(19) United States
(12) Patent Application Publication
(10) Pub. No.: US 2005/0132278 A1
(43) Pub. Date: Jun. 16, 2005

(54) Structural conversion apparatus, structural conversion method and storage media for structured documents

(75) Inventor: Shigeru Yoshida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/045,184

(22) Filed: Jan. 31, 2005

Related U.S. Application Data
(63) Continuation of application No. PCT/JP03/14821, filed on Nov. 20, 2003.

(30) Foreign Application Priority Data
Dec. 27, 2002 (JP) 2002-379971
Jun. 10, 2003 (JP) 2003-165735

(51) Int. Cl. G06F 15/00

(52) U.S. Cl. 715/513

(57) ABSTRACT

In the prior patent application, each element contained in a record is categorized into one subjected to data processing (i.e., key element) and the other, not subjected thereto (i.e., non-key element) as shown by FIG. 1(b) and element contents of the non-key elements being linked together by the CSV format per each new element are converted into an XML document. The present invention places a plurality of new elements on the first hierarchical layer and links each non-key element together freely as element contents of the discretionary new element as shown by FIG. 1(c).

### CROSS REFERENCE TO RELATED APPLICATION

This application is a continuation of international PCT application No. PCT/JP03/14821 filed on Nov. 20, 2003.

### BACKGROUND OF THE INVENTION

1. Field of the Invention

The present invention relates to a method and apparatuses for converting and reconverting between XML documents.

2. Description of the Related Art

In recent years, diverse systems used by individuals, enterprises, municipalities, et cetera, are interconnected through the Internet, and various services such as Web services, EDI (Electronic Data Interchange), EC (Electronic Commerce) are provided by these systems cooperating with one another, thus requiring a wide spectrum of information exchanges.

Under the circumstance, XML (extensible Markup Language), having a flexible expression capability for structuring data and a suitability for computer processing, has been in attention for use as a common platform format for data exchanges among the above mentioned systems and the data processing by the respective systems.

The XML has been established for its basic specification, XML 1.0, at the W3C (World Wide Web Consortium) in February 1998, for an easy use on the Internet, based on SGML (Standard Generalized Markup Language) that had been standardized by ISO in 1986.

HTML (HyperText Markup Language), a conventionally used Web page script language, has a fixed tag specifically used for displaying, which has been faced with a problem of being unable to meet a specification for computer processing in accordance with tag information.

Contrarily, XML allows the user to define tags discretionarily and has a language structure capable of being given a meaning to a character string in a document. A document scribed by such featured XML enables a computer to perform information processing in accordance with tag information.

Note that the XML documents are largely categorized for their characteristics into two types as follows:
Data-centric XML documents: form, schedule chart, et cetera, having a large number of tags or short elements of contents.
Document-centric XML documents: magazine, manual, dictionary, et cetera, having long elements of contents such as sentences

The data-centric XML documents are a main subject herein.

At this time, let it be explained the terminology used in the following description according to the XML standard. It is well known that a character string parenthesized by “<” and “>” is called as “tag”, “<character string>” as “start tag”, “</character string>” as “end tag”, a whole character string between a start tag and an end tag as “element”, a character string parenthesized by a start and end tags as “content of element”, a name of element scribed within a tag as “tag name (or element name)”, and added information to an element as “attribute.”

In a structured document, a data structure is written by embedding a tag in the document. Thus configuring with a data structure being embedded in a document makes it possible to gain a flexibility and extendibility in adding, deleting and changing data items; and labeling a tag with a name meaningful to a person lets a data have a visibility.

Meanwhile, what is generally done is an attempt to have a high operating performance of platform software by higher process speeds and a reduction of memory volume usage for better capability of processing the XML documents. However, it is also possible to improve a performance of processing the XML document by a certain treatment of the XML document beforehand other than the above mentioned method. The present invention is concerned with the latter method (i.e., a processing performance improvement by treating the XML document). Here, a conventional technique relating to the latter method will be described as follows.

For instance a Non-patent document 1 listed below discloses an example of fixing the problem of slowing down the processing speed at the time of introducing the XML through a changing in a data structure. An example is seen in a case presented by Sumitomo Electric Systems Co., Ltd (refer to the company publication, pages 64 to 65) in which same kind of data are collectively scribed by the CSV (Comma Separated Value) format and the collectively scribed data are embedded in one tag in an XML document. That is, “as if embedding a CSV-formatted data in an XML data.” For example, one month worth of XML data are clustered together with commas punctuating between the dates and in order thereof.

Specifically, the daily performance data which was scribed in different tags for each day as follows:
<KOUSU day=“01”>8.0</KOUSU> <KOUSU day=“02”>5.5</KOUSU> . . . <KOUSU day=“31”>12.8</KOUSU>
has been changed so as to scribe collectively for one month worth as follows:
<KOUSU day=“01, 02, . . . , 31” data=“8.0, 5.5, . . . , 12.8”></KOUSU>

By the above change, just one access to the data base server is required for one month worth of data, and the data base capacity needed is reduced by 10 to 1 since only one transmission of the XML definition information is necessary.

Meanwhile, a Non-patent document 2 discloses a technique in which an XML document in a record format is converted, record by record, into an XML document through the XSL (Extensible Stylesheet Language) conversion with all elements in the record being linked together by the CSV format while the document retaining the specified XML format in an attempt to reduce the volume of data. This aims at handling a document with all the elements in a record being put together into one by the CSV format by using a specific API (application programming interface) in order to alleviate a data processing load.

Specifically, an XML document before- and after the conversion by the method according to the disclosure of the Non-patent document 2 is exemplified in FIG. 46A and 46B. FIG. 46A is an original XML document before the conversion while FIG. 46B is the one after the conversion.

As shown by FIG. 46B, the XML document after the conversion has two parts, that is, one part describing each tag name in the original XML document, and the other describing a content of each element (1, 2, 3, 4, and so on) in a connected form by the CSV format.

Meanwhile, here, for the XML document as a representative structured document, two typical interface (API: Application Programming Interface) standards are established, i.e., DOM (Document Object Model) and SAX (Simple API for XML), so that other kinds of application software can handle (i.e., operations such as search, renewal, delete) an XML document. The SAX has characteristics such as requiring a small memory usage, generally a high speed, and being suitable for a simple process of time series output and of reference only. The DOM on the other hand has characteristics such as a low speed generally, requiring a large memory usage and making it easy to write a program even for a complex processing content because the DOM develops elements of a document into a hierarchical tree structure.

Handling an XML document such as search, renewal, delete, et cetera, in general follows developing the document subjected to handling into a DOM tree by using a standard API (i.e., DOM). The development of an XML document into a DOM tree requires not only a vast volume of memory capacity of up to six times the original data volume but also developing items not to be used (i.e., the items not subjected to the operation), resulting in consuming a large amount of time for the development (note that the processing speed and the memory usage are in proportion to the number of elements in the XML document).

Such is the circumstance needing methods as presented by the Non-patent documents 1, 2 as described above for improving processing performance through a treatment of the XML documents.

However, techniques presented by the Non-patent documents 1 and 2 as described above have been faced with the problems as follows:

First of all, the method presented by the Non-patent document 1 is a specific method dependent on data, not an organized generic method. That is, the method presented by the Non-patent document 1 puts together the same kind of data for a data processing, which is applied to a specific data having the same kind of data, and therefore its improvement effect depends on the data. In other words, it is not a generic method.

Meanwhile, while the technique presented by the Non-patent document 2 can reduce a volume of data by removing tags of the XML document, it is not possible to alleviate a data processing load on the existing application software by this method.

The technique presented by the Non-patent document 2 assumes making the specific API software capable of handling the converted document in order to alleviate a data processing load. This means a separate software program having the same function as the existing DOM software must be created, requiring a vast amount of man-hours. Therefore it will hardly be used in the same way as the existing DOM.

Also, the technique presented by the Non-patent document 2 assumes the fixed pattern XML documents (e.g., table format).

The inventor of the present invention has proposed a method described in a Non-patent document 3 listed below vis-à-vis such conventional techniques.

The technique noted in the Non-patent document 3, which is for improving a data processing performance of DOM application software for handling an XML document in a record structure to begin with, aims to be applicable to an application software with a minimal modification (i.e., for executing the conversion without writing the specific software) and able to handle the converted document basically the same as (i.e., transparently) the original document. And, the characteristic of the technique is that contents of a plurality of elements other than those subjected to processing are converted into the XML documents with all the above mentioned contents being connected together by the CSV format for each record, while leaving the elements subjected to processing by the application software as they are. It has also proposed that names of the elements not subjected to processing are connected together by the CSV format in the same sequence as the contents of the elements to place as the attribute of the elements in the converted CSV format for the XML document representing data by a non-table format because there is a lack of elements appearing in a record, hence requiring to relate with the contents of elements by retaining the names of the elements not subjected to processing in the converted documents.
[Non-patent document 1] “Emerging truth about an illusion of almighty; Over-turning “common knowledge” about the XML,” Nikkei Computer Magazine, Published Mar. 12, 2001, pp 52-71
[Non-patent document 2] “Building an XML Bloat Buster using ZXML XML Compression Method”: by Alain Trotter; searched on Internet, dated Feb. 18, 2002; <URL: http://www.ASPToday.com/>; or a summary in <URL: http://www.XML.com/pub/r/904>
[Non-patent document 3] “A study of improving data processing performance by a pre-conversion of format for XML documents”; by Shigeru Yoshida, et al; The first forum of information technology (FIT 2002); D-29; Dated Sep. 27, 2002

### SUMMARY OF THE INVENTION

The object of the present invention is to provide methods for a conversion and/or a reconversion of structured documents, the apparatus and program thereof enabling the existing application software to handle the converted XML document by categorizing elements contained in a record into key elements to be used by the application software and the remaining non-key elements, and converting the non-key elements so as to link them together by the CSV format, while leaving the key elements as they are; a reduction of memory usage volume and processing time for data processing as the general method; and, furthermore, the XML document to maintain its self-describability even after a conversion while preventing an overhead from becoming large even in a case where the application software ends up handling the non-key element, or making capable of reconverting back to the original XML document with the sequence of elements in the reconverted document being the same as the original XML document, or avoiding a redundancy even if there are large number of records and/or of non-key elements in an unfixed form document.

The first aspect of a structural conversion apparatus for a structured document according to the present invention comprises a conversion specification definition unit for defining a plurality of new elements in a converted structured document, categorizing each element contained in a structured document for conversion into a key element to be subjected to data processing and the others in sequence of appearance in a record and determining to which of the plurality of new elements to assign the each non-key element that is one other than the key element in dealing with a fixed form structured document; and a structural conversion unit for describing each element contained in the structured document for conversion in sequence of appearance in the record by the method of writing the key elements, as is, while, for the non-key elements, writing in the form of linking the element contents together by the CSV format per the each applicable new element as element contents of each new element, both in the structured document for conversion, in order to create the converted structured document from the structured document for conversion according to a conversion specification specified by the conversion specification definition unit.

In the above configuration, categorizing each element in a structured document for conversion into the key and non-key elements and linking the element contents of the non-key elements together by the CSV format, that is, by way of punctuation marks make it possible to reduce memory usage volume and processing time for a data processing as a generic method and at the same time enable the application software to execute a series of processing such as search by using the key elements, which is the same as the prior patent application.

The above noted first aspect of the structural conversion apparatus for a structured document further defines a plurality of new elements to assign each of the non-key elements to either of the new elements. The number of the new elements may be defined in response to that of the non-key elements. This makes it possible to suppress the number of the non-key elements to be assigned to one new element, preventing an overhead from becoming large even when the application software happens to handle the non-key elements. Meanwhile, being able to convert a document freely independent of the hierarchical structure of a structured document for conversion, a definition for conversion may be so as to enable the application software to handle the converted structured document according to the processing content of the application software. Furthermore, since the conversion specification definition unit defines each element in the structured document for conversion in sequence of appearance thereof in the record, it is possible to convert back to the original document with the sequence of element being lined up perfectly by processing a reconversion in a complete compliance to the defined sequence.

The second aspect of a structural conversion apparatus for a structured document according to the present invention comprises a conversion specification definition unit for defining a plurality of new elements in a converted structured document, categorizing all elements of possible appearances in a structured document for conversion into key elements to be subjected to data processing and the others in sequence of appearance for all possible appearances and determining to which of the plurality of new elements to assign the each non-key element that is one other than the key elements in dealing with an unfixed form structured document; and a structural conversion unit for describing each element contained in the structured document for conversion in sequence of appearance in the record by the method of writing the key elements, as is, while, for the non-key elements, writing a relating element content thereof in the converted structured document by taking the form of element contents of the new element linked together by the CSV format per one respective new element in which the relating element content is written for an element appearing in the structured document for conversion and an empty element is substituted for the element content thereof not appearing therein, in order to create the converted structured document from the structured document for conversion according to a conversion specification specified by the conversion specification definition unit.

Also in the above described second aspect of a structural conversion apparatus for a structured document may, for example, further include a reconversion unit for refraining from writing an element if the relating element content thereto is the empty element, when the unit is searching a new element applicable to each element, one after another, which is defined in the sequence of appearance by the conversion specification definition unit, searching an element content corresponding to the element in parallel with the sequence from among each element content linked together by the CSV format for the new element, and writing the element content in the original structured document in order to reconvert the converted structured document back to the original structured document according to a conversion specification specified by the conversion specification definition unit.

According to the above described second aspect of a structural conversion apparatus for a structured document, it is possible to configure so as to gain the same benefit for an unfixed form structured document as with the first aspect thereof. Furthermore, a reconversion is enabled without a problem if an element name of non-key element is not written even when a structured document for conversion is in fact an unfixed form structured document. To enable this, the conversion specification definition unit defines each element contained by a record in sequence of appearance for all elements of possible appearances in the record in the above described configuration so as to perform a conversion and a reconversion in the sequence and, at the same time, outputs the element content of the element which does not appear at the time of conversion by the form of an empty element, while refrains from outputting the element which does not appear at the time of reconversion.

Furthermore, the above described second aspect of a structural conversion apparatus for a structured document may be configured so that the structural conversion unit further writes element names in the form of the CSV format linking them together, of all elements whose element contents can be written in each of said new element, per said new element, in a converted structured document as additional information.

By this, the relationships between element contents and element names, and the fact that the element of the above described empty element is not written in the record, can be known by referring to the additional information even when the application software happens to handle a non-key element. In the prior patent application, either element names or compressed character strings were written; whereas the present invention only requires one time entry of additional information in the header for example, for making the above relationship clear, without writing in each record one after another.

The third aspect of a structural conversion apparatus for a structured document according to the present invention comprises a conversion specification definition unit for defining a plurality of new elements in a converted structured document, categorizing the new elements into unfixed form element or the other form for each thereof, categorizing all elements of possible appearance in a structured document for conversion into the key elements to be subjected to data processing and the others in sequence of appearance for all possible appearance, and determining to which of the plurality of new elements to assign each non-key element that is one other than the key element in dealing with an unfixed form structured document; and a structural conversion unit for describing each element contained in the structured document for conversion in sequence of appearance in the record by the method of writing the key elements, as is, while, for the non-key elements, writing element contents of the appearing elements being linked together by the CSV format in sequence of appearance as element contents of the new element per each new element, if the new element is not the unfixed form element, while writing element contents of the appearing elements being linked together by the CSV format in sequence of appearance as element contents of the new element and also the sequence of appearance being put together by the CSV format as a tag attribute of the new element, if the new element is the unfixed form element, in order to make a converted structured document from the structured document for conversion according to a conversion specification specified by the conversion specification definition unit.

Also, the above described third aspect of a structural conversion apparatus for a structured document may be configured for example so that the structural conversion unit, further writes element names in the form of the CSV format linking them together, of all elements whose element contents can be written in each of said new element, per said new element, in a converted structured document as additional information.

The above described third aspect of a structural conversion apparatus for a structured document provides the same benefit as the above described second aspect thereof. The methodological difference between the two is that the sequence of appearance of the actual appearing element is written, instead of outputting empty element for one not appearing in order to show actual appearance of the elements. The element whose sequence of appearance is not written does not appear in the record.

The fourth aspect of a structural conversion apparatus for a structured document according to the present invention comprises a conversion specification definition unit for defining a record item list for each record category, categorizing all elements contained in each record item list of possible appearances for the record category into key elements, to be subjected to data processing, and the others, defining at least one new element for a converted structured document and determining to which of the new elements to assign the non-key elements that are ones other than the key element in dealing with an unfixed form structured document having different elements for forming a record for each record category; and a structural conversion unit for selecting a record item list from the conversion specification definition unit relating to the record category per each record in the structured document for conversion, describing each element contained by the record in sequence of appearance therein based on the selected record item list by the method of writing the key elements, as is, while, for the non-key elements, writing in the form of linking them together by the CSV format per each applicable new element as element contents of each new element, both in the structured document for conversion, in order to create the converted structured document from the structured document for conversion according to a conversion specification specified by the conversion specification definition unit.

According to the above configured fourth aspect of a structural conversion apparatus for a structured document, the conversion specification definition unit defines record items (i.e., elements), which vary with record category, separately with a switching condition identified so as to switch the record items according to the condition at a conversion or a reconversion, eliminating a useless writing in the converted structured document and a redundant check for a presence or absence of the non-key elements, and thus enabling a faster conversion and a reconversion processing.

Last but not least, it is also possible to provide an answer to the above described problems by making a computer read out of a computer readable storage media storing a program having the same function as with the above described configurations and execute the program. In other words, the present invention can be configured by such a program per se, or by a storage media, especially a portable storage medium, storing the aforementioned program.

### BRIEF DESCRIPTION OF THE DRAWINGS

The present invention will be more apparent from the following detailed description when the accompanying drawings are referenced to.

FIG. 1A through 1C describes a form of memory deployment on a DOM in comparison between the present invention and the conventional technique;

FIG. 2 is a summary block diagram showing an overall processing of a conversion method for a structured document performed by a computer, et cetera, according to the present embodiment;

FIG. 3 shows an example of fixed form XML document subjected to conversion in a first embodiment;

FIG. 4 shows an example of conversion specification XML document used in a first embodiment;

FIG. 5 shows an example of converted XML document in a first embodiment;

FIG. 6 is a basic process flow chart of a structural conversion processing for a fixed form XML document;

FIG. 7 is a basic process flowchart of a structural conversion processing for an XML document;

FIG. 8 is a detailed process flow chart of the step S17 shown by FIG. 6 or the step S28 shown by FIG. 7 in a conversion processing;

FIG. 9 is a detailed process flow chart of the step S17 in a reconversion processing;

FIG. 10 shows an example of unfixed form XML document as the input XML document in a second and a third embodiment;

FIG. 11 shows an example of conversion specification XML document in the second embodiment;

FIG. 12 shows an example of converted XML document as a result of structural conversion of unfixed form XML document shown by FIG. 10 by using a conversion specification XML document shown by FIG. 11;

FIG. 13 is a detailed process flow chart of “processing the elements in a record” in a structural conversion processing according to the second embodiment;

FIG. 14 is a detailed process flow chart of “processing the elements in a record” in a reconversion processing according to the second embodiment;

FIG. 15 shows an example of conversion specification XML document in the third embodiment;

FIG. 16 shows an example of converted XML document as a result of structural conversion of unfixed form XML document shown by FIG. 10 by using a conversion specification XML document shown by FIG. 15;

FIG. 17 is a detailed process flow chart of “processing the elements in a record” in a structural conversion processing of the third embodiment;

FIG. 18 is a detailed process flow chart of “processing the elements in a record” in a reconversion processing according to the third embodiment;

FIG. 19A through 19D show a summary processing procedure in the case of using conversion/reconversion XSL sheet according to the first embodiment;

FIG. 20 is an example of conversion XSL sheet being generated when reading in the conversion specification XML document as exemplified in FIG. 4;

FIG. 21 is an example of reconversion XSL sheet being generated when reading in the conversion specification XML document exemplified in FIG. 4;

FIG. 22 describes a procedure for making a conversion specification XML document;

FIG. 23 shows an example of application software program;

FIG. 24 shows an example of application software program;

FIG. 25 shows an example of unfixed form XML document having different types of record items depending on the kind of record;

FIG. 26 is an example of conversion specification XML document when applying the second embodiment to the unfixed form XML document shown by FIG. 25;

FIG. 27 shows a converted XML document corresponding to the example shown by FIGS. 25 and 26;

FIG. 28 is an example of conversion specification XML document according to the fourth embodiment (part 1);

FIG. 29 is an example of conversion XSL sheet (part 1 of 2) being created by using the conversion specification XML document shown by FIG. 28;

FIG. 30 is an example of conversion XSL sheet (part 2 of 2) being created by using the conversion specification XML document shown by FIG. 28;

FIG. 31 is an example of converted XML document according to the fourth embodiment (part 1 of 2);

FIG. 32 is an example of reconversion XSL sheet (part 1 of 2) being created by using the conversion specification XML document shown by FIG. 28;

FIG. 33 is an example of reconversion XSL sheet (part 2 of 2) being created by using the conversion specification XML document shown by FIG. 28;

FIG. 34 is an example of conversion specification XML document according to the fourth embodiment (part 2);

FIG. 35 is a flow chart showing a conversion/reconversion processing based on the conversion specification shown by FIG. 34;

FIG. 36 is a detailed flow chart of the step S302 (part 1 of 2) shown by Fig. 35 for a conversion processing;

FIG. 37 is a detailed flow chart of the step S302 (part 2 of 2) shown by FIG. 35 for a conversion processing;

FIG. 38 is a detailed flow chart of the step S302 (part 1 of 2) shown by FIG. 35 for a reconversion processing;

FIG. 39 is a detailed flow chart of the step S302 (part 2 of 2) shown by FIG. 35 for a reconversion processing;

FIGS. 40A and 40B are the flow charts for creating conversion and reconversion XSL sheets based on the conversion specification shown by FIG. 34;

FIGS. 40C and 40D are the flow charts of conversion and reconversion processing by using these conversion and/or reconversion XSL sheets;

FIG. 41 is an example of conversion XSL sheet being made by FIG. 40A;

FIG. 42 is an example of reconversion XSL sheet being made by FIG. 40A;

FIG. 43 describes a creation method for the conversion specification XML document shown by FIG. 34;

FIG. 44 shows an example of hardware configuration for achieving a structured document conversion method;

FIG. 45 shows an example of storage media being stored with a program, et cetera, or a download;

FIG. 46A is a pre-conversion original XML document according to a conventional technique; and FIG. 46B is its post-conversion XML document;

FIG. 47A is an example of pre-conversion fixed form XML document according to the prior patent application; FIG. 47B is its conversion result; and FIG. 47C is an example of conversion specification used for the aforementioned conversion;

FIG. 48A is an example of pre-conversion unfixed form XML document according to the prior patent application; FIG. 48B is its conversion result; and

FIG. 48C is an example of conversion specification used for the aforementioned conversion.

### DESCRIPTION OF THE PREFERRED EMBODIMENT

The proposing entity of the present invention has already filed for a patent with the number by Japanese patent laid-open application publication 13-401934 (called “prior patent application” hereinafter).

The prior patent application proposes, as in the Non-patent document 3, that elements in a record are categorized into items subjected to data processing (“key element” hereinafter) by the application software and items not subjected thereto (“non-key element” hereinafter) for a fixed pattern XML document, and the document is converted into an XML document with contents of the non-key elements being connected to one new element (“CSV element” hereinafter) in the CSV format at the time of document conversion, leaving the key elements as they are. For an unfixed pattern XML document, the names of elements being put together as a new element are converted to the CSV format and attached to the attribute. This conversion (“CSV compression conversion” hereinafter) is executed as an XSL conversion.

Since the CSV compression conversion leaves the key elements subjected to data processing as they are instead of converting them into the CSV format, it is applicable by a minimal modification to the application software. Meanwhile, eliminating tags for non-key elements and accordingly combining their contents into new one element reduce a memory volume usage, deployment time and processing time for XML document processing in proportion with the number of elements eliminating the tag in the original document.

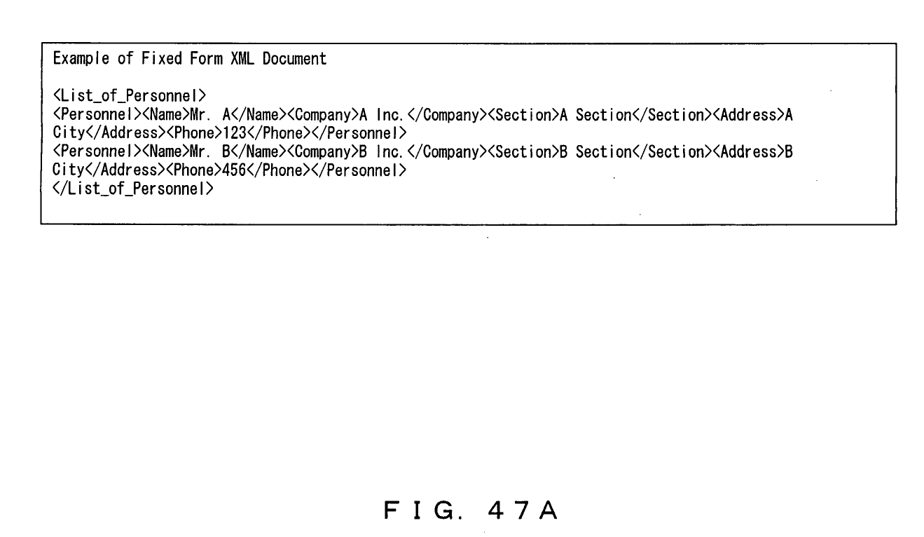

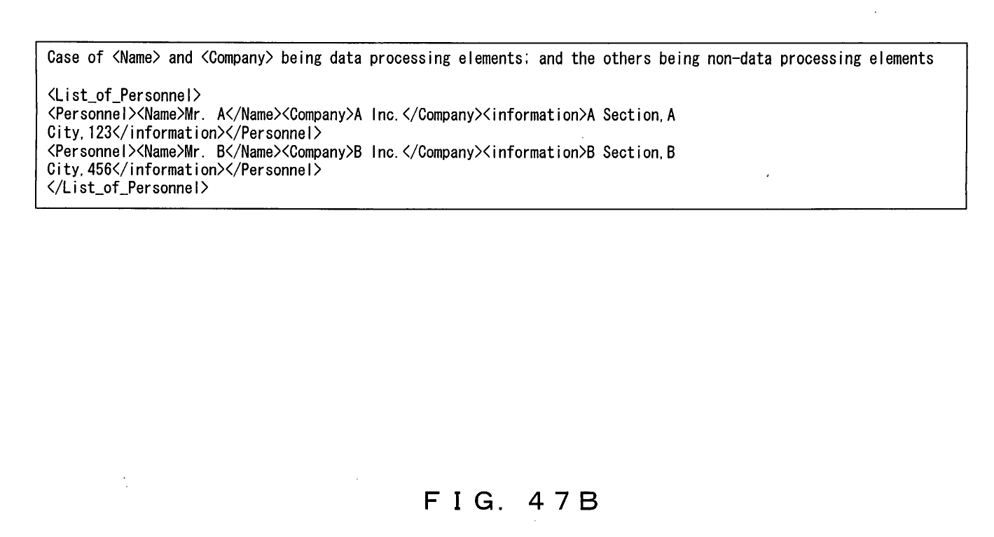

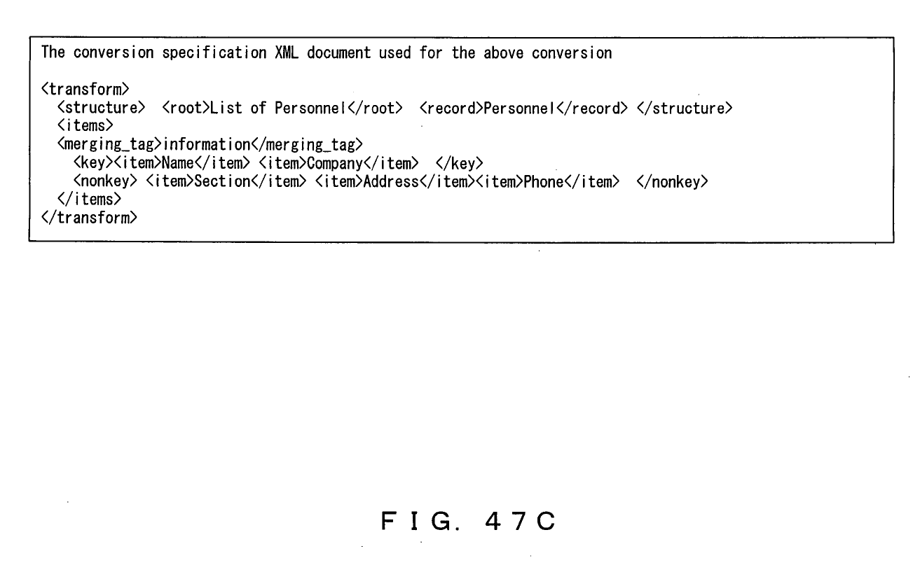

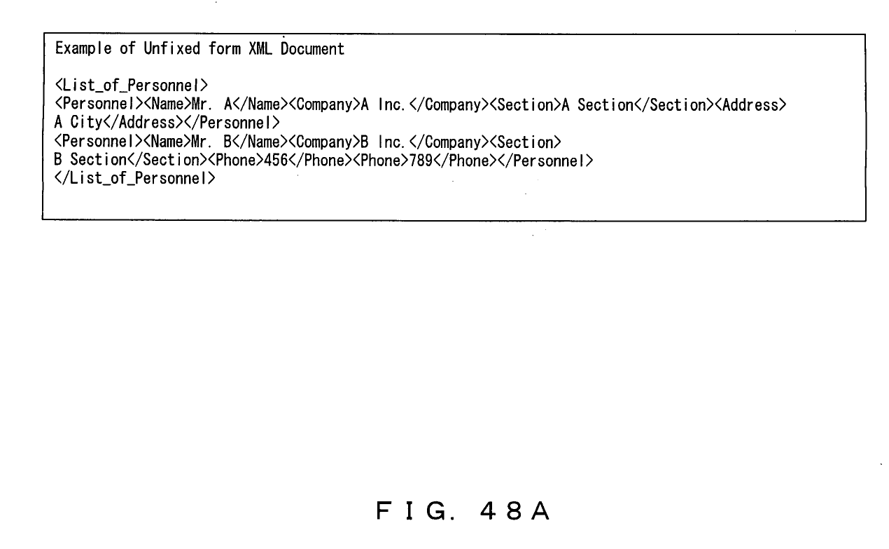

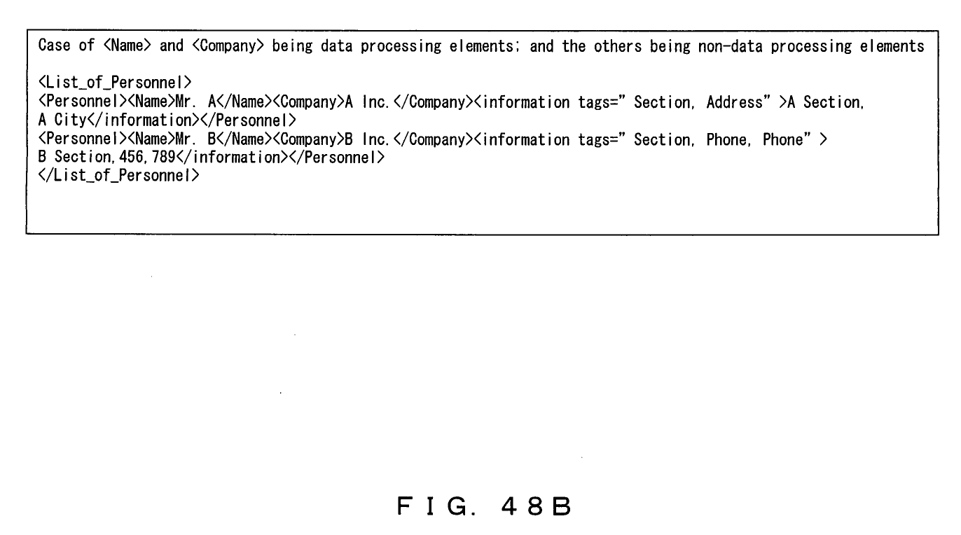

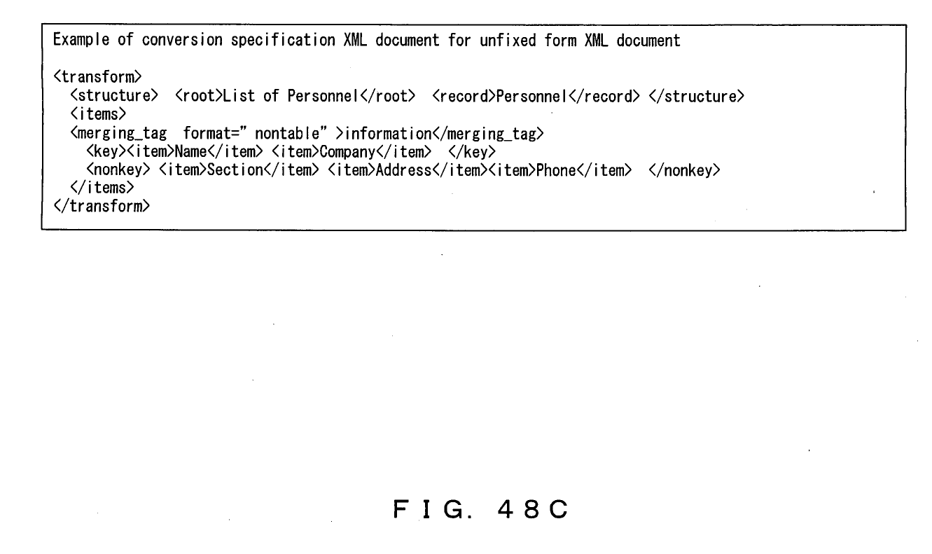

For instance, pre- and post-conversions XML documents are exemplified here, with FIG. 47 showing a case of fixed form XML document; and FIG. 48 showing a case of unfixed form XML document and an example of conversion specification.

FIG. 47A shows an example of pre-conversion fixed form XML document; FIG. 47B shows the post conversion; and FIG. 47C shows an example of conversion specification used for the conversion.

In this example, “name” and “company” are key elements, while element contents of the other non-key elements are put together in the new element “information” by the CSV format in the post conversion document.

Meanwhile, FIG. 48A shows an example of pre-conversion non-fixed pattern XML document; FIG. 48B shows the post-conversion; and FIG. 48C shows an example of conversion specification used for the conversion.

In this example, for each record (i.e., Mr. A or Mr. B), the element names of non-key elements noted in the record are addressed by the attribute tags in the tag of new element in the post-conversion document. By this, corresponding relationship between the element name and the element content is known by using the converted XML document at a time of processing by application software.

As described above, the Non-patent document 3 and the prior patent application have proposed a better method as compared to the conventional method especially in relation to application software processing the converted XML document. Moreover, the conventional method had never thought about a method for handling an unfixed form XML document.

The method presented by the prior patent application, however, has left a room for improvement as described in the following paragraphs (a), (b) and (c):

(a) Concerning an Ease of use by Application Software

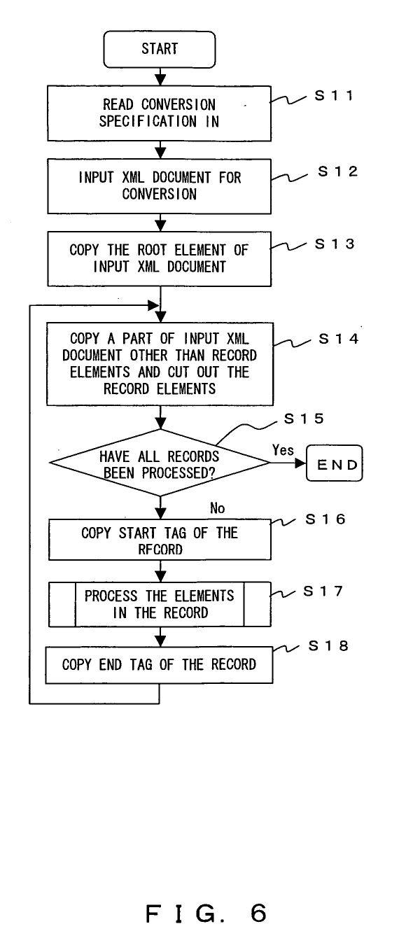

In the prior patent application, non-key elements assumed elements not used by the application software. There are, however, many kind of application software incapable of distinguishing between the key and non-key elements so that even if a non-key element is defined, the application software happens to read out and/or write in the non-key element after the conversion. Any script language, given a capability of reading out the content of a CSV element, can easily deploy it by using the standard function (“split” and “join”) for splitting and/or joining a CSV.

Whereas the method proposed by the prior patent application has left an issue of an overhead becoming large since such a situation was not included in the concept, requiring unfolding and taking out the non-required elements in addition to the required from among the non-key elements when many non-key elements are put together. The overhead becomes larger with the number of non-key elements being put together by the CSV format. In order to solve this, a consideration can be given to define a plurality of new elements and thereby reducing the number of non-ken elements being assigned to one new element. The prior patent application has considered the point to put together non-key elements by the CSV format respectively in two elements, “information 1” and “information 2,” as shown by FIGS. 6 through 8 in the prior patent application.

However, this does not assume the above described problem, but rather put together the elements included in the tag name “work place” in the new element “information 1” created within the element being tagged “work place” while the other non-key elements are put together in a new element “information 2” created on the first hierarchical layer in the record. Since the application software does not assume a possibility of handling a non-key element, the “information 1” is made under the element “work place” that is, on the second hierarchical layer according to the hierarchical structure of the original XLM document, while the “information 2” is made on the first layer in the record. This may give the application software a difficulty when handling the non-key element.

Meanwhile, while there are two new elements, that is, a plurality thereof in this example, the prior patent application does not have a concept to make the number of new elements 3, 4, . . . , or 10 or more, according to the number of non-key elements if there are many thereof.

(b) Sequence of Elements in a Record After Conversion and Reconversion

Not only the prior patent application but also the conventional techniques have not stored a sequence of elements in a record. This creates a problem of document having changed in the user's eye because the sequence of the elements is different even though the content is identical when comparing a reconverted XML document after the conversion with the pre-conversion original XML document, hence giving the user a usability problem.

(c) An Improved Countermeasure to a Lack of Self-Describability as the XML Document

Being given meaning of data by the element name, the XML document has self-describability by itself. Conventionally, however, bringing in the CSV format to a non-fixed XML document loses the self-describability, requiring a reference to another file to understand a meaning of data being linked together by the CSV format.

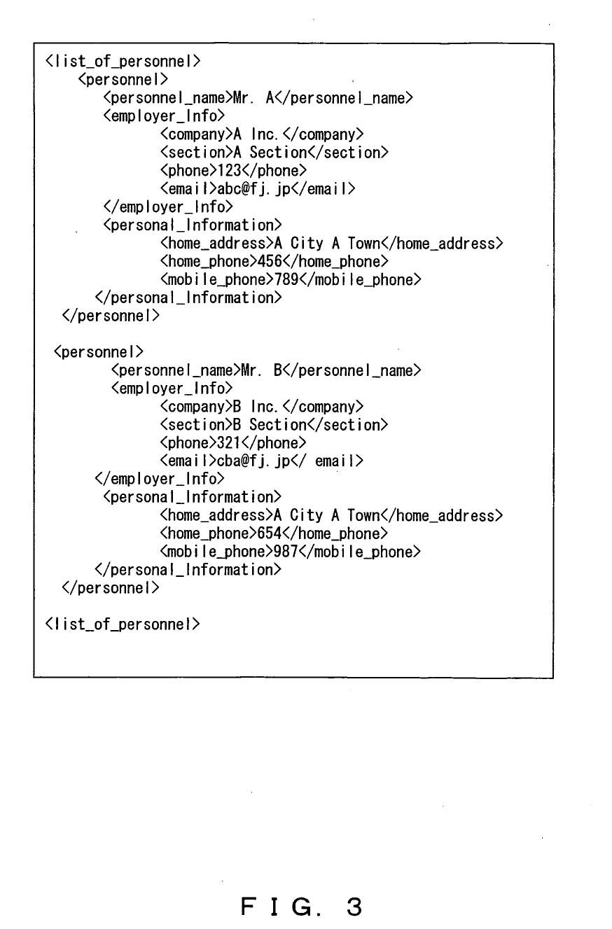

As a counter measure to the above, in order to relate a name of element with the content thereof, the prior patent application has proposed a method for unfixed form documents of giving a path including the names of non-key elements being linked together with the CSV format by an attribute. That is, as shown by FIG. 48B herein and FIG. 3(b) of the prior patent application, the names of non-key elements are described by attribute tags. This method can respond to unfixed form documents as well. However, since the element names of all non-key elements are described for each record, there is a problem of too much redundancy if there are many records and/or the number of non-key elements.

To avoid the above described problem, the prior patent application has also proposed a method in which a discretionary compressed character string describes a path including the names of non-key elements used for the unfixed form documents. That is, each non-key element is allocated by the discretionary compressed character string A, B, C, et cetera, which is described by the attribute tags.

This method, however, needs to record the relationship between the name of each non-key element and the compressed character string in a separate file for the application software in executing the processing while referring to the separate file, in order to enable the application software to handle the converted documents.

Also a need for defining the relationship one after another makes it increasingly troublesome as the number of non-key elements increases, taking an extraneous time.

Furthermore, the names of elements (or the compressed character string) being described in the converted XML document have originally been required for a reconversion processing in the prior patent application.

Embodiments of the present invention are described while referring to the accompanying drawing as follow.

What follows here is a detailed description of the embodiments of the present invention.

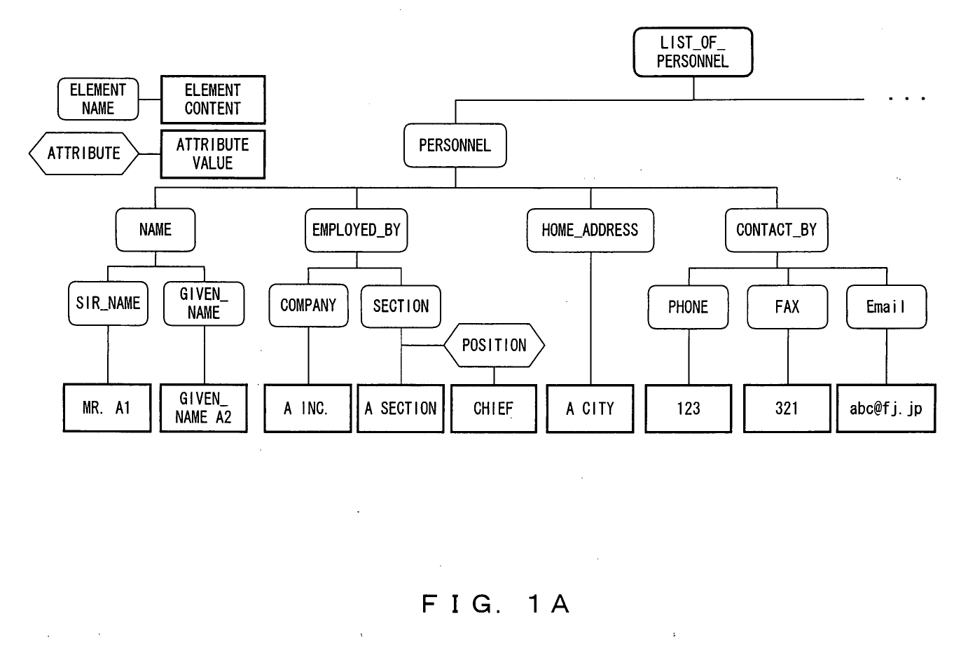

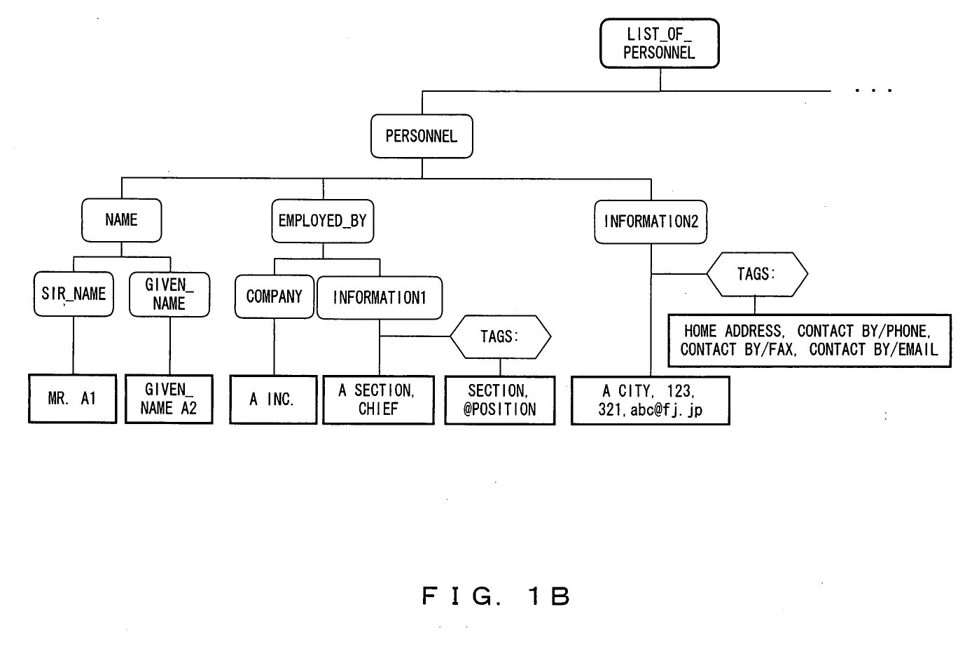

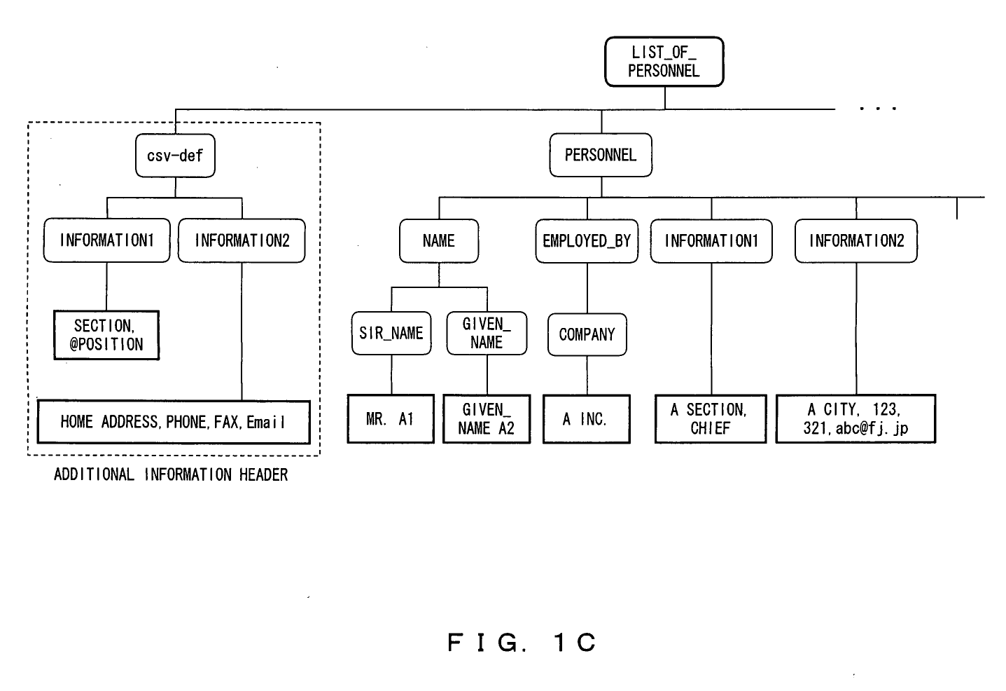

First of all, one of the characteristics of the present invention in comparison with the conventional techniques and the prior patent application is described by FIG. 1(a) through (c) which exemplifies an XML document developed as a DOM tree on a memory.

FIG. 1C shows a memory development form on the DOM according to a structured document conversion method of the present embodiment. Also shown for comparison are FIG. 1A showing a conventional DOM development form and FIG. 1B showing a DOM development form according to the prior patent application. Note that FIG. 1A through 1C shows only one record (i.e., tag named “personnel”), while there will be many records actually.

As shown by FIG. 1A, the conventional method handling heterogeneous data develops all elements on a memory including elements being unused for a data processing, which causes to use large amount of operating memory and slow down the processing speed.

Countermeasures have been proposed to the above problem, such as the method of linking homogeneous data together by the CSV format as the above described Non-patent document 1, and the method of linking all elements in a record together into one by the CSV format with a consideration of a fixed form XML document as the above described Non-patent document 2.

However, as described above, no response has conventionally been given to a case of application software executing any kind of processing by using a converted XML document, or to an unfixed form XML document.

Meanwhile, the prior patent application categorizes all elements in a record into items subjected to data processing by the application software (i.e., key elements) and the remaining items subjected not thereto (i.e., non-key elements), and converts to XML documents with all the non-key elements being linked together to anew element by the CSV format, while leaving the key elements as they are, as shown by FIG. 1B. Note that the element of the tags named “name” and “company” are the key elements in an example shown by FIG. 1B and 1C.

This method links all element contents of the non-key elements together into one new element by the CSV format with the tags of respective non-key elements being removed, thereby making it possible to reduce drastically the number of sub-elements (children) being developed on a memory and handle the non-key elements together at the time of tree development and data processing. Note that the aforementioned “sub-elements” of the tree is element which include the tags named “section,” “phone,” “email,” “fax,” et cetera, for example, in FIG. 1A.

And furthermore, when the application software executes a kind of processing by using the converted XML document, a search processing, et cetera, for instance, can be performed by using the key elements.

The prior patent application, however, has not considered a situation where the assumption “non-key elements are the ones unused by the application software” may not hold as noted above, hence not allowing the application software to handle the non-key elements easily. That is, as has already been described, a CSV element “information 1” is created under the element “employed by,” i.e., on the second layer in a record, according to the hierarchical structure of the original XML document, while a CSV element “information 2” is created on the first layer in a record as shown by FIG. 1B. And the non-key elements contained in each CSV element are of the same structure as the original XML document. This may make the application software to be faced with a difficulty in handling the non-key elements. Or at least, a creation of structure so as to allow the application software to handle the non-key elements easily has not been considered.

Also, the prior patent application has not provided enough of a countermeasure to an increased overhead in proportion to the number of non-key elements in developing the CSV element when subjecting the discretionary items of non-key elements to a processing.

Contrarily, the structural conversion and/or reconversion method of the present embodiment defines a plurality of CSV elements and places all of the plurality thereof on the first hierarchical layer independent of the hierarchical structure of the original XML document as shown by FIG. 1C. Furthermore, while not shown by a figure herein, the aforementioned method allows each non-key element to be defined as being included freely in either of the CSV elements independent of the original XML document, so long as retaining desirably a document structure which can be handled by the application software in its contents of operations. Also not shown by a figure herein, the number of CSV elements shall desirably be increased with the number of non-key elements being contained.

As such, the method proposed by present invention makes it possible to modify a document structure so as to be easily handled by the application software even when subjecting the non-key elements to a processing and also prevents an overhead from becoming large when developing the applicable CSV elements even if there are a large number of non-key elements.

Note that this is just one of the characteristics of the structural conversion method of the present embodiment which has a various characteristics as described in the following.

For instance, if an XML document subjected to conversion is an unfixed form XML document, the prior patent application has described a tag name of each CSV element corresponding to the content of each element linked together by the CSV format by using the attribute tags as shown by FIG. 1B, creating a problem especially when there is a large number of records, since the tag names are described for each record one after another. Contrarily, the present invention describes tag names of all elements possibly appearing as additional information collectively in the header as shown by FIG. 1C, thereby being able to respond to the aforementioned problem, which will be described in detail later herein.

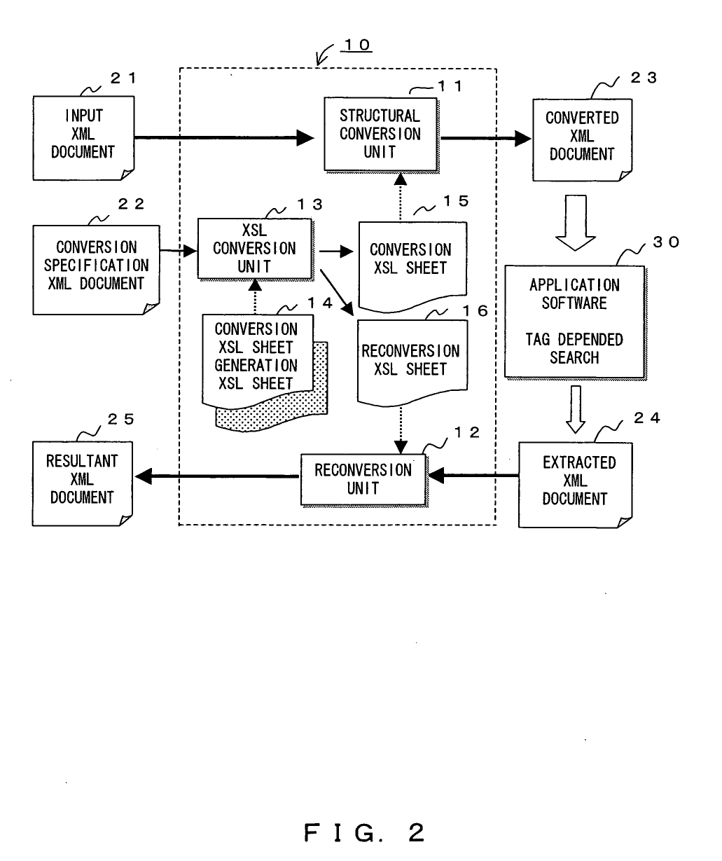

FIG. 2 is a summary block diagram showing an overall processing of a conversion method for a structured document performed by a computer, et cetera, according to the present embodiment.

The structured document conversion method of the present embodiment is described as a first through fourth embodiments applied to a fixed form XML and unfixed form XML documents (that is, two methods are presented for the respective types) as described later, for which the summary flow of the whole processing and the configuration are common to all of the aforementioned methods as shown by FIG. 2.

In FIG. 2, a data structural conversion and/or reconversion mechanism 10 includes a structural conversion unit 11, a reconversion unit 12 and an XSL conversion unit 13. The data structural conversion and/or reconversion mechanism 10 receives an input XML document 21 and a conversion specification XML document 22 as inputs thereto and outputs a converted XML document 23 (i.e., “conversion”); and also receives an extracted XML document 24 as input thereto and outputs a resultant XML document 25 (i.e., “reconversion”).

The input XML document 21 is an XML document subjected to conversion.

The conversion specification XML document 22 is an XML document for providing a conversion specification for a conversion and/or a reconversion. That is, it is extremely cumbersome, costing time and money, to create a style sheet, i.e., XSL (Extensible Stylesheet Language) sheet for the respective XML document corresponding to a diverse kind of XML documents. Accordingly, the present embodiment (as with the prior patent application) makes ready by creating an XML document with a specification for converting the data structure of an XML document, that is, the conversion specification XML document 22.

The structural conversion unit 11 converts the input XML document 21 into the converted XML document 23 based on the conversion specification provided by the conversion specification XML document 22, while the reconversion unit 12 reconverts the extracted XML document 24 to the resultant XML document 25. Meanwhile, although the processing method can be through a direct conversion and/or reconversion based on the conversion specification, a process may be required in which reading and judging a conversion specification for each record when converting a large amount of data.

The XSL conversion unit 13 generates a conversion XSL sheet 15 (“data structural conversion style sheet” noted in claims herein) for specifying a conversion processing procedure and a reconversion XSL sheet 16 (“reconversion style sheet” noted in claims herein) for specifying a reconversion processing procedure based on the conversion specification XML document 22 and a conversion XSL sheet generation XSL sheet 14 (“automatic conversion style sheet” noted in the prior patent application) for the above processing. Meanwhile, although there is one of the conversion XSL sheet generation XSL sheets 14 for generating the conversion XSL sheet 15 and another thereof for generating the reconversion XSL sheet 16, they are treated as one herein.

And the structural conversion unit 11 or the reconversion unit 12 may perform a conversion processing or a reconversion processing, respectively, by thus generated XSL sheet 15 or 16, respectively. Performing a conversion and/or reconversion after generating the XSL sheet 15 or 16 eliminates an operation of reading and judging the conversion specification for each record and hence enables a high speed execution.

Meanwhile, by the style sheet thus providing the execution procedure for a conversion and/or reconversion, it is possible to make a standard XSLT processor execute a conversion and/or reconversion and therefore execute a conversion and/or reconversion according to the present embodiment in most kinds of XML document management systems. In this case, the data structural conversion and/or reconversion mechanism 10 (comprising the structural conversion unit 11, the reconversion unit 12 and the XSL conversion unit 13) is actually made possible by one of the standard XSLT processors (i.e., structured document conversion processor) for example.

Note that the extracted XML document 24 is a result of the converted XML document 23 being developed into a DOM tree on a memory by the application software 30, a part of record of the converted XML document 23 being taken out through a certain processing, e.g., a tag search, and converted into an XML document. Subsequently, the resultant XML document 25 is obtained by reconverting the extracted XML document 24 back to the original state of the document.

As described above, the present embodiment proposes processing of four embodiments for which the summary process flow for the overall processing and configurations shown in FIG. 2 are common. What follows here are the first embodiment dealing with a fixed form XML document being subjected to conversion; the second and third embodiments dealing with first and second methods, respectively, both dealing with an unfixed form XML document; and the fourth embodiment containing two methods dealing with another type of unfixed form XML documents.

What follows first is a description of the first embodiment.

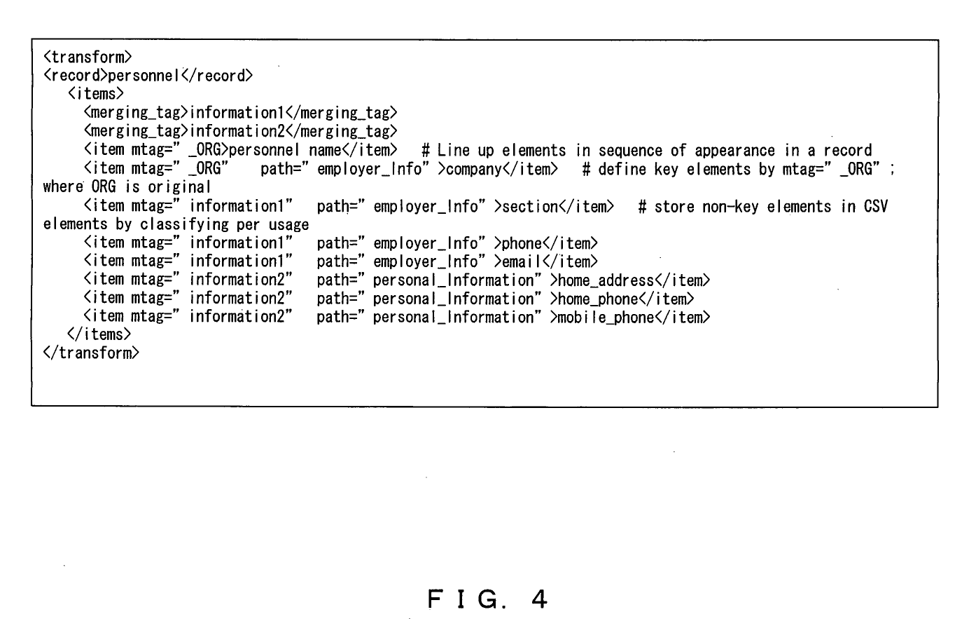

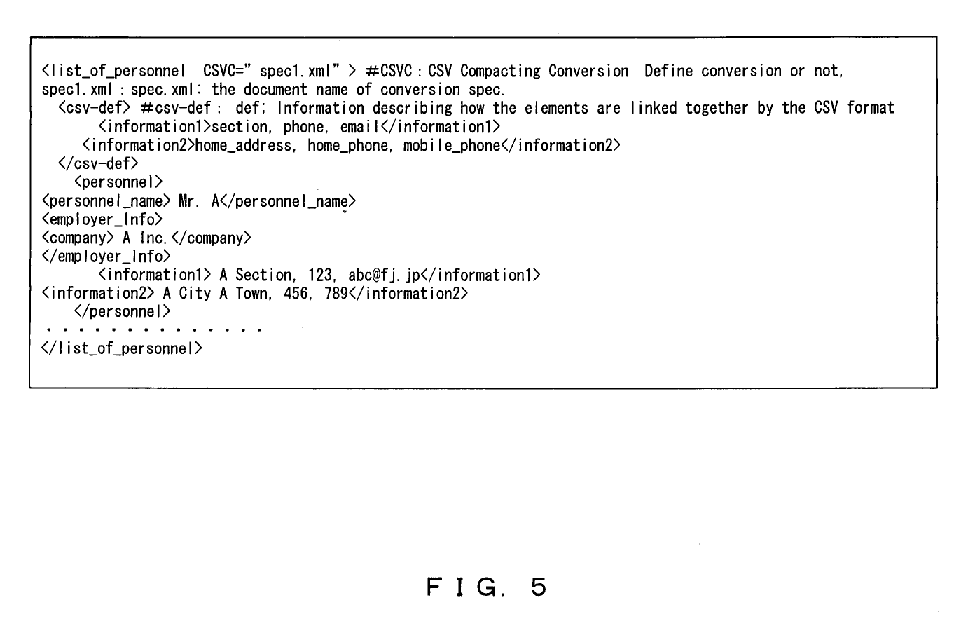

The fixed form XML documents subjected to conversion in the first embodiment include for instance an XML document containing data in a table form in which the number of elements and tag names in a record are fixed as exemplified by FIG. 3. This corresponds to the input XML document 21. FIG. 4 shows an example of conversion specification XML document 22 corresponding to the fixed form XML document shown by FIG. 3. FIG. 5 shows an example of the converted XML document 23 as a result of the structural conversion unit 11 converting the fixed form XML document shown by FIG. 3 by using the conversion specification XML document 22 shown by FIG. 4.

A fixed form XML document, while the example shown by FIG. 3 only indicates two records, will contain many more records usually. Also, in the example shown by FIG. 3, each record (the tag named “personnel”) is made up by two hierarchical layers dividing the record into the employer and the personal information, but the hierarchical layer is not limited as such. Rather, it may be one layer, or three or more layers.

In FIG. 3, each record contains one element for the respective tag name “name,” “employer_info,” and “personal information” The elements under the tag name “employer_info” is a hierarchical structure having the tag names “company” “section,” “phone” and “email.” Likewise, the elements under the tag names “personal_information” is a hierarchical structure having the tag names “home_address,” “home_phone,” and “mobile_phone.” Being a fixed form XML document, all records, and not just these two records shown, have the same hierarchical structure.

Meanwhile in the conversion specification XML document 22 exemplified by FIG. 4, the name of a record being subjected to conversion is described first as the element content of the element “record” named by a tag. This is followed by describing elements of the tags named “merging_tag” and “item” as the elements within the tag named “items.”

The names of CSV elements (i.e., tag names of the CSV element) are described in the element contents of the elements of the tag named “merging_tag.” A plurality of the element contents of the tag name “merging_tag,” that is, the CSV element names, may be freely defined independent of the hierarchical structure of the input XML document 21.

While the present embodiment, as with the prior patent application, creates a converted XML document by linking contents of non-key elements together into a new element (which is called “CSV element”) by the CSV format when converting an XML document, while leaving the key elements as they are, the present embodiment allows a plurality of CSV elements to be freely defined independent of the structure of the input XML document 21, thereby making it possible to define them for an easy handling by the application software 30. Also, there is no particular limitation for the number of CSV elements, allowing an increase of the number thereof with the number of non-key elements and thereby suppressing the number of non-key elements to be linked together into one CSV element by the CSV format. This limits the number of non-key elements to be handled by the application software 30 in developing the applicable CSV elements only, if a situation arises to require the any given non-key elements for processing, hence preventing an overhead from becoming large.

The two tag names for two CSV elements, i.e., “information1” and “information2” are defined in the example shown by FIG. 4 which do not have a large number of non-key elements, whereas the number of CSV elements may be increased with the number of non-key elements.

Next, for elements of the tag named “item,” the tag name of each element being described for the record in the XML document subjected to conversion are written as the element contents.

In the meantime, the expression “elements of the tag named ‘item’” is now changed to the “‘item’ element” or “element ‘item’” for avoiding confusion.

Also, “the tag name of each element described in the record for XML document subjected to conversion,” which is the element content of an “‘item’ element” will be specifically called “element name.”

For each “item” element, the conversion specification for the respective element is defined in sequence of appearance of the elements in the record, starting from the top of FIG. 4.

First, the element name is the tag name in sequence of elements appearing in a record as shown by FIG. 4. For instance, the element name of the first “item” element is “name” which is the tag name of the element appearing first in the record of the XML document subjected to conversion. By this practice, each element is outputted in the same sequence as the original document when reconverting the converted XML document back to the original document based on the applicable conversion specification.

Also, a predefined attribute “mtag” is given to each “item” element within the tag. In other words, the attribute “mtag” specifies as for which CSV element to store the element content of each “item” element in, that is, the above described “element name.” Except that when specified as mtag=“_ORG,” it means the element of the element name is a key element. In the example shown by FIG. 4, assuming that the application software 30 searches by the elements “name” and “company” as key words for a search processing by using the converted XML document, the attribute, “mtag”, “_ORG” defines that the element names “name” and “company” are key elements. Also, “path” attribute defines the hierarchical layer on which the element of each element name is located within the record.

As for non-key elements, which are elements other than the above described key elements, the CSV element “information 1” contains the non-key elements “section,” “phone” and “email” (while each is defined by “path” attribute as “employer_info” but not limited as such) in the example shown by FIG. 4, while another CSV element “information2” contains the non-key elements “home_address,” “home_phone” and “mobile_phone” (also is defined by “path” attribute as “personal_information”, but is not limited as such. That is, allocation of a CSV element is not in accordance with the hierarchical structure of the pre-conversion original document).

Meanwhile, let the file name of the conversion specification XML document 22 shown by FIG. 4 be “spec1.xml”.

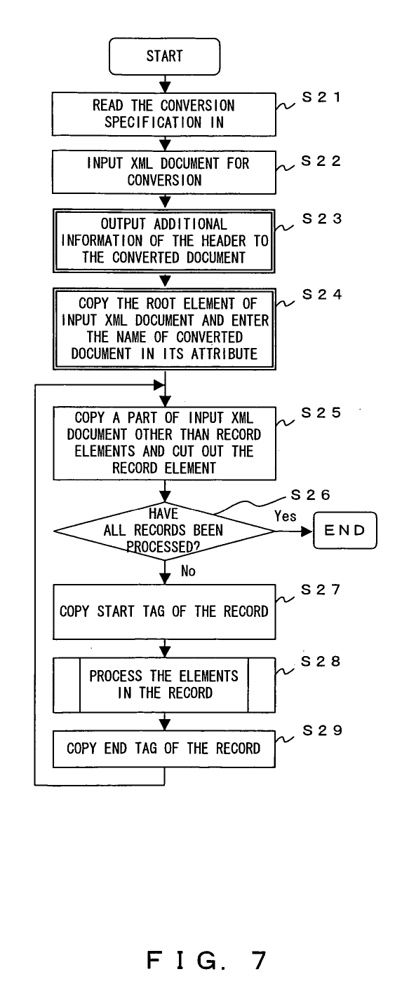

The structural conversion unit 11 converts the fixed form XML document shown by FIG. 3 by executing processing shown by FIG. 7 by using the conversion specification XML document 22 shown by FIG. 4 into the converted XML document 23 shown by FIG. 5. Note that FIG. 5 shows the conversion result of record for only Mr. A, but the other record (i.e., Mr. B) is also converted.

Referring to FIGS. 5 and 7, the structural conversion processing according to the present embodiment is described in the following.

Incidentally, FIG. 7 is a basic process flow chart of a structural conversion processing for the XML document common to the first through third embodiments.

Meanwhile, the processing shown by FIG. 6 may be applied if the application software 30 has no use of a non-key element. FIG. 6 is a basic process flow chart of a structural conversion processing for an XML document. The difference between the processing of FIG. 7 and FIG. 6 are adding the processing of the step S23, and replacing the processing of the step S13 in FIG. 6 with the processing of the step 24, both for FIG. 7. Other processing are the same between the two figures, and therefore a description of FIG. 6 is omitted herein.

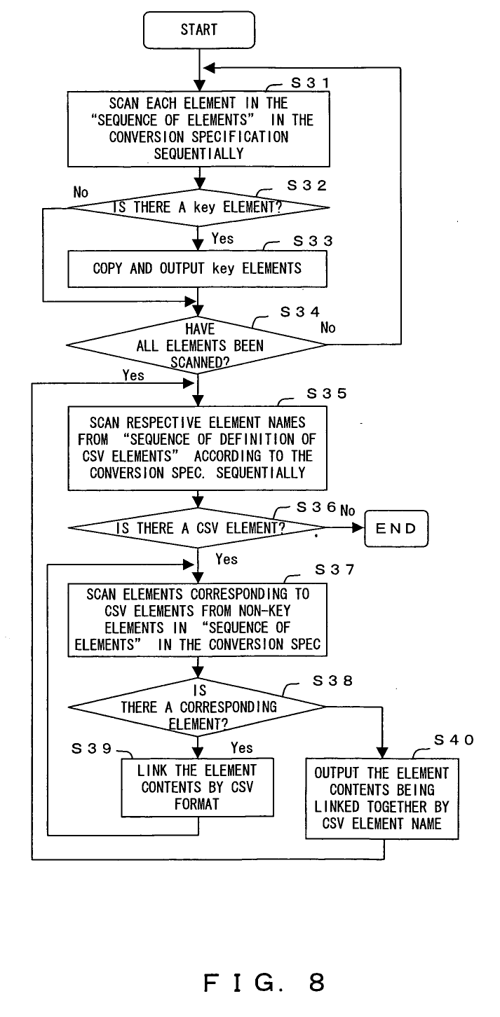

FIGS. 6 and 7 show flow charts of conversion processing performing while reading the conversion specification directly in; and FIG. 8 is a detailed flow chart for the step S17 of FIG. 6 or the step S28 of FIG. 7.

Note that FIGS. 6 through 9 show processing executed by the data structure conversion and/or reconversion mechanism 10.

In FIG. 7, first the data structure conversion and/or reconversion mechanism 10 reads in the conversion specification XML document 22 and analyzes the conversion specification according to the specification content (step S21), followed by inputting the input XML document 21 as a conversion subject (step S22). The aforementioned mechanism 10 continues to execute the processing of the steps S23 and thereafter based on the analyzed conversion spec. and the input XML document 21.

First of all, the aforementioned mechanism writes additional information for its header (i.e., <csv-def>) in the converted XML document 23 (nothing is written at this moment) (step S23). That is, the additional information is added to the header of the converted XML document 23 according to the conversion specification specified by the conversion specification XML document 22, in which the name of a CSV element as the tag name and the element names of non-key elements, being linked together by the CSV format, as the element contents corresponding to the respective CSV element for each CSV element. In this example, as shown by FIG. 5, a CSV element name “information1” containing the corresponding non-key element names “section,” “phone” and “email”; and another CSV element name “information 2” containing the corresponding non-key element names “home_address”, “home_phone” and “mobile_phone” are respectively written with the element names being linked together by the CSV format, according to the conversion spec. shown by FIG. 4.

Being given the meaning of the element content by the tag name, an XML document has a self-describability characteristic. Although the self-describability characteristic of the XML document tends to be lost by bringing in the CSV format because tags are removed for the part written by the CSV format, the self-describability characteristic is in fact maintained by embedding the aforementioned additional information in the converted document.

In other words, it is possible for the application software 30 to comprehend the element name corresponding to the respective element content by referring to the additional information when executing some kind of processing by using the converted XML document.

Then the aforementioned mechanism 10 copies the root element of the input XML document 21, writes a “CSVC (CSV Compacting Conversion)” as the attribute indicating that the converted XML document 23 is a CSV conversion document and, at the same time, enters the file name of the conversion specification XML document 22 (step S24). In the example shown by FIG. 3, the root name is “list of personnel” and the file name of the conversion specification XML document 22 is “spec1.xml” as noted above, and therefore is written as <list of personnel CSVC=“spec1.xml”> as shown by FIG. 5. Note that while the file name of the conversion specification XML document 22 is written herein, the name of a reconversion XSL sheet 16 may be written instead. Or, for instance a URL may replace such file names.

While there may be a number of converted XML documents 23 being created depending on a selection of parameters specified by the conversion specification XML document 22, a relationship with the input XML document 21 as the original XML document is maintained by writing the file name of the conversion specification XML document 22 or the sheet name of a reconversion XSL sheet in the converted XML document 23.

Then, copies a part of the input XML document 21 other than the record elements into the converted XML document 23, and cut out each record element (step S25). A record element is one sandwiched by a pair of tag names for meaning elements describing a record, that is, the elements sandwiched by the tag names <personnel> and </personnel> as exemplified by FIG. 3. While the example of FIG. 3 shows only the record elements, there are many cases where other descriptions (not shown) are actually contained in addition to the record elements, therefore those will be copied into the converted XML document 23.

Then repeats the steps S27 through S29 until all the records are processed for each record element, that is, a judgment in the step S26 becomes “yes”. In the example shown by FIG. 3, processes all the record elements for Mr. A, followed by processing the record for Mr. B and all the other records.

For processing the steps S27 through S29, first copies the start tag of a record element into the converted XML document 23 (step S27). In the example of FIG. 3, the start tag is <personnel>.

Then, processes the elements in the record (step S28) and, finally, copies the end tag of the record element (i.e., </personnel> in FIG. 3) into the converted XML document 23 (step S29).

FIG. 8 is a detailed process flow chart of the step S28.

In FIG. 8, first refers to the conversion specification XML document 22, executes the processing of copying all the key elements, as they are, from the input XML document 21 into the converted XML document 23. That is, scans each element in the “sequence of elements” in the conversion specification XML document 22, i.e., “item” elements, one after another (step S31), and judges whether or not the element of the element name is a key element (step S32). That is, if a character string defined by an attribute tag of “item” element is mtag=“_ORG”, then the element of the element name is a key element (i.e., “yes” in step S32).

Then, copies the key elements written in the record subjected to processing of the input XML document 21, as they are, into the converted XML document 23 (step S33). In the examples shown by FIGS. 3 through 5, for instance in FIG. 4, the element of the element name “name” in the first “item” element of the “sequence of elements” is described by an attribute mtag=“_ORG” and therefore is judged as a key element. And the first record is “Mr. A” in FIG. 3, and therefore the element of the tag name “name”, the part “<name>Mr. A</name>” is copied, as it is, into the converted XML document 23. Likewise executes the processing until the above described processing are done for all the “item” elements in the “sequence of elements” (i.e., “yes” in the step S34), when the processing proceeds to the steps S35 and thereafter.

The processing in the steps S35 through S40 refer to the conversion specification XML document 22, searches and obtains the “item” elements corresponding to the respective CSV element for each CSV element, links the element contents of the respective “item” elements, that is, the names of non-key elements, together by the CSV format and outputs to the converted XML document 23. First of all, referring to the conversion specification XML document 22, scans the respective element names (i.e., CSV element names) from “sequence of definition of CSV elements” sequentially (step S35), and judges whether or not there is a CSV element (step S36). An element of the “sequence of definition of CSV elements” is actually a “merging_tag” element shown in FIG. 4 in which “information 1” exists in the first place, and therefore the judgment in the step S36 is “yes”, followed by scanning non-key elements of “sequence of elements” in the conversion specification XML document 22, that is, the “item” elements defined by the respective CSV elements in each “item” element, not defined as “_ORG” by the attribute mtag, and searching non-key elements corresponding to the above described CSV element (“information 1” herein) (step S37).

Then, every time a corresponding non-key element is found (i.e., “yes” in step S38), obtains the element content thereof from the input XML document 21 and links the aforementioned element content by the CSV format (step S39). The non-key element corresponding to the above described CSV element “information 1”, that is, the one defined as mtag=“information 1” is the element name “section” at first and “path=”employer_info”, in the example shown by FIG. 4, and therefore obtains the element content “A section” of the “section” element from the input XML document 21 according to the aforementioned path. Likewise, obtains the element contents “123” and “abc@fj.jp” of the element names “phone” and “email”, respectively, from the input XML document 21 according to the aforementioned path, followed by linking these element contents together one after another by the CSV format. Then, when the corresponding non-key element is no longer found (i.e., “no” in step S38), outputs a new element (i.e., a CSV element), in which the element contents of the above described non-key elements are linked together by the CSV format and attached with the above described CSV element name “information 1” as the tag, into the converted XML document 23 (step S40). The result is as shown by FIG. 5:
<information1>Asection,123,abc@fj.jp</information1>
is written in the converted XML document 23.

Then, going back to the processing of the step S35, obtains the next CSV element name “information 2” and performs the same processing as above described, resulting in, as shown by FIG. 5:
<information2>ACityATown,456,789</information2
is written in the converted XML document 23.

As there is no CSV element following “information 2” (i.e., “no” in step S36), the aforementioned processing is complete. This completes a creation of the converted XML document 23.

By the above conversion processing, placing all the CSV elements (i.e., “information 1” and “information 2” in this embodiment) on the same hierarchical layer (first layer in the embodiment) as a record in the converted XML document 23 and storing the element content of each element belonging to “employer_info” and “personal_information” in “information1” and “information2”, respectively, provide a document structure so as to enable the application software 30 to easily handle the non-key elements unexpectedly when such a situation arises. Note that “employer_info” and “personal_information” are on the same layer in this embodiment, possibly making it difficult to understand, but even if “employer_info” and “personal_information” were on the different layers from each other, “information1” and “information2” would definitely be on the first layer in a record. Also as described above, all element contents of elements belonging to “employer_info” do not necessarily have to be included in “information1”, thus making it possible to define freely according to the conversion specification XML document 22. Also, as described above, an overhead will not become large even with a large number of non-key elements.

What follows next is a detailed description of reconversion processing, that is, a reconversion of the converted XML document 23, which is obtained by the structural conversion for a fixed form XML document, back to the originally structured XML document. In the example shown by FIG. 2, firstly, the application software 30 produce the extracted XML document 24, being obtained through a tag search, et cetera, according to a search condition required by the client for instance, from among a plurality of converted XML documents 23. Next, the reconversion unit 21 reconvert the extracted XML document 24 and outputs the resultant XML document 25 as the reconverted result. Therefore the description will be given herein according to the above procedure.

First of all, an entire flow chart of a reconversion processing is not particularly shown, but it is basically the same as a conversion flow shown by FIG. 6, except for a part thereof. The difference is that an inputting XML document to be subjected to conversion in the step S12 is the extracted XML document 24 and therefore, the “input XML document” in the steps S13 and S14 is now simply replaced by the “extracted XML document 24”. Meanwhile, if the extracted XML document 24 is a result of conversion processing shown by FIG. 7, the attributes are removed when copying the root element in the step S13. Also the additional information of the header is removed when copying for the processing in the step S14.

Meanwhile, the processing content in the step S17 is naturally different from FIG. 8.

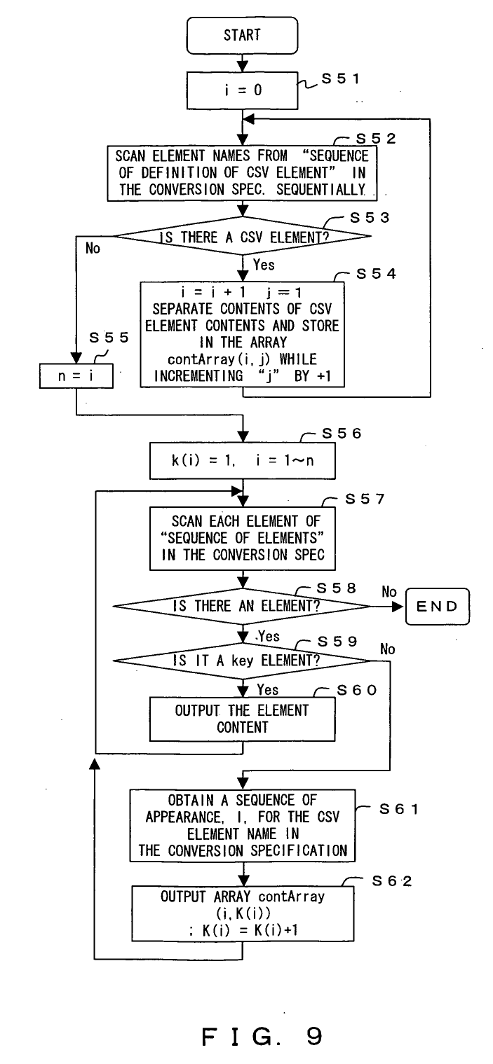

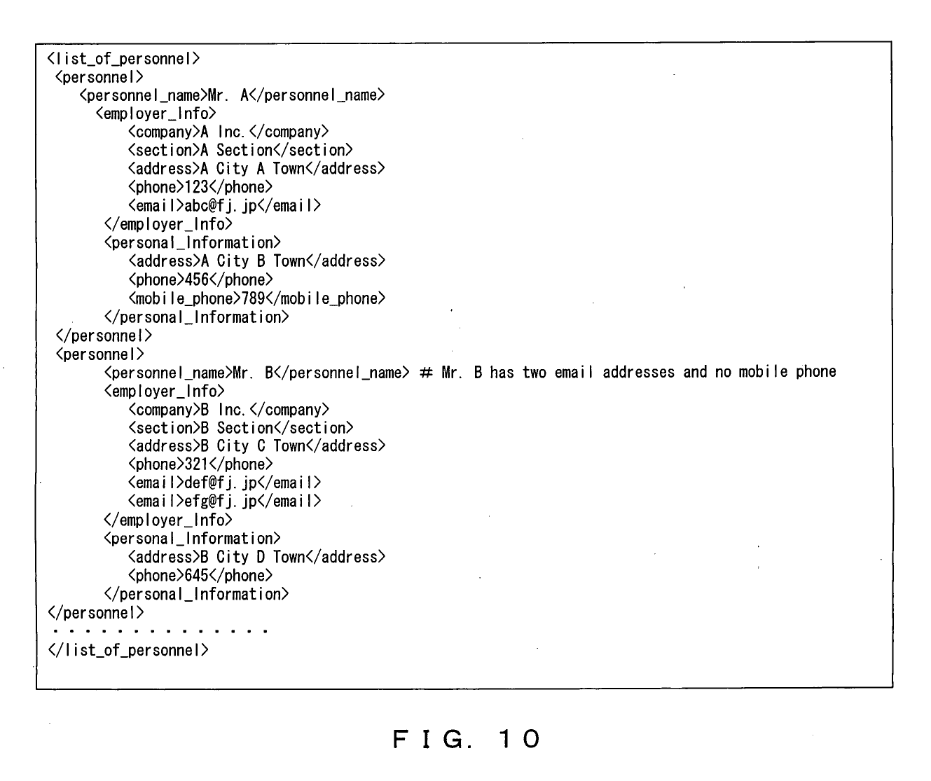

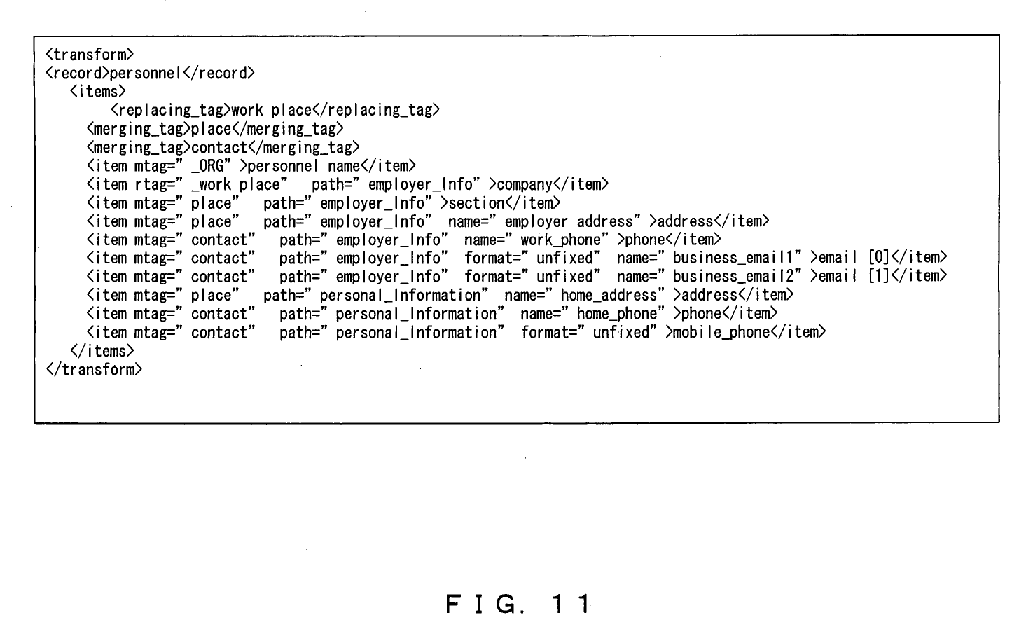

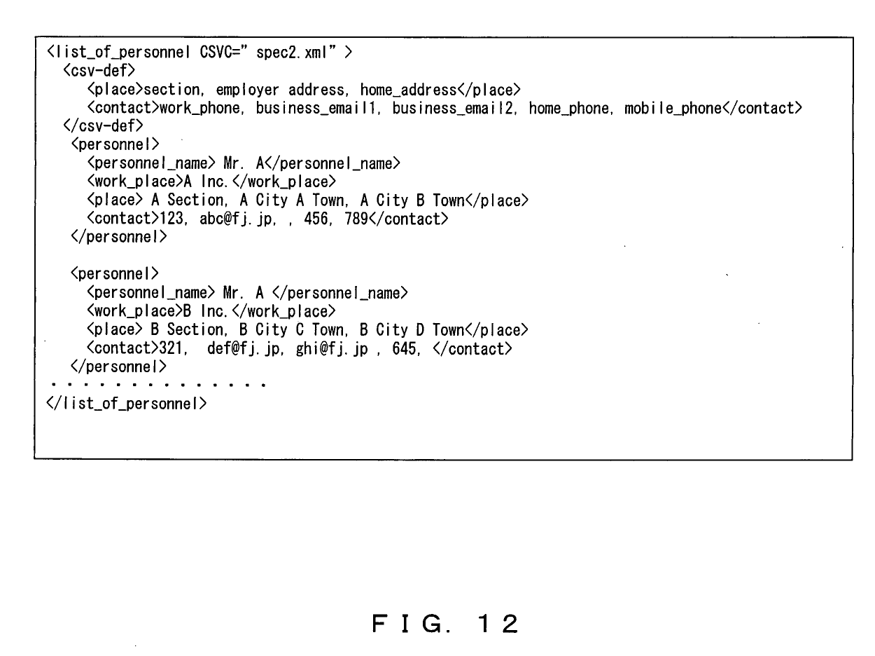

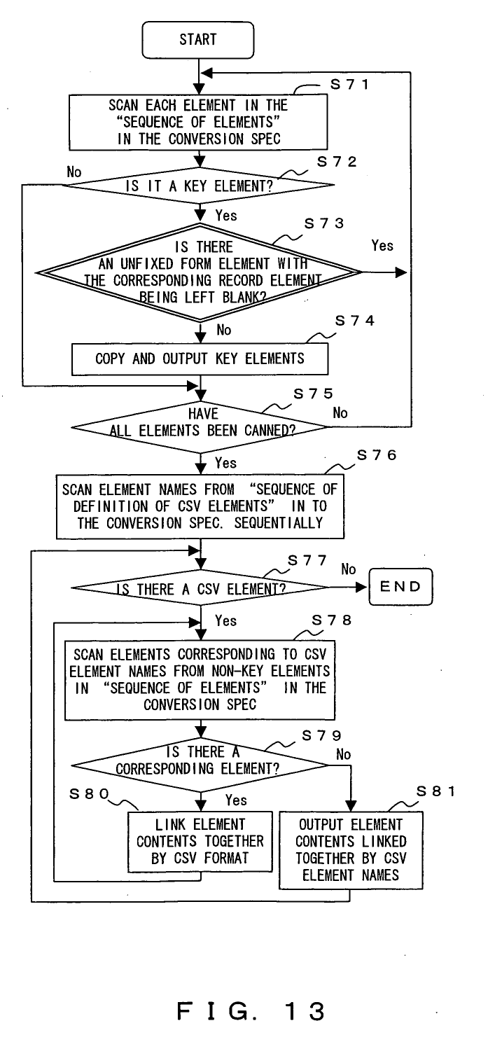

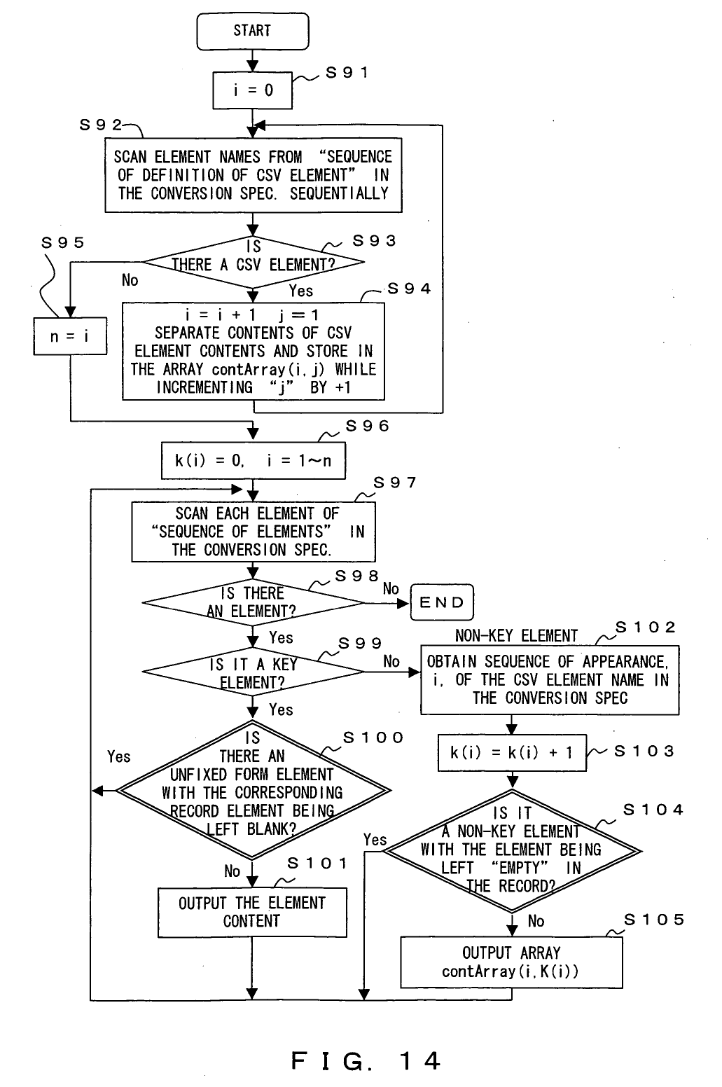

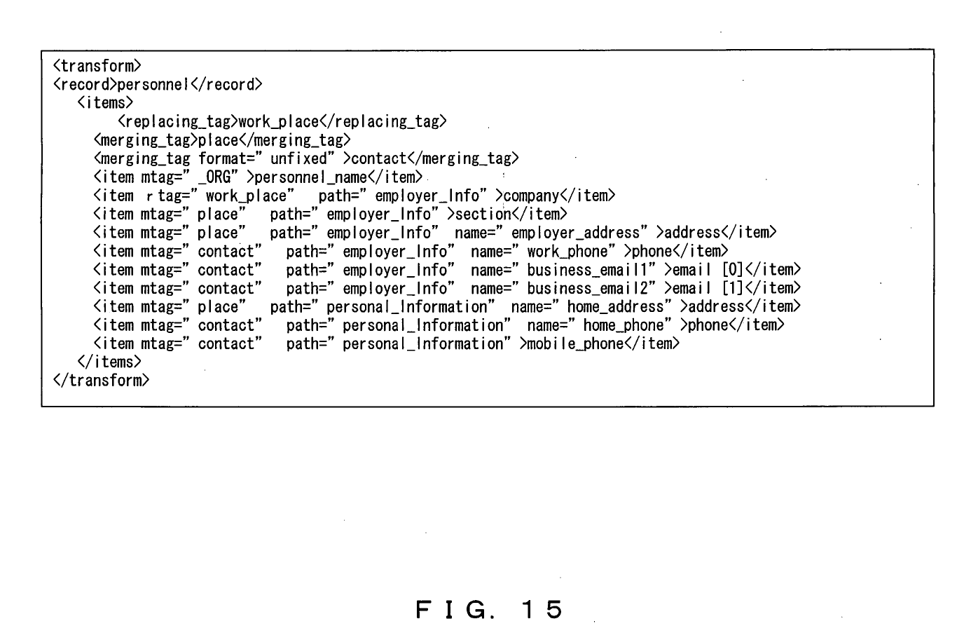

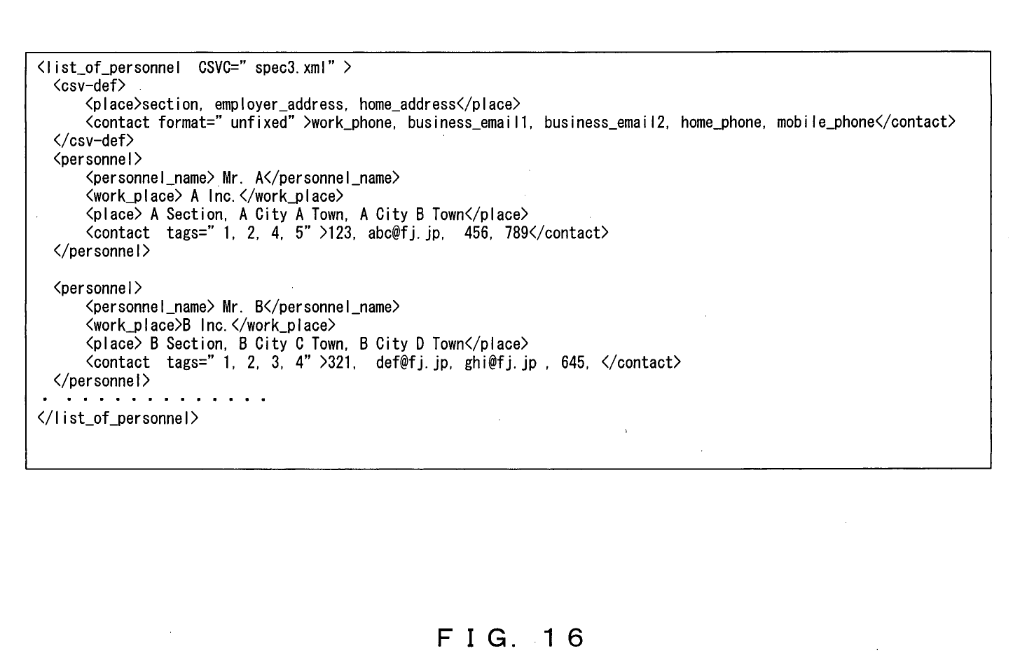

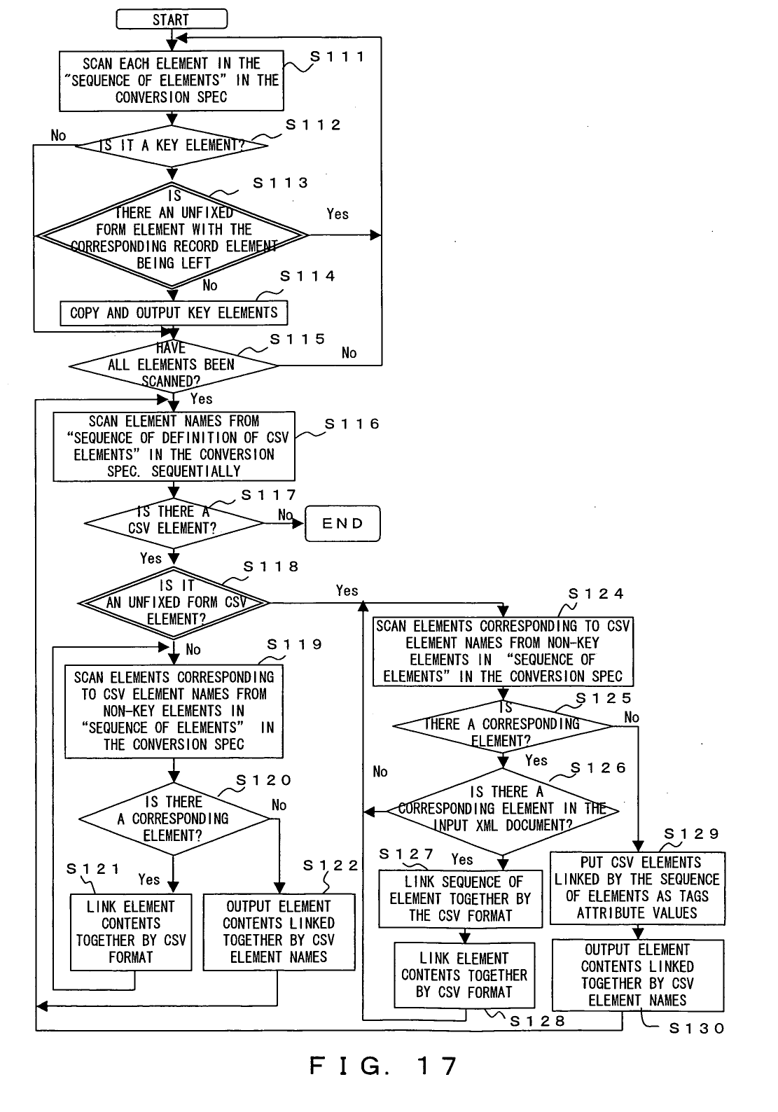

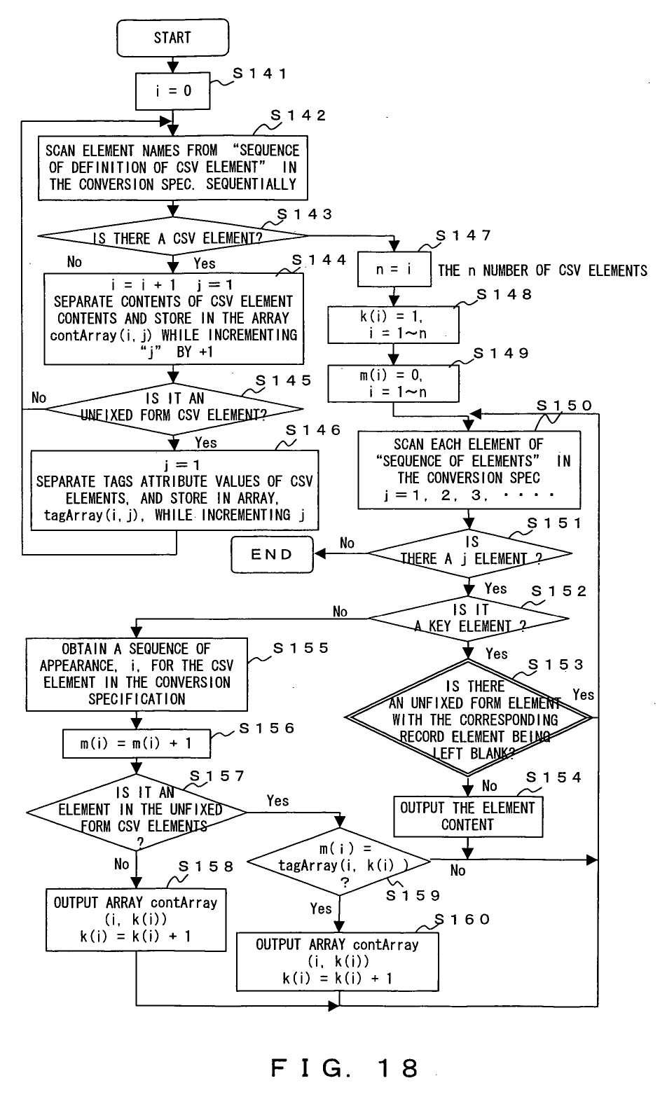

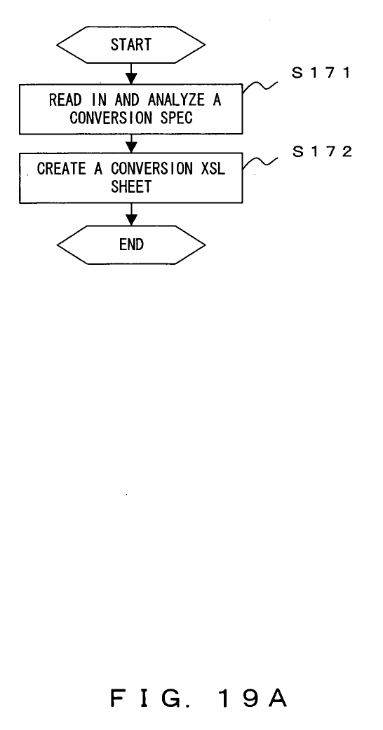

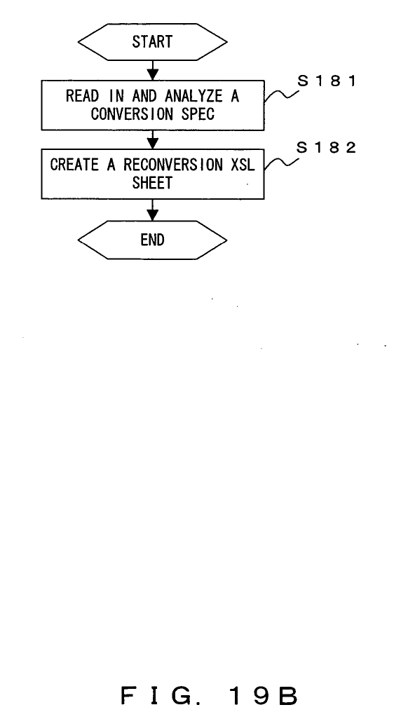

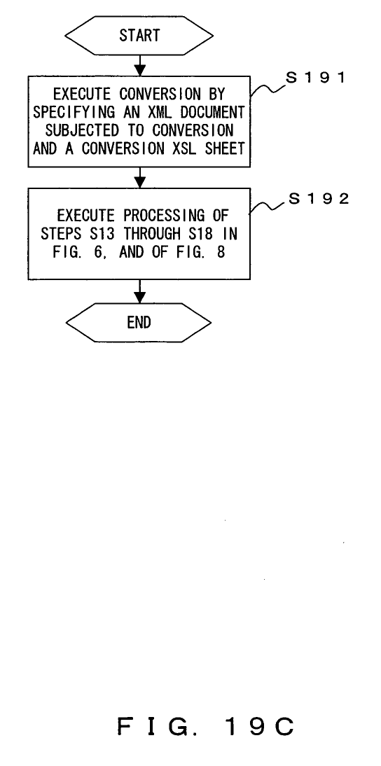

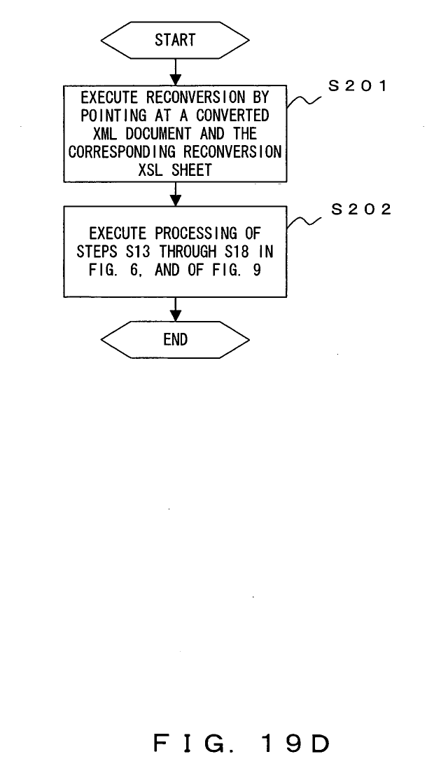

FIG. 9 is a detailed process flow chart of the step S17 in a reconversion processing.

The reconversion processing shown by FIG. 9 is to separate a character string representing the element contents by the commas “,” for each CSV element, store them in a prescribed arrangement and output by arranging the key and non-key elements in the sequence of “sequence of elements” specified by the conversion specification XML document 22.

The description herein deals with the case of reconverting the XML document shown by FIG. 5 back to the original XML document shown by FIG. 3 according to the conversion specification shown by FIG. 4. Therefore the resultant XML document 25 becomes the content shown by FIG. 3.

In FIG. 9, first substitutes zero for a variable “i” (step S51).

Then, referring to the conversion specification XML document 22, scans element names (that is, CSV element names) from “sequence of definition of CSV element” sequentially (step S52), and judges whether or not there is a CSV element (step S53). An element of “sequence of definition of CSV element” is a “merging_tag” element shown by FIG. 4 in which first “information 1” exists and therefore the judgment in the step S53 becomes “yes”.

Then, increments i by +1 (i.e., i=i+1) first. Then, substitutes the initial value “1” for the variable j. And, referring to the extracted XML document 24, obtains element contents of the above described CSV element, separates them with the punctuation marks, comma, “,”and stores them in the arrays, contArray (i,j), while incrementing j by +1 (step S54). In the above example, since i=1, and the element content of the element “information 1” in the extracted XML document 24 is “A section, 123, abc@fj.jp”, separates these and stores in the arrays, contArray (i,j), then “A section” is in the array (1,1), “123” in the array (1,2) and abc@fj.jp in the array (1,3) are respectively stored. For another CSV element “information 2”, “ACityAtown” in the array (2,1), “456” in the array (2,2) and “789” in the array (2, 3) are stored, respectively, as a result of similar processing.

When finishing the above described processing for all CSV elements (i.e., “no” in step S53), substitutes a current value of i for the variable n (step S55). In the above described example, i=2 by the processing for the CSV element “information 2”, substitutes it for the variable n. Subsequently, sets k (i)=1 for each of i=1˜n (step S56). In the above described example, since i=1˜2, sets k (i)=1 for i=1 and i=2, respectively. That is, k (1)=1, k (2)=1.

Then, repeats the processing of the steps S57 through S62.

First, scans each element of “sequence of elements” in the document 22 sequentially (step S57), and if an “item” element exists (“yes” in step S58), judges whether or not the element of the element name of the “item” element is a key element (step S59). That is, if mtag=“_ORG” in the tag attribute of the “item” element, the element of the element name is judged as a key element (“yes” in step S59). If it is a key element, copies the key element of the extracted XML document 24, which is one contained in a record subjected to conversion, into the resultant XML document 25 (step S60). In the example shown by FIG. 4, the element name of the first key element in the “sequence of elements” is “name”, and if the record subjected to processing is for “Mr. A”, then copies the element “<name>Mr. A</name>” into the resultant XML document 25 as it is.

On the other hand, if it is a non-key element (i.e., “no” in step S59), that is, a CSV element name is defined, instead of “_ORG”, in a tag attribute, mtag, of “item” element, obtains an order of appearance, i, for the aforementioned CSV element name in the conversion specification XML document 22 (step S61), and outputs the data stored in the arrays, contArray(i,k(i)), to the resultant XML document 25 along with element names of the aforementioned non-key element (step S62).

In FIG. 4, for instance, since the non-key element appearing first in the “item” element sequence is the element by the element name of “section”, and the CSV element name defined by the tag attribute, mtag, is “information 1”, subsequently when referring to “merging_tag” element, the order of appearance of “information 1” is first, thus becoming i=1 for the sequence of appearance. Meanwhile, since k (i=1) is the initial setting value of “1” at this stage, a data stored in the array (1,1), that is, “A section”, along with the element name “section,” is written in the resultant XML document 25. Needless to say, but the “path” is referred to for the practice.

Meanwhile, at the end of processing in the step S62, lets k(i)=k(i)+1. By this, a next appearance of non-key element corresponding to the CSV element “information 1” will cause to output data stored in the array (1,2).

When completing the above described processing for all the “item” elements in the “sequence of elements” contained in the conversion specification XML document 22 (step S58), the processing is finished. At this moment the content of the resultant XML document 25 is the same as FIG. 3 in the above described embodiment.

Conventionally, when comparing a pre-conversion original XML document with the converted and then reconverted XML document, the sequence of the elements are changed, while the content per se staying the same, looking as if the document had been changed to the user's eyes, whereas the processing according to the present embodiment does not allow a changing sequence of elements, enabling a complete reconversion back to the original document.

The structural conversion and/or reconversion processing for the fixed form XML document are thus far described.

What follows here is a description of structural conversion and/or reconversion processing for unfixed form XML document.

As noted above, the processing contain the second and third embodiments.

First of all, FIG. 10 shows an example of unfixed form XML document as the input XML document in the second and the third embodiments.

The unfixed form XML document has a variable number of elements and tag names in a record as shown by FIG. 10.

The example shown by FIG. 10 considers the case of making “name” a key element, while handles “company” either as a key element or a non-key element.

Meanwhile form on-key elements, FIG. 3 has had the same element names and the number of elements for both Mr. A and Mr. B (not just limited to Mr. A and Mr. B, but also to other records), whereas FIG. 10, being an unfixed form XML document, has different tag names and the number of elements. That is, non-key elements about Mr. A are element names “section”, “address”, “phone” and “email” as the employer info, while element names “address”, “phone” and “mobile_phone” as the personal information. On the other hand, non-key elements about Mr. B are element names “section”, “address”, “phone”, “email” and “email” as the employer info, while element names “address” and “phone” as the personal information.

Mr. B, comparing with Mr. A, has two “email” as the employer info, while no “mobile_phone” as the personal information. That is, Mr. B has two email addresses while he has no mobile phone, thus inputting such personal information.

Note that although the example has element content of key elements being written in the input XML document 21, there may be no such info written.

Both the second and the third embodiments use a non-fixed XML document shown by FIG. 10 as described above for the input XML document 21 in the following description.

First of all, the description is about the second embodiment.

FIG. 11 shows an example of conversion specification XML document 22 in the second embodiment.

In FIG. 11, first the description will be given about a conversion specification for outputting to the converted document by replacing the element of original document “employer_info/company” with discretionary other name “work_place”. This is done by defining new element name “work place” with <replacing_tag>, and specifying as rtag=“work_place” by an attribute at the element “company” in the “sequence of element”. By this practice, not just two layers, but also deeper layers such as three or more can be easily read out by the application software by raising elements on a deeper layer to the first layer. Also, this case is special in that only one element is to be linked together by the CSV format. Although there is no requirement for distinguishing between one and a plurality thereof, but distinguishing them makes it easy to operate a conversion and/or reconversion.

Meanwhile, there are two of “address” and “phone”, respectively, in the example shown by FIG. 10. That is, there are “address” and “phone” in both “employer_info” and “personal_information”. In such a case if an element name is only outputted into the converted XML document 23, the application software 30 cannot identify one from the other. Faced with this, the prior patent application has outputted in the forms of “employer_info/address”, “employer_info/phone”, “personal information/address” and “personal_information/phone” by using tags, which has become redundant writing with a depth of hierarchical layers. Contrarily the present embodiment provides a name attribute as a tag attribute of “item” element as exemplified in conversion specification XML document 22 shown by FIG. 11. A different name is defined by the name attribute and the different name is written in the header of converted document as additional information. In the example shown by FIG. 11 different names such as “employer_address” instead of “employer_info/address” and “home_address” instead of “personal_information/address” are provided. And the different names are used for writing the additional information for the header shown by FIG. 12 and used for the application software 30 performing a discretionary processing. “Phone” is handled in the same way. The “email”, allowing two addresses thereof, the different name is given as shown by FIG. 11.

As such, giving an element name for defining uniquely when linking the element contents of non-key element together into a CSV element, which is reflected on the converted document, enables the application software 30 to handle the document in a different way of putting together independent of the original document and different element names. This may be applied to the first embodiment, incidentally.

Also, the present embodiment provides a format attribute in “item” element tag as shown by FIG. 11 in which for example the attribute, format=“unfixed”, is attached to the each “item” elements of “employer_info/email[0]”, “employer_info/email[1]” and “personal_information/mobile phone”, thereby making it possible to define that each of the element contents of elements by these names does not appear in a fixed manner in the input XML document 21.

The above phrase “does not appear in a fixed manner” points at the data of which Mr. B did not enter a mobile phone number since he had no possession of one in the example shown by FIG. 10. The format=“unfixed” defines such fact that an element content of the element by the element name is not necessarily entered.

Meanwhile, if the attribute, format=“unfixed”, is not attached to a tag, the element content of the element by the element name is certainly entered. That is, in an example of general practice where mandatory input items are defined, and displayed, so as to declare an error if a “registration”, et cetera, is requested with any of the mandatory input items being left blank when calling for optional information (such as personal information about a certain user herein) in certain home page on the web. An element without the above described attribute, format=“unfixed”, being attached can be considered to be corresponding to the mandatory input item. The attribute, format=“unfixed”, can be defined for both key and non-key elements.

However, the attribute, format=“unfixed”, does not necessarily have to be defined for the case of unfixed appearance of data. In such event, an “unfixed form element and . . . ” condition in the later described processing of the steps S100 and S104 shown by FIG. 14 will disappear. In such case, however, a processing of making “error” will no longer be possible even if an element does exist for the one without the attribute, format=“unfixed”, being specified.

FIG. 12 shows an example of converted XML document 23 as a result of structural conversion of unfixed form XML document shown by FIG. 10 by using the conversion specification XML document 22 shown by FIG. 11.

FIG. 13 is a detailed process flow chart of “processing the elements in a record” in a structural conversion processing according to the second embodiment. That is, as process flow of the overall structural conversion processing according to the second embodiment is approximately the same as in the first embodiment, the overall processing described in association with FIGS. 6 and 7 stands here, hence omitting herein. And, since the processing performed in the step S17 or S28 is different from the first embodiment, it will be described while referring to FIG. 13. Meanwhile, FIG. 12 shows a result of processing for attaching additional information.

However, in the processing shown by FIG. 7, that is, in attaching additional information, the processing content of the step S23 is further a little different. That is, since the name attribute provides a different name for the element name of non-key element given by the additional information of the header in a converted document as shown by FIG. 11 in the second embodiment, the processing in the step S23 is to output the different name specified by the name attribute into the converted XML document 23 as additional information. For instance, since “employer_address” is specified for a non-key element “employer_info/address” by the name attribute in FIG. 11, the “employer_address” is written in a CSV element name “place” as shown by FIG. 12. This practice is the same for other non-key elements. Also, in FIG. 12, a root element “list of personnel” and the name of the converted document in the attribute are written as a result of the processing in the step S24 shown by FIG. 7. Let it be assumed here the file name of the conversion specification XML document 22 as shown by FIG. 11 is spec2.xml.

As described above, a series of information in the personnel tag shown by FIG. 12 is written in the manner that the root element and the header are written as a result of the processing shown by FIG. 13.

In FIG. 13, first of all, basically the processing of the steps S71 through S75 in which picking up all key elements by referring to the conversion specification XML document 22, and copying the element names and the element contents into the converted XML document 23, are approximately the same as that of the steps S31 through S34 shown by FIG. 8. Except that an input document is an unfixed form XML document in the second embodiment, in which not only the non-key elements but also key elements may appear in non-fixed manners. Responding to such possibilities, the processing of the step S73 exists.

In the processing of step S73, if the tag of an “item” element corresponding to a key element picked up in the step S72 is attached by the attribute, format=“unfixed”, and at the same time the aforementioned key element is left blank in the input XML document 21 (i.e., “yes” in step S73), then the aforementioned key element will be refrained from copying.

Although there is no example in FIGS. 10 and 11 making the judgment “yes” for the step S73, if for instance the attribute, format=“unfixed”, were attached to the tag of the “item” element corresponding to the key element “name” in FIG. 11 and at the same time “name” element is not written in FIG. 10, the part <name>Mr. A</name>would not be written in FIG. 12.

Also in FIG. 13, basically the processing of the steps S76 through S81 in which picking up elements corresponding to respective CSV element by a search for each CSV element while referring to the conversion specification XML document 22, linking element contents of the corresponding elements together by the CSV format and outputting onto the converted XML document 23 are approximately the same as that of the steps S35 through S40 shown by FIG. 8. Except that an unfixed form XML document is the input document according to the second embodiment, the non-key elements may appear in non-fixed manners as described above. Facing this, if there is no element content for a certain non-key element, the present embodiment links those “empty” elements together in the processing of the step S80.

For instance, in the processing of the steps S78 and S79 for the record with regard to Mr. A, when picking out an “item” element relating to “employer_info/email[1] in the “item” element of the conversion specification XML document 22 as a non-key element corresponding to the CSV element name “contact” (i.e., “yes” for step S79), the “empty” elements will be linked together in the process of the step S80, since the non-key element “employer_info/email[1]” is left blank as shown by FIG. 10. This will make the element contents of the CSV element name “contact” become:
<contact>123,abc@fj.jp,,456,789</contact>

That is, an empty element “,,” links between the element content “abc@fj.jp” of a new element name “business email1” and the element content “456” of another new element name “home_phone”.

Meanwhile, while not shown by FIG. 13, if a tag attribute, rtag, is specified for a certain “item” element in the “sequence of elements” within the conversion specification XML document 22, the processing executes so as to replace the element name with a new element name defined by the <replacing_tag> and outputs it into the converted XML document 23. This replaces “employer_info/employer” with “work_place”, that is, an element placed on the first hierarchical layer within the record, as shown by FIG. 12. This is a special case where there is one element linked by the CSV format.

The above described processing makes the converted XML document 23 shown by FIG. 12. In the converted document, the element contents of non-key elements which were under “employer_info” and “personal_information” in the input XML document 21 shown by FIG. 10 as the original XML document are now linked together under the CSV elements “place” and “contact” separately as shown by FIG. 12. The aforementioned word “separately” means that not all non-key elements which are under “employer_info” will not necessarily be linked together in the CSV element “place” for instance, but rather may partly be linked together in the “contact”.

Note that the converted XML document 23 writes the element names of element contents being involved in each CSV element as additional information of the header in which new names “employer_address”, “employer_phone”, “home_address” and “home_phone” according to the name attribute of the conversion specification XML document 22 as described above, as opposed to the same-named elements “address” and “phone” under the “employer_info” and “personal_information”, respectively, in the original XML document for element names of which these names are duplicated in a record. This enables application software 30 to handle easily by giving different names to avoid redundancy with a depth of hierarchical layers if other uniquely defined names are given by way of XPath such as “employer_info/address”. This example also assumes the maximum of two entries for “employer_info/email”. Therefore, a repeated appearance of “employer_info/email” is replaced by uniquely defined new names, “business_email1” and “business_email2”.

Next, a reconversion processing according to the second embodiment is described as follows.

The overall flow of reconversion processing of the second embodiment is approximately the same as that of the first embodiment, hence drawing or description is omitted herein.

FIG. 14 is a detailed process flow chart of “processing the elements in a record” in an overall reconversion processing.

In the processing of FIG. 14, since the processing of the steps S91 through S95 are approximately the same as that of the steps S51 through S55 shown by FIG. 9, a description is omitted herein. Except that an array is allocated even if an element content is an empty element in the processing of the step S94. That is, while there is an empty element in front of an element content “456” in a CSV element “contact” in the record regarding Mr. A for instance shown by FIG. 12, the element content “456” will be stored in an array (2,4) as the empty element is allocated to an array (2,3).

The processing of the steps S96 and thereafter is described as follows.

First of all, substitutes the initial value zero for k (i) for each i in the range of i=1˜n (step S96).

Let it be explained here of the reason for substituting the initial value, zero, instead of one (1) as with the step S56 shown by FIG. 9. This relates to performing the processing of incrementing the value of k (i) by +1 in the step S103. While the contents of these processing are in most part the same as that of FIG. 9, in which a value of k (i) was incremented by +1 at the same time the storage content of array was outputted in the processing of the step S62. However, a processing of outputting the storage content of array may not necessarily be performed in dealing with an unfixed form XML document as with the present embodiment (i.e., a judgment in step S104 becoming “yes”), and therefore the value of k (i) will be incremented by +1 (step S103) before a decision in the step S104. Besides, the initial value of k (i) is given by zero in the step S96, because the value of k (i) will be further incremented by +1 before processing of outputting the storage content of the array (i, k(i)).

After the processing of the above described step S96, first scans each “item” element in the “sequence of elements” within the conversion specification XML document 22 (step S97), for each “item” element (i.e., “yes” in step S98), and judge whether of not the element of the element name defined by the “item” element is a key element (step S99). The judgment method has already been described.

If it is judged as a key element (i.e., “yes” in step S99), then subsequently, if the tag of the aforementioned “item” element is attached by the attribute, format=“unfixed”, and at the same time there is no element of the key element in the record subjected to the processing within the extracted XML document 24 which is a conversion object input document (i.e., “yes” in step S100), then outputs nothing into the resultant XML document 25 and the process goes back to the step S97 for processing the next element. On the other hand, if the tag of the “item” element relating to the aforementioned key element is not attached by the attribute, format=“unfixed”, or the attribute, format=“unfixed” is attached and there is an element of the key element name in the extracted XML document 24 (i.e., “no” in step S100), then copies the element name of the key element into the resultant XML document 25 and at the same time copies the element content of the aforementioned key element written in the processing subject record within the extracted XML document 24 into the resultant XML document 25 (step S101).

Meanwhile, if it is judged as a non-key element in the step S99 (i.e., “no” in step S99), that is, the tag attribute, mtag, is not an “_ORG” but a CSV element name, then first obtains the order of appearance, i, of the CSV element name in the conversion specification XML document 22 (step S102), and increments the value of k (i) by +1 (step S103). Then, if the tag of the “item” element relating to the aforementioned key element is attached by the attribute, format=“unfixed”, and at the same time nothing is stored in the array contArray(i,k(i)) (i.e., empty) (step S104), copies nothing into the resultant XML document 25 and goes back to the step S97 and continues to process the next “item” element. Outputs nothing because it is “empty” and outputs no element name of the aforementioned key element either.

On the other hand if the judgment in the step S104 is “no”, then outputs data stored in the array contArray(i,k(i)) into the resultant XML document 25 along with the element name of the aforementioned non-key element (step S105).

The above described processing makes it possible to reconvert a converted document exemplified by FIG. 12 back to the original document shown by FIG. 10. This also makes it possible to bring the sequence of data appearance back to the original document, because each “item” element in the document 22 is put in the sequence of appearance in the original XML document, processed and outputted in the aforementioned sequence.

While not shown in FIG. 14, if there is an attribute, rtag, in the tags of the “item” elements in the conversion specification XML document 22, regarding the element of the element name obtains the element content of a new element name specified by the attribute, rtag (“work_place” in the examples of FIGS. 11 and 12) from the extracted XML document 24, and outputs the element content and the original element name onto the resultant XML document 25.

According to the second embodiment as described above, the same effect is gained for unfixed form XNL document as with the first embodiment. Also as described, a favorable effect is gained by the name attribute.

Next, what follows here is a description of a second method for an unfixed form XML document, that is, the third embodiment.

Document examples in describing the third embodiment are the input XML document 21 which is the same as the one exemplified by the above described FIG. 10, the conversion specification XML document 22 shown by FIG. 15 and the converted XML document 23 shown by FIG. 16.

The example of conversion specification XML document 22 shown by FIG. 15 in comparison with one for the second embodiment shown by FIG. 11, what is common with the latter is that a different name of a non-key element given by the additional information of the header in the converted XML document 23 is provided by the name attribute in each “item” element relating to the non-key element within the conversion specification XML document 22.

What is different from the second embodiment is that, in “merging_tag” elements within the conversion specification XML document 22, if a tag attribute, format=“unfixed”, is attached to the tag, then all the non-key elements included in the CSV element are defined as not appearing in fixed manners.

When performing the processing of the step S23 accordingly, attaches the attribute, format=“unfixed” as shown in FIG. 16, so that defines so as to regard all the non-key elements in the CSV element “contact” as unfixed forms.

FIG. 17 is a detailed process flow chart of “processing the elements in a record” in a structural conversion processing of the third embodiment. That is, the process flow of the overall structural conversion processing is approximately the same as the first embodiment in the third embodiment, as in the second embodiment, which is described in association with FIGS. 6 and 7, hence omitted here. And the processing contents of the steps S17 or S28 is different from either the first or second embodiments, therefore the detail will be described in reference to FIG. 17. Meanwhile, FIG. 16 shows a conversion result of attaching the additional information. The processing shown by FIG. 7, that is, for attaching the additional information, the processing content of the step S23 is the same as the second embodiment. That is, the processing outputs a different name defined by the name attribute into the header of the converted XML document 23 as the additional information.

In FIG. 17, the processing of the steps S111 through S117 are the same as that of the steps S71 through S77 shown by FIG. 13, hence omitting the description here. Also the steps S119 through S122, being the processing for the case of the judgment in the step S118 being “no”, are the same as the steps S37 through S40 shown by FIG. 8, hence omitting the description.

The following is a description of processing when the judgment in the step S118 is “yes”, in other words, a CSV element subjected to processing is a non-fixed CSV element, is when the attribute, format=“unfixed”, is attached in respective tag in “merging_tag” element as the above noted “contact”.

In this case, scans the non-key elements in “sequence of elements” within the conversion specification XML document 22 and searches the non-key elements corresponding to the above noted unfixed form CSV elements (i.e., “contact” in this case) (step S124).

Then, every time finds a corresponding non-key element (i.e., “yes” in step S125), judges whether or not the non-key element is written in the input XML document 21 (step S126), and if it is written (i.e., yes” in step S126), links the sequence of appearance of the non-key element (step S127) and obtains the element content thereof from the input XML document 21 to link it by the CSV format (step S128). The processing of these steps will be repeated.

Then, if finding no more corresponding non-key element (i.e., “no” in step S125), puts the process result of the step S127 as tags attribute values in the tags of the above described unfixed form CSV elements (step S129) and outputs the process result of the step S128 into the converted XML document 23 together with the tags of the unfixed form CSV elements containing the tags attribute.

In the example of unfixed form CSV element “contact” shown by FIGS. 15 and 16, in processing the record regarding Mr. A, finds non-key elements relating to the “contact”, in order of the scan: “employer_info/phone” (first in appearance), “employer_info/email [1]” second in appearance), “employer_info/email [2]” (third in appearance), “personal_information/phone” (fourth in appearance) and “personal_information/mobile phone” (fifth in appearance) in the step S125 shown by FIG. 15, whereas only “employer_info/email [2]” (third in appearance) has no record entry for Mr. A as shown in FIG. 10, and, as shown by FIG. 16, therefore writes in the converted XML document 23 as the tags of unfixed form CSV element having the tags attribute:
<contact tags=“1,2,4,5”></contact>
and as the element content:
123,abc@fj.jp,456,789

Also as described above, the element names corresponding to the element contents of the CSV elements (being given different names here: “employer phone, business email1, business email2, home phone and mobile phone”) are written in order of appearance as the additional information of the header.

This makes it possible to correlate the element contents being linked together in the CSV element as the new element with the corresponding element names. For instance, as the tags attribute value corresponding to the element content “456” is “4”, identifying the fourth element name “home phone” in the additional information.

Next up is a description of reconversion processing according to the third embodiment while referring to FIG. 18 which is a detailed flow chart of “processing the elements in a record” in a reconversion processing according to the third embodiment.

Of processing in the steps S141 through S149 shown by FIG. 18, the processing in the steps S141 through S144, and steps S147 and S148, are approximately the same as those in the steps S51 through S56 shown by FIG. 9, except that the processing in the steps S145, S146 and S149 are added. Description on the processing will be either omitted or summarized for the steps S141 through S144, S147 and S148.

First of all, the processing up to the step S144 has stored the element contents of the CSV elements subjected to processing in the array, contArray(i,j), followed by, if the CSV elements are unfixed form elements (i.e., “yes” in step S145), separating the attribute “tags” values and storing them in respective arrays, tagArray(i,j) (step S146).

In the example shown by FIGS. 15 and 16, the first found CSV element is “place” which is not an unfixed form CSV element, and therefore the judgment in the step S145 is “no”. Since i=1 in this case, therefore stores the element content of a CSV element subjected to processing in the array, contArray(1,j), and goes back to the processing in the step 142.

Meanwhile, the next CSV element “contact”, having been attached by the attribute, format=“unfixed”, is an unfixed form CSV element (i.e., “yes” in step S145). Therefore, i=2 in this case, stores the element contents of the CSV element being subjected to processing in the array contArray(2, 1) (step S144), further separates the attribute “tags” values and stores in the respective arrays, tagArray(2,j) (step S146).

The above described processing stores “A section” in array (1,1), “A City A Town” in array (1,2), “A City B Town” in array (1,3); “123” in array (2,1), “abc@fj.jp” in array (2,2), “456” in array (2,3), “789” in array (2,4), respectively, in the array, contArray, with regard to the record for Mr. A for example. Meanwhile, stores “1” in array (2,1), “2” in array (2,2), “4” in array (2,3) and “5” in array (2,4), respectively, in the array, tagArray.

Then, since n=2 in the step S147 for this example, sets initial value for k(i) and m(i) in the steps S148 and S149, respectively, resulting in setting k(1)=1, k(2)=1, m(1)=0 and m(2)=0.

Then, scans the “sequence of elements” in the conversion specification XML document 22 and executes the processing of the steps S152 through S160 for each “item” element, j=1, 2, 3, . . . and when processing for all “item” elements (i.e., “no” in step S151) completes the aforementioned processing.

First, judges whether or not an element subjected to the processing, that is, the element of the element name defined by the i-th “item” element in the “sequence of elements”, is in fact a key element (step S152). The judgment method is already described. If it is a key element (i.e., “yes” in step S152), executes the processing of the steps S153 and S154 which are approximately the same as the second embodiment, i.e., that of the steps S100 and S101 shown by FIG. 14, hence omitting the description here.

On the other hand, if an element of the element name defined the aforementioned “item” element is in fact a non-key element (i.e., “no” in step S152), then first obtains the order of appearance, i, of the CSV element name corresponding to the aforementioned non-key element in the conversion specification XML document 22 (step S155), followed by incrementing m (i) by +1 (step S156). Then, depending whether or not the aforementioned CSV element is an unfixed form CSV element, the process branches to the steps S158 or S159 (step S157).

In the example shown by FIG. 15, the first appearing non-key element is “employer_info/section” and the corresponding CSV element name is “place”, and the order of appearance thereof is “1”, hence:
m(1)=m(1)+1=0+1=1
and, further, since the CSV element “place” is not an unfixed form element, the process transfers to the processing of the step S158. That is, outputs the data stored in the arrays, contArray(i,k(i)), into the resultant XML document 25 together with the name of the aforementioned non-key element (step S158). In this example, since k(1) retains the initial value “1”, outputs “A section” stored in the array, contArray(1,k(1))=contArray(1,1), into the resultant XML document 25 together with the aforementioned non-key element name “section”.

And a value of the k(1) gets incremented by +1, becoming “2”.

On the other hand, if a non-key element “employer_info/phone” becomes a subject of processing, the corresponding CSV element is “contact” and the sequence of appearance thereof is “2” in the example shown by FIG. 15, hence:
m(2)=m(2)+1=0+1=1
and, further, since this CSV element “place” is a non-fixed element (i.e., “yes” in step S157), the process transfers to the step S159.

The processing in the step S159 is to use an order of elements stored in the arrays, tagArray, and restrain an element without the order being defined from outputting. In the above noted “employer_info/phone” for instance, since m(2)=1 and “1” being stored in the array, tagArray (2,1), the judgment in the step S159 becomes “yes” and accordingly outputs “123” stored in the array, contArray (2,1), into the resultant XML document 25 together with the non-key element name “employer_info/phone”. And increments k(2) by +1. As for the next non-key element “employer_info/email [0]” in FIG. 15, m(2)=2 likewise in the step S156, storing “2” in the array, tagArray (2,2), and thus the judgment in the step 159 becomes “yes”.

Meanwhile, in the case of the next non-key element “employer_info/email [1]”, while m(2)=3 in the step S156, the judgment in the step S159 becomes “no”, since “4” is stored in the tagArray (2,3). Since a data for “employer_info/email [1]” has not been written to begin with, the above described processing makes it possible not to output the element. Also in this case, the processing in the step S160 is not done, and hence k(2) will not be incremented by +1. Therefore, in the processing for the second next element in the “sequence of elements”, i.e., “personal_information/phone”, a comparison with the array, tagArray (2,3)=“4” in the step S159. Since m(2)=4 in this case, the judgment in the step S159 becomes “yes”.

The above described two methods dealing with an unfixed form XML document, that is, the second and third embodiment, in comparison with the method of the prior patent application, have characteristics as follows.

First of all, in the prior patent application a compressed character string had to be defined one after another for each record as the attribute in the tag even when using a compressed character string, making not only a redundancy but also mandating to refer to a file, et cetera, correlating between the character string and an element name.

Contrary to the above, the second embodiment writes the element names of all elements possibly appearing as additional information in the header and leaves the elements not appearing in the record empty elements, thereby enabling definition of the relationship between the element names and the element contents.

Meanwhile, the third embodiment, while using the above described additional information, necessitates description of attributes in tags for each record. The attribute, however, describes a sequence of appearance as is, enabling a computer to describe an attribute value, whereas in the prior patent application, a separate file had to be defined for such relationship, costing time and money.

Additionally in the prior patent application, tag names of non-key elements being described in the converted XML document was cut out and the non-key elements were restored according to the tag names and the element content at the time of reconversion even if the application software does not use the converted XML document. The second and third embodiments, on the other hand, can execute a reconversion even if tag names of the non-key elements are not described in the converted XML document.

Meanwhile, the following summarizes pluses and minuses in comparison between the second and third embodiments.

The method of the second embodiment can also be regarded as an extension of that of the first embodiment. The second embodiment links together by the CSV format, and separates, all possible selective appearance elements (i.e., elements possibly appearing), benefiting the case where the possible selective appearance elements each appears frequently.

Contrarily the method according to the third embodiment correlates element contents with element names by using attribute values, benefiting the case where there are many elements seldom appearing among the possible selective appearance elements, while its method being cumbersome.

While the above described processing performs a direct structural conversion or reconversion based on the conversion specification XML document 22, there may be a configuration as noted earlier which creates a conversion XSL sheet 15 and a reconversion XSL sheet 16 based on the conversion specification XML document 22, and thereby performs a structural conversion or reconversion processing. Although in such cases processing contents remain substantially the same as the described above, here, FIG. 19(a) through (d) will show an example of summary processing procedure by using a conversion and reconversion XSL sheets.

While showing only the first embodiment here, the second and third embodiments are the same.

First off, in FIG. 19(a), an XSL conversion unit 13 reads the conversion specification XML document 22 in, analyzes a conversion spec. from the description thereof (step S171), and creates the conversion XSL sheet 15, which is a style sheet for converting the data structure when converting from an XML document to another XML document, by using the analysis result and a conversion XSL sheet generation XSL sheet 14 (step S172) Also, similarly, the XSL conversion unit 13 reads the conversion specification XML document 22 in, analyzes the conversion spec. from the description thereof (step S181) and creates the reconversion XSL sheet 16, which is a style sheet for a reconversion processing for reconverting from either the converted XML document 23 or the extracted XML document 24 back to the document format of the original XML document 21, by using the analysis result and the conversion XSL sheet generation XSL sheet 14 as shown by FIG. 19(b) (step S182).

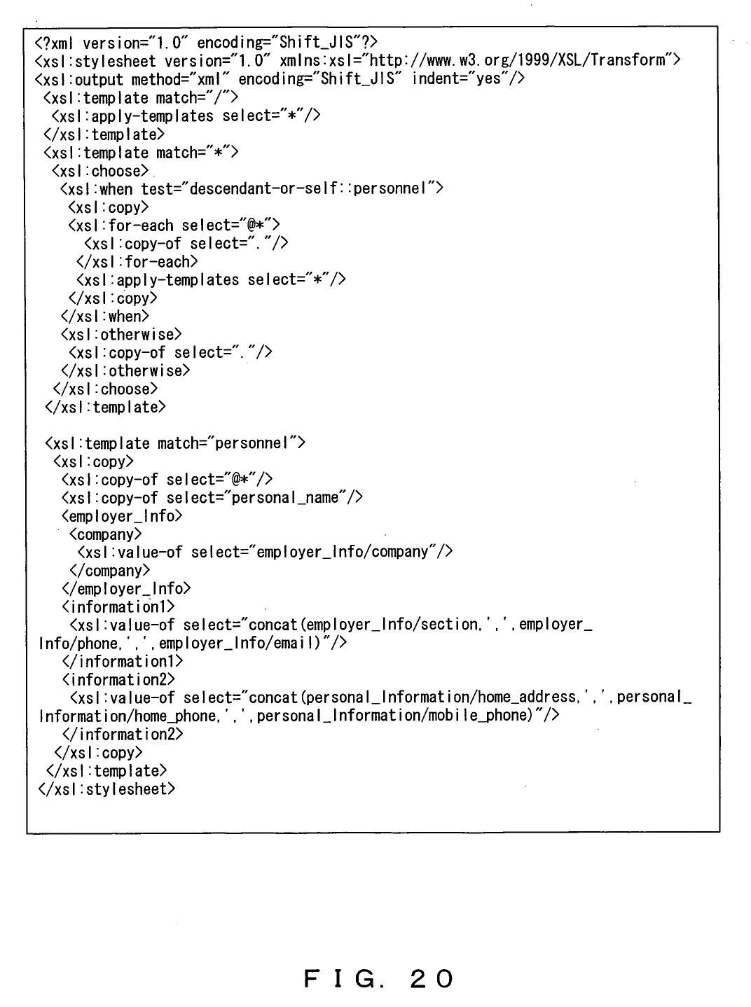

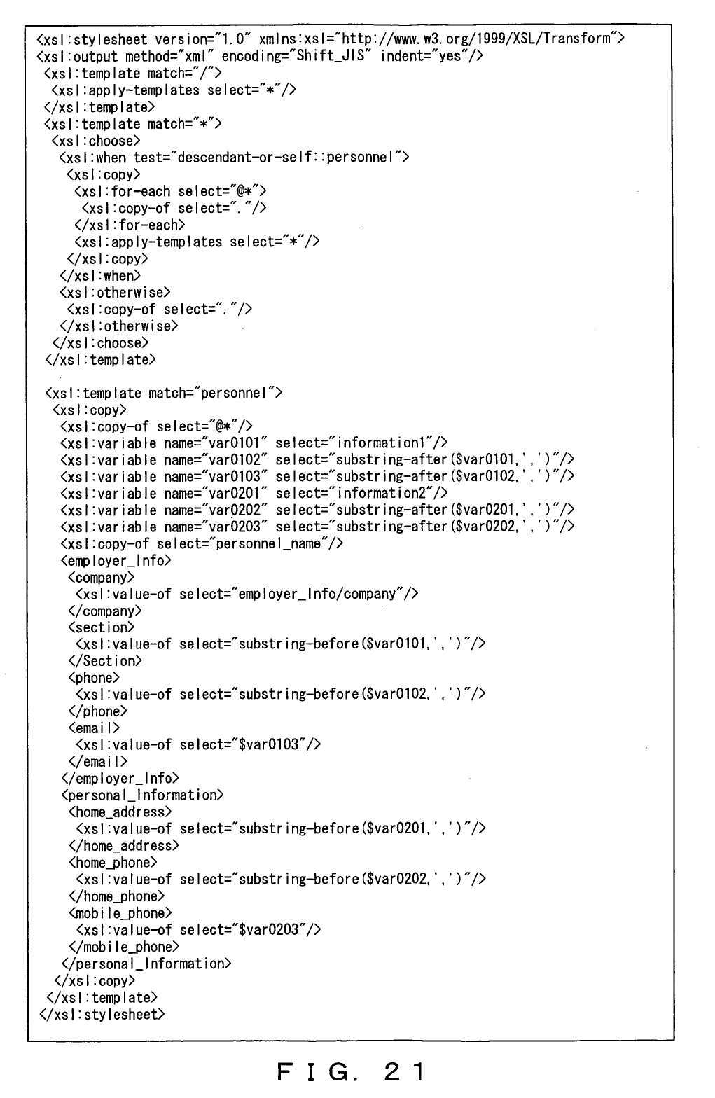

FIGS. 20 and 21 respectively show examples of conversion XSL sheet 15 and reconversion XSL sheet 16 when reading in the conversion specification XML document 22 shown by FIG. 4.

And the conversion processing as shown by FIG. 19 (c), points at the file names of an input XML document 21 subjected to processing and the corresponding conversion XSL sheet 15 (step S191) and executes actually the corresponding processing of the steps S13 through S18 shown by FIG. 6 (except that the processing of step S17 is as per FIG. 8) by using the aforementioned conversion XSL sheet 15 (step S192).

Likewise, a reconversion processing as shown by FIG. 19(d) points at the file names of a converted XML document 23 (or an extracted XML document 24) and the corresponding reconversion XSL sheet 16 (step S201) and executes actually the corresponding processing of the steps S13 through S18 shown by FIG. 6 (except that the processing of step S17 is as per FIG. 9) by using the aforementioned reconversion XSL sheet 16 (step S202).

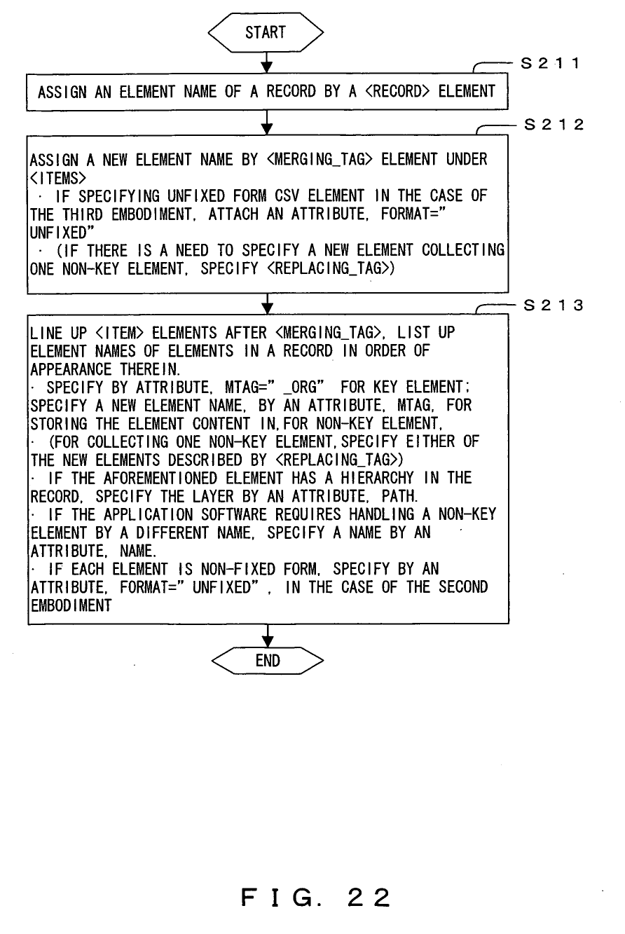

Next follows a description of a procedure for making a conversion specification XML document 22 with reference to FIG. 22 which assigns an element name of a record by a <record> element to begin with (step S211).

Next, assigns a new element name (i.e., a CSV element name) by <merging_tag> element under <items> (step S212). In this process, if specifying the above described unfixed form CSV element in the case of the third embodiment, attaches an attribute, format=“unfixed” to <merging_tag> tag. Or, if there is a need to specify a new element collecting one non-key element by “rtag”, writes <replacing_tag>.

Next, lists up each “item” element in order of appearance of the elements in a record (step S213). In this process, depending on the element defined by “item” element:
for key element, specify by an attribute, mtag=“_ORG”
for non-key element, specify a CSV element name, by an attribute, mtag, for supposedly storing the element content in.
for assigning a new element collecting one non-key element, specify either of the new elements described by <replacing_tag> with an attribute, rtag.
if the aforementioned element has a hierarchy in the record, specify the layer by an attribute, path.
if the application software 30 requires handling a non-key element by a different name, specify the different name by an attribute, name.
if there is a need to specify that the element content of the element does not appear in a fixed manner in the second embodiment, attach an attribute, format=“unfixed”

Note that the phrase “in a (or, the) record” is defined as “in the input XML document 21”.

The converted XML document 23 made by the above described conversion spec. make the one easily handled by the application software 30.

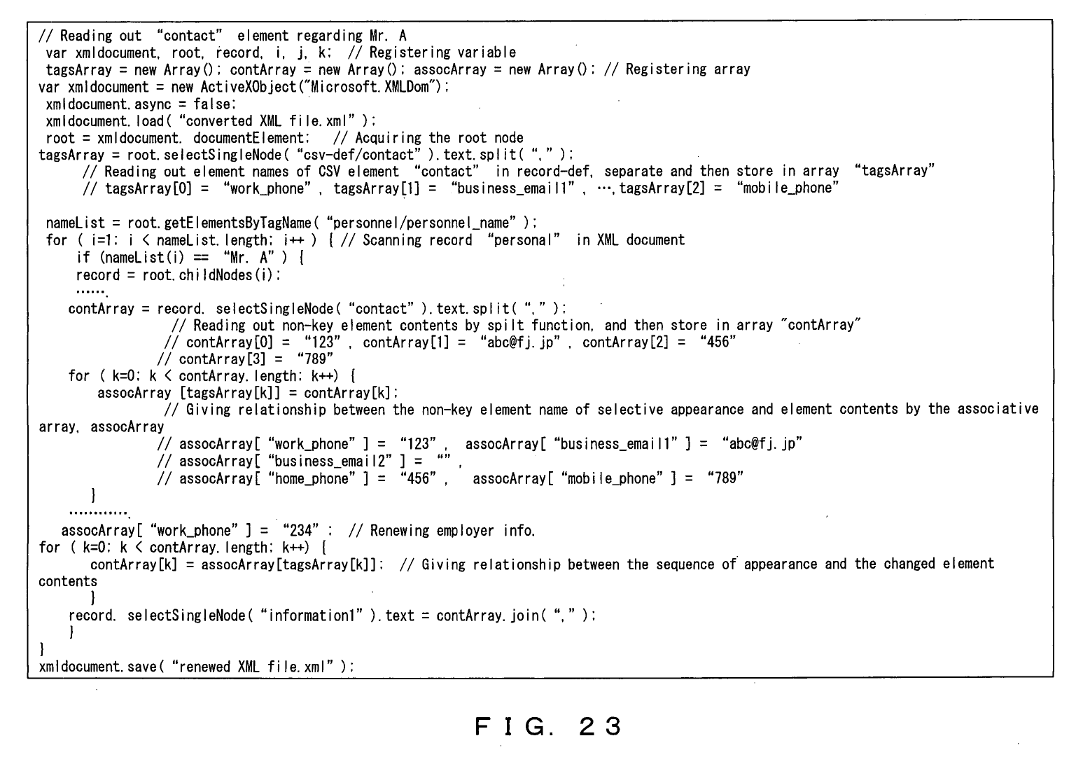

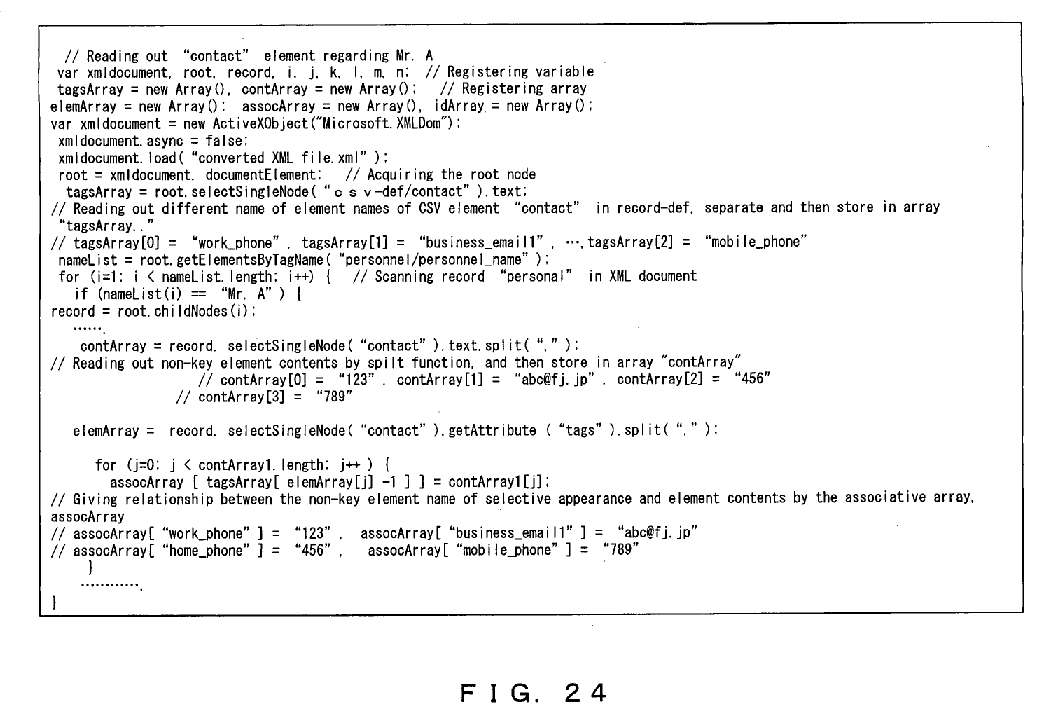

Each of the FIGS. 23 and 24 shows an example of J Script program of the application software 30.

The processing of FIGS. 23 and 24, while being a common and simple content, and having no particular importance by itself, a summary of the processing by the program shown therein will be given as follows.

The programs shown by FIGS. 23 and 24 are both for reading out the new CSV element “contact” of “Mr.A”, with FIG. 23 making the converted XML document shown by FIG. 10 the processing subject, while FIG. 24 making the converted XML document shown by FIG. 16 the processing subject, and therefore the program descriptions are different from each other. The purposes of the processing, however, are almost the same, hence the program shown by FIG. 24 is now summarized in the following.

Step 1: Read the additional information of the header, separate the element names linked together by the CSV element and store them in element name arrays.

Step 2: Read a CSV element “contact” linking together non-key elements regarding Mr. A, separate element names linked together in the CSV element and store in element content arrays.

Step 3: Read element contents in a CSV element “contact”, separate them and store in arrays.

Step 4: Read order of corresponding element names as attributes of the CSV element “contact”, separate them and store them in arrays.

Step 5: Readout element name array by the sequence read out of the element name order array of the CSV element “contact”, and store element contents of the corresponding CSV element “contact” in the associative array, assocArray “contact” with the aforementioned element name order being the argument.

Meanwhile, FIG. 23 adds a processing for changing the element content of an associative array, assocArray “work phone” from “123” to “234”.

Characteristics of these embodiments are, since the converted document has become more self-describable by the additional information and element content allow access to the element names, the programs shown by FIGS. 23 and 24 can be used as is, even if the number of record items in the original document increases and accordingly the number of non-key elements linked together by the CSV elements. As such, the flexibility brought forth by self-describability nature of XML documents will be inherited.

As described above, the present invention basically has the following characteristics, in addition to the characteristic and effect of the above noted prior patent application.

(A) Usability of Handling a Non-Key Element as a Processing Object by Application Software

The prior patent application has not assumed that there is a possibility of the application software making a non-key element a processing subject as described above.

The present invention places a plurality of CSV elements on the same hierarchical layer (e.g., the first layer in a record), allocates each non-key element to the plurality of CSV elements in the manner that is free of restrictions and is independent of hierarchical structure of the original XML document. For instance, non-key elements classified according to the usage can be stored in the respective CSV elements prepared for each usage. This makes it possible for the application software to handle easily even when a situation arises unexpectedly requiring a data processing by using non-key elements, and furthermore, in the case that the number of non-key element is very many, the number of CSV elements can be increased to reduce the number thereof storing in one CSV element, thus reducing overhead as a result of developing the necessary CSV elements only.

(B) Retaining the Sequence of Elements in a Record According to the Conversion Spec.

The conversion spec defines the sequence of elements in a record in order to keep the sequence of elements in a record after conversion and reconversion. This will make it possible to output a document with the sequence of elements in the right sequence at the time of reconversion even if the sequence is lost in conversion, thus restoring not only the content but also the sequence thereof.

(C) Self-Describability of Converted Document

Generally speaking, an XML document has a characteristic of being self-describable.

In the prior patent application, in dealing with an unfixed form document, the relationship between the element names (or the character string) and the element contents for each CSV element one after another, for each record, was written in a post-conversion XML document. By this practice, the element name and the element contents were cut out of at the time of reconversion processing and the original non-key elements were restored accordingly. Also, the relationship between the element names and the element contents was comprehended when executing the processing by the application software. Writing the element names made it lengthy, however, and writing a compressed character string instead in an attempt to avoid the lengthiness necessitated a separate reference to the relationship between the element names and the compressed character string.

The present invention provides the additional information in the converted XML document describing the element names of all the elements possibly being stored in a respective CSV element, in other words, the element names of all the elements possibly appearing in the record relative to the CSV element, in sequence of appearance for each CSV element as a common definition for all the records.

And the contrivance is so as to indicate which record and which element therein has not been entered with a relevant data for each record when storing the element content of the element corresponding to the CSV element sequentially for each CSV element. For instance, if any of the elements is not entered with data, links the element together with the other elements by the CSV format as an empty element; or for instance, describes the elements actually being stored in a CSV element, that is, the actual sequence of appearance, in the record, of such element contained in the aforementioned CSV element, in the form of linking together by the CSV format as an attribute of the tag for the CSV element.

As described above, the additional information describes the element names of all the elements of possible appearance in sequence thereof, thereby comprehending the relationship between each of the element content and the respective element name. Also comprehending is the fact that the element by the element name corresponding to the empty element, or the element by the element name corresponding to a sequence of appearance being not written in an attribute, has no data entry for the record in the pre-conversion XML document.

This practice enables the application software to perform a data processing by using the converted XML document in the same way as dealing with the original XML document by referring to the additional information. Meanwhile the use of the above described empty element eliminates a need to attach a tag attribute of CSV elements. Besides, the present embodiment imposes no need to refer to the additional information at the time of reconversion. Therefore, the application software does not require the additional information when a processing thereby does not deal with the non-key elements.

Data in an EDI contains the number of items anywhere from hundreds to a thousand in one record, and the vast number of the items makes it unsuitable to a DOM deployment. An actual use of the standard API (i.e., SAX: Simple API for XML) just for cutting document element out and transmitting in time series makes difficult for a complex document handling. But a single piece of application software has no capability to access all of those hundreds of elements. The present invention makes it possible to develop only the group (i.e., new element) containing the element for use in the processing corresponding to a convenience of the application software, hence preventing an overhead from becoming large and being practical. Also providing a perfect reversible conversion in that the sequence of elements is perfect to an examining eye.

Additionally, linking together elements in frequent use for the respective record into a CSV element by a group containing a small number of non-key elements for an XML document with deep hierarchical layers makes it possible to read the elements on a single layer by a separation of the CSV elements, giving a benefit of quick reading. While this practice causes to lose a transparency of the original XML application software, it makes similar to a usage by the application software using as a CSV file.

The present invention, however, is not limited by such descriptions of present embodiments.

For instance, commas are used as punctuation marks for linking element names and element contents of non-key elements together by the CSV format in the above examples. This is because originally the CSV is a method for linking numbers and character strings by way of commas, limiting to using comma as the punctuation mark for a general use.

The present invention, however, does not restrain a use of other signs as punctuation marks. If an element content is a number for price in which a comma is used for punctuating a unit of thousand, then “@” (at-mark) or “_” (under-bar) is used instead. Or it may be use a two-character string that will seldom appear as punctuation marks. The punctuation marks inserted between the character strings may be replaced by characters which are recognizable as being in reference to a substance. A “&CMM” replaces comma for example. Therefore, those punctuations shall desirably be either characters or character string that will hardly appear in usual character strings.

In the present invention as described above, the method of linking together numbers and/or character strings by way of punctuation marks (not limited comma) and/or a string of signs is called as the CSV format for convenience.

The present invention is also a method for grouping a plurality of non-key elements into a series of new elements so as to enable the application software to handle them together during the relevant data processing.

For this reason, allows a choice between placing the element names of non-key elements in the element names of a new element by linking together by the CSV format, and placing in the attribute. Also allows a choice between placing the element contents of non-key elements in the attribute of a new element by linking together by the CSV format, and placing in the element contents. While these choices depend on the volume of data or an estimate of number of new elements possibly increasing during the data processing, any choices as to where to place them in the attributes or element contents of the new element are possible because the nature of the present invention is for handling a plurality of non-key elements by grouping into a few thereof.

Note that (a) a conversion specification or a reconversion software, and (b) information on elements linked together by the CSV element, are defined in the conversion documents according to the present invention. Since these pieces of information are not contained in the original document, these may be provided by linking with an external file. Also the information may be identified by a specific namespace for indicating as the separate information when placing in the converted document.

Next up is a description of the fourth embodiment according to the present invention.

As described above, the second and third embodiments, in dealing with unfixed form XML documents, store element contents by defining a plurality of CSV elements for each use so as to enable the application software to handle the elements linked together by the CSV element. The element names, just indicating the relationship with the additional information of the header, do not enter the respective record, making it possible to decrease the number of nodes at the time of developing the XML document, and to give benefit of reducing a memory volume usage and the deployment time. Also defining a sequence of elements in the conversion specification XML document for reconversion gives a benefit of complete reconversion in which the sequence of elements in the converted XML document is restored.

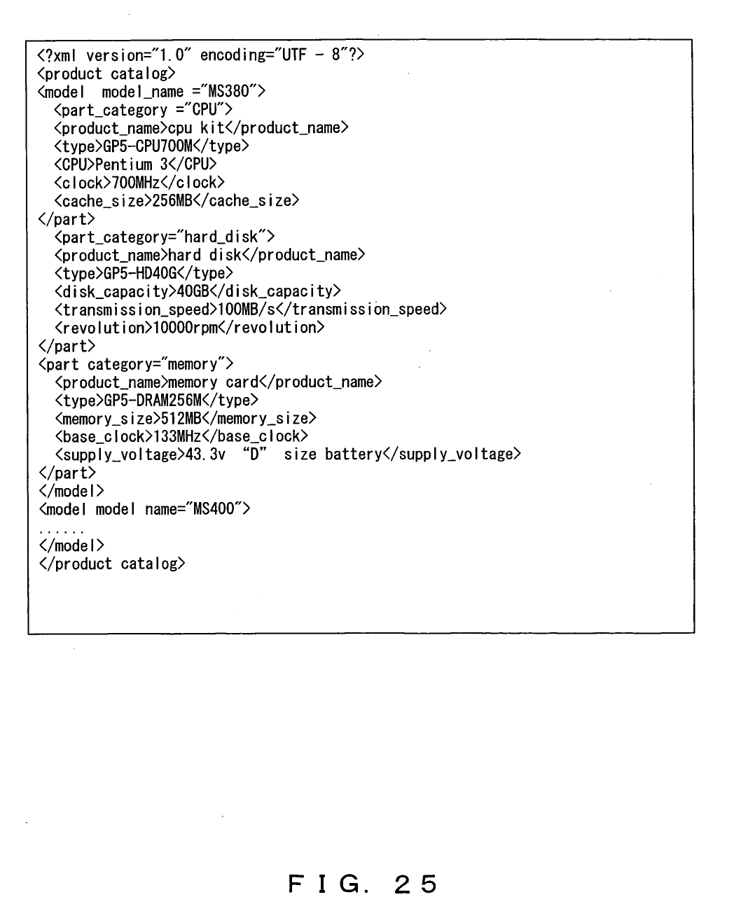

Incidentally, among the unfixed form XML documents, there is a type in which unfixed form elements occupy a large part of record (i.e., a type being difficult for a table form) such as an XML document for a product list having record items variable with a category of the record (i.e., part) as exemplified by FIG. 25, in addition to the type in which some unfixed form elements appear in a part of the record as shown by FIG. 10 above.

The unfixed form XML document shown by FIG. 25 is an example of product catalog, in which <part> shows one record and its attribute “category” defines a category of the record (i.e., part). The example has three categories, “CPU”, “hard disk” and “memory”. And the tag names of a record item (i.e., element) relating to the part category=“CPU” are product name, type, CPU, clock and cache size. The tag names of a record item relating to the part category=“hard disk” are product name, type, disk capacity, transmission speed and revolution. The tag names of a record item relating to the part category=“memory” are product name, type, memory size, base clock and supply voltage.

The unfixed form XML document exemplified by FIG. 25 has different record items in great deal depending on the record (i.e., part) category. In other words, the unfixed form elements largely occupy.

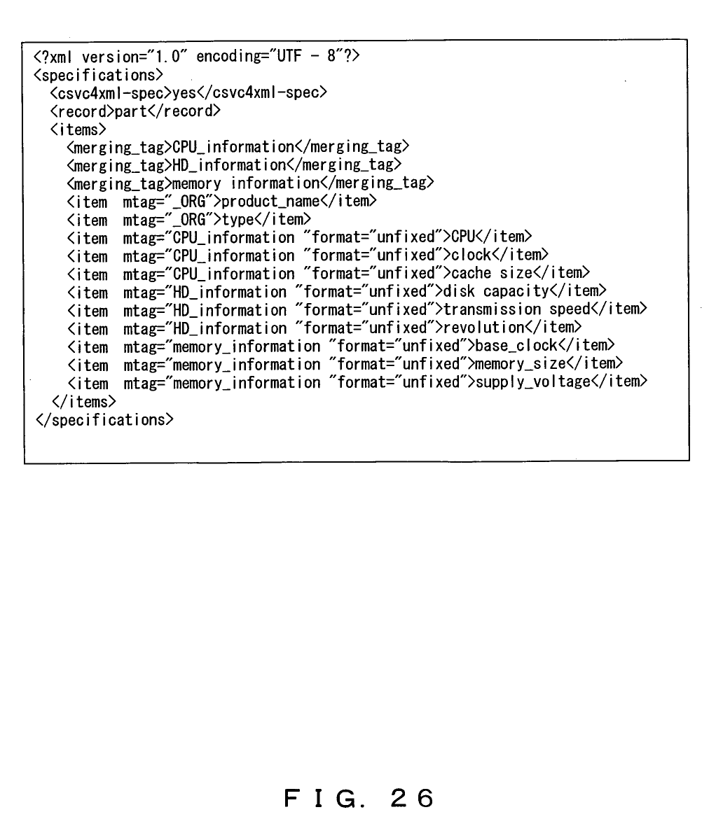

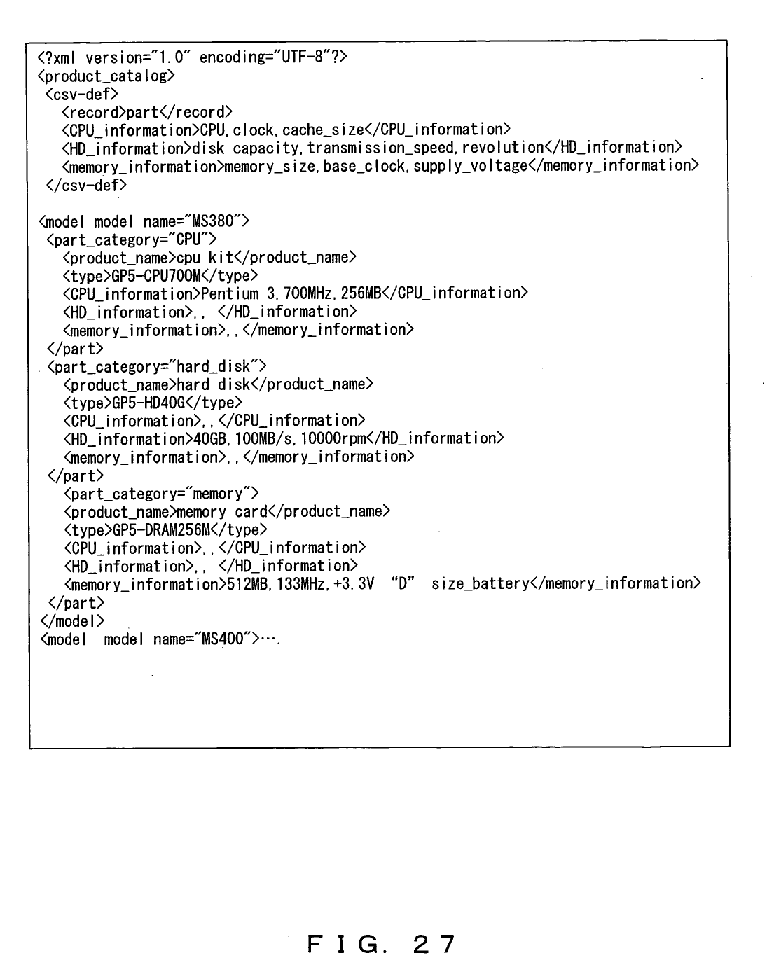

FIG. 26 is a conversion specification XML document 22 when applying the second embodiment to the unfixed form XML document shown by FIG. 25; FIG. 27 shows a converted XML document 23 as a result of converting the unfixed form XML document shown by FIG. 25 by using the conversion specification XML document 22 shown by FIG. 26.

In the conversion specification XML document 22 exemplified by FIG. 26, the element common to all the record (i.e., part) categories “CPU”, “hard disk” and “memory”, i.e., “product name” and “type” classified as key element and all other elements as non-key elements with all those being attached by an attribute, format=“unfixed”, defining that all the non-key elements are unfixed form elements. Meanwhile, the element content of “merging_tag” for describing the CSV element name (i.e., tag name for the CSV element) are “CPU Information”, “HD information” and “memory information”, respectively.

Meanwhile, an attribute, “mtag”, specifies the above described CSV element name corresponding to the record (i.e., part) category which the non-key element has a relationship with. That is, for instance, the attribute, “mtag”, specifies “HD information” for a non-key element “disk capacity”.

The above described conversion specification XML document 22 shown by FIG. 26 ends up containing all elements possibly appearing. This makes processing load large for a conversion and/or reconversion (i.e., the processing as shown by FIG. 13). That is, taking example of processing for the record, category=“hard disk”, the processing is done for all non-key elements although the non-key elements for this record are only disk capacity, transmission speed and revolution, making the processing load large. Also as a result, non-key elements relating to other categories, that is, CPU information and memory information are all outputted as empty elements (e.g., <CPU information>, , </CPU information>) into the converted XML document 23, increasing an amount of useless information, as shown by FIG. 27. That is, CSV elements containing only empty elements are created, negating an effective reduction of elements.

Meanwhile, in a reconversion processing (i.e., processing shown by FIG. 14), regarding the non-key element, the processing is such that the elements only containing the element contents are outputted from among all possible element of appearance while restraining from outputting the empty elements, requiring an examination as to whether or not all possible element contents are present and thus increasing the processing load.

Although the above example has three record categories, the processing load will increase with the number of such categories.

The fourth embodiment hereby proposes two methods for the unfixed form XML documents of such type as described in the following.

First of all, the fourth embodiment (part 1) will be described.

The fourth embodiment (part 1) is to eliminate a useless description in a converted XML document, that is, not to include a CSV element containing only the empty elements.

The fourth embodiment (part 2) is further to lighten a processing load at conversion and/or reconversion.

First, the fourth embodiment (part 1) will be described.

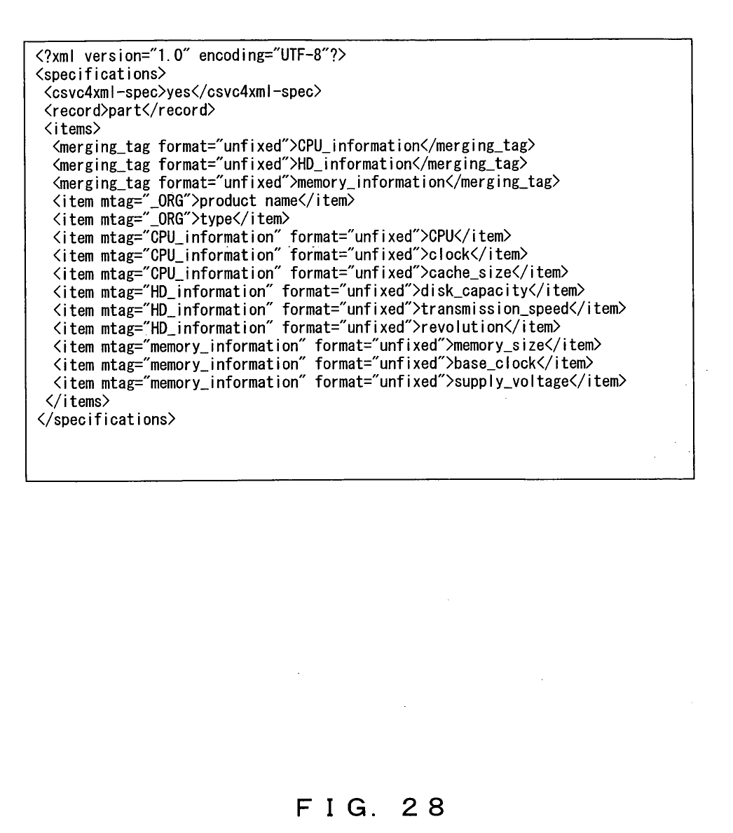

The embodiment uses the conversion specification XML document shown by FIG. 28 which is different from FIG. 26 where attaching the attribute, format=“unfixed”, in “merging_tag” elements in the former.

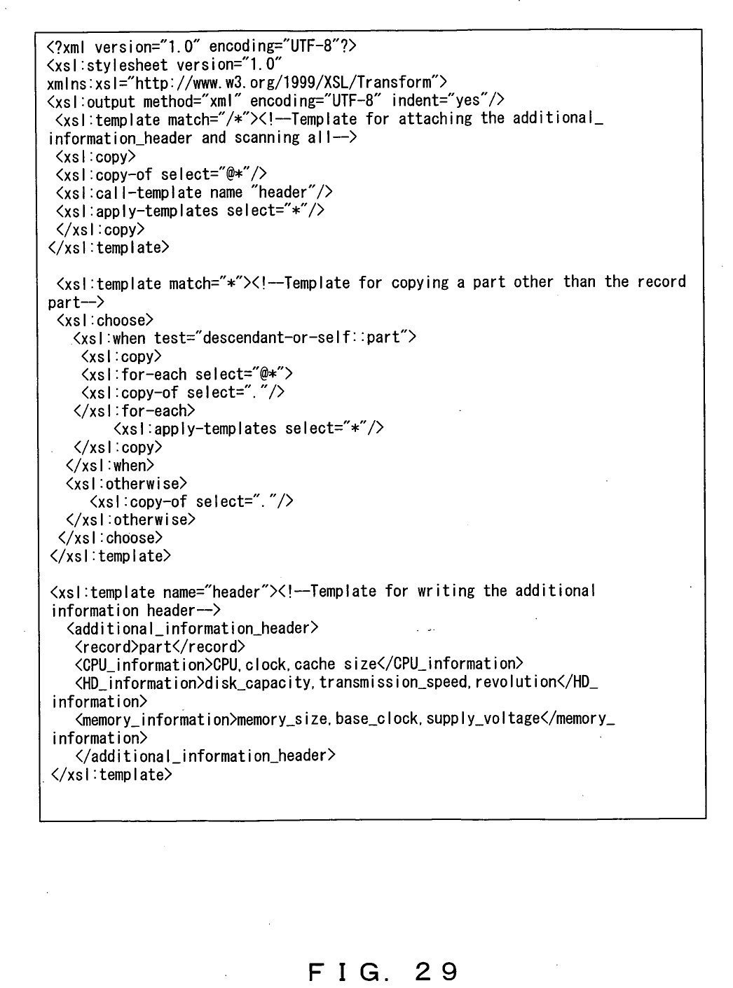

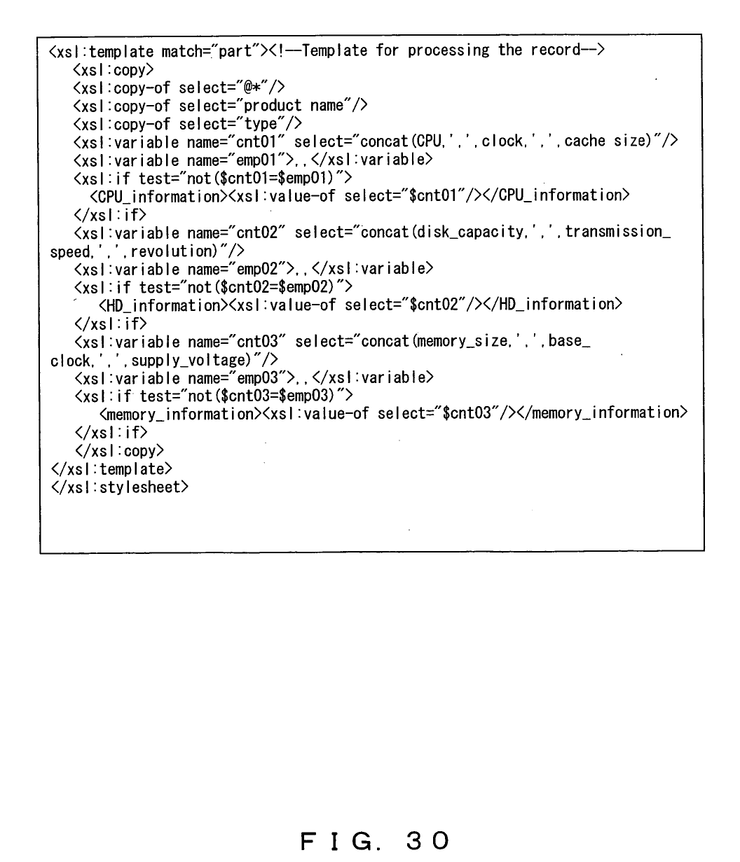

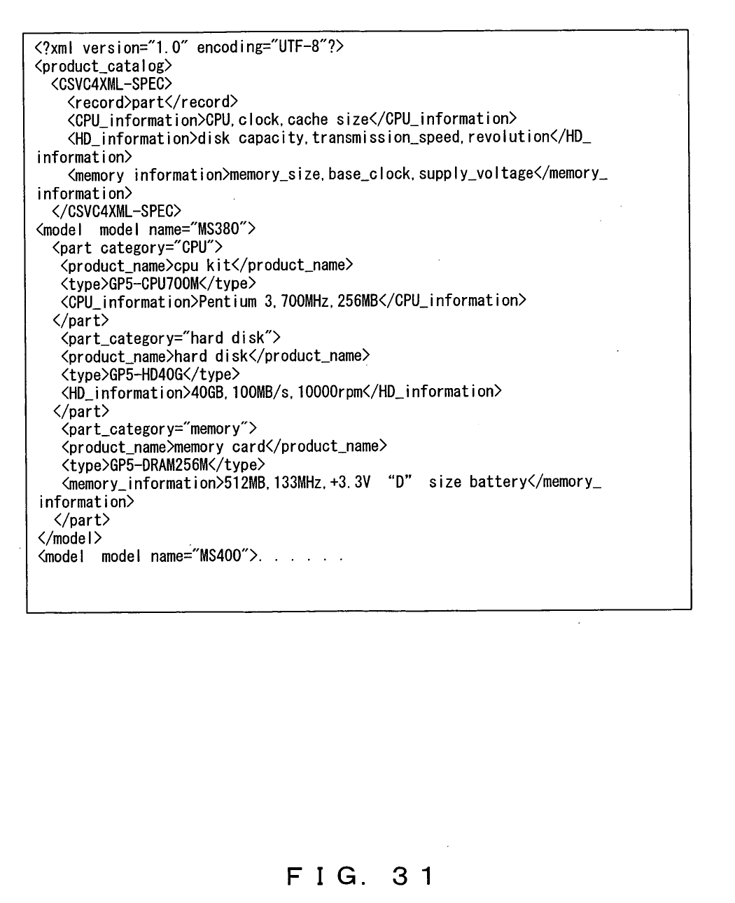

FIGS. 29 and 30 are examples of conversion XSL sheet 15 being created by the XSL conversion unit 13 by using the conversion specification XML document shown by FIG. 28. FIG. 31 is an example of converted XML document 23 according to the present embodiment.

FIGS. 29 and 30 show the conversion XSL sheet in two parts, with FIG. 29 showing the first half of the conversion XSL sheet and FIG. 30 showing the second half thereof.

The conversion processing by using the conversion specification XML document shown by FIG. 28 is approximately the same as the example for the second embodiment, except in the step S81 shown in FIG. 13. That is, the “merging_tag” element is attached by the attribute format=“unfixed” in the conversion specification XML document shown by FIG. 28. As described already, if the attribute, format=“unfixed”, is attached to the tag of “item” element relating to a key element and nothing is written for the aforementioned key element in the input XML document 21, then the processing is neither to copy nor output the key element in the processing of the step S73. Likewise in this embodiment, the processing is such that, if the attribute, format=“unfixed”, is attached to a “merging_tag” element and a result of the processing in the step S80 (i.e., linking element contents together by the CSV format) contains only empty elements, then stops the processing the step S81. That is, although the processing of the steps S78 through S80 are done, but an output to the converted XML document will not be done.

The following “if test” sentence in the conversion XSL sheet shown by FIG. 30 corresponds to this practice, for instance:
<xsl:if test=“not($cnt01=$emp01)”

The practice eliminates a useless description, that is, a CSV element containing only empty element from the converted XML document as shown by FIG. 31.

This method, however, performs a processing to check whether or not the element contents are all empty after linking the element contents together by the CSV format, even if outputting of the result into the converted XML document is stopped, being unable to eliminate a useless processing altogether. In other words, the problem of the above described increase of processing load is not solved entirely.

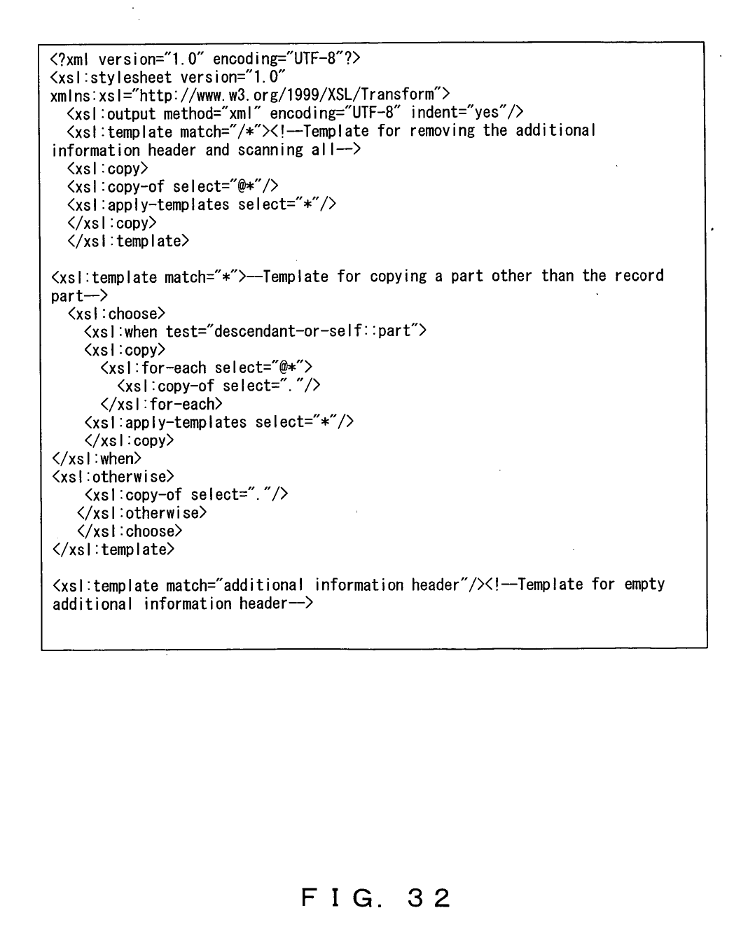

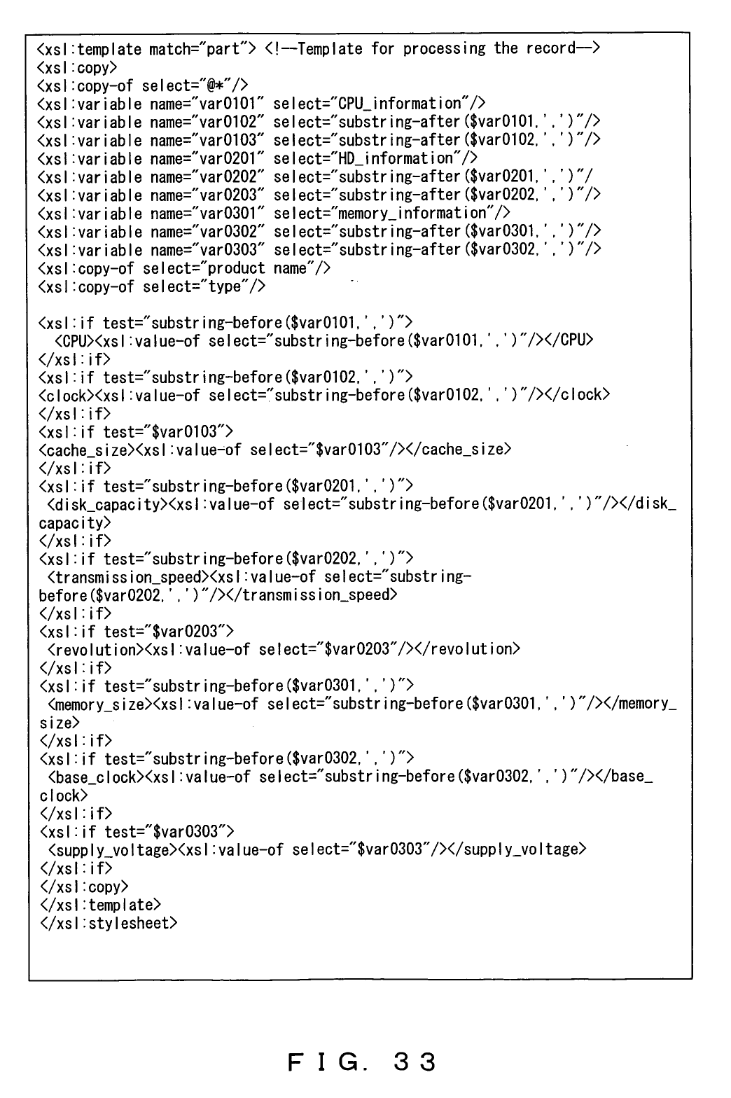

The same goes with a reconversion. FIGS. 32 and 33 exemplify a reconversion XSL sheet, together of which share one XSL sheet, with FIG. 32 showing the first half of the reconversion XSL sheet and FIG. 33 showing the second half thereof.

FIG. 32 is the processing of a part other than the record part, hence omitting the description.

In a reconversion, substitutes the non-key elements contents linked together by CSV format for each CSV element for variables “var0101” through “var0303” by <variables> as shown by FIG. 33, where “null” substitutes where no element content exists (i.e., empty element).

For example, if the document shown by FIG. 27 is subjected to a reconversion and processing for the first record (i.e., category=“CPU”), “Pentium 3, 700 MHz, 256 MB” substitutes for “var0101”, “700 MHz, 256 MB” for “var0102” and “256 MB” for “var0103”, while “null”substitutes for “var0201” through “var0303”.

Then, the “if test” sentence judges either to output or not output data for each non-key element.

First, for <CPU> in the above example, by:
if test=“substring-before($var0101,′,′)”
there is Pentium 3 in front of the first comma in “Pentium 3, 700 MHz, 256 MB” substituting for “var0101”, that is, not null (i.e., empty element), and therefore outputs Pentium 3.

Likewise for <clock>, outputs 700 MHz in front of the first comma in “700 MHz, 256 MB” substituted for “var0102”.

For <cache size>, outputs “256 MB” substituted for “var0103”.

On the other hand, for <disk capacity> through <supply voltage>, null substitutes for “var0202” through “var0303”, and therefore does not output.

Note that “if test” and “substring-before” are well known in the XSLT and the summary descriptions are provided later.

The above described processing also necessitates useless checking for records in addition to the relevant records, hence negating a high speed processing.

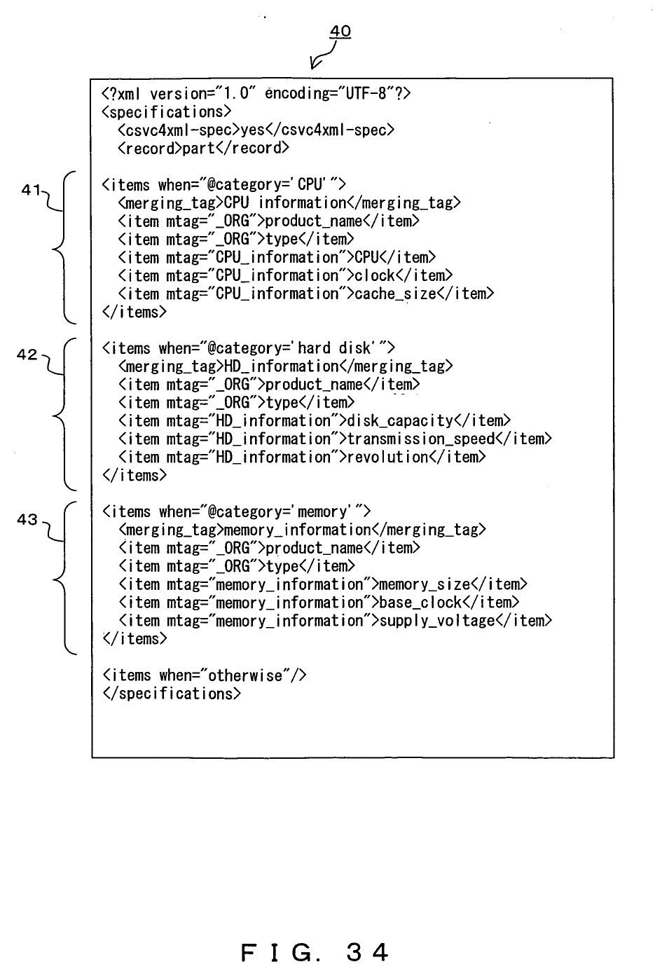

Contrary to the above, the fourth embodiment (part 2) lines up record items (i.e., elements), which are variable with the record, separately by respective records as shown by a conversion specification XML document in FIG. 34 for example, and switches the sequence of elements by a predefined condition at conversion or reconversion, thereby eliminating a useless checking of non-key elements for their presence or absence.

That is, the present embodiment specifies elements appearing by record category separately in the conversion specification XML document 40 shown by FIG. 34, and switches the list, <items>, of the record items for each record by a condition, i.e., the “when” attribute. The attribute value of attribute, “when” is used for switching condition written in a conversion and/or reconversion XSL sheets. For this reason, the attribute value is written according to a conditional equation of XSL sheet. In other words, the switching condition is written in the conversion specification XML document 40 according to the notation of the program language for the conversion and/or reconversion XSL sheets.

Contrarily, since the attribute value, as is, is reflected on the conversion and/or reconversion XSL sheets, a complex designation of condition, by AND, or OR, combination between a plurality of element contents and attribute values, becomes possible.

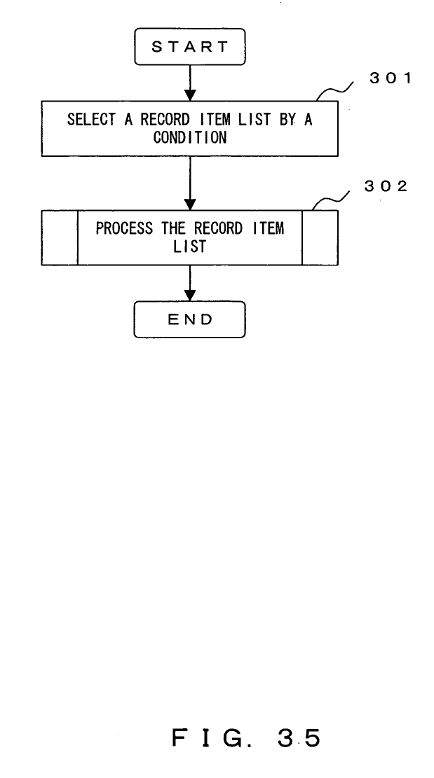

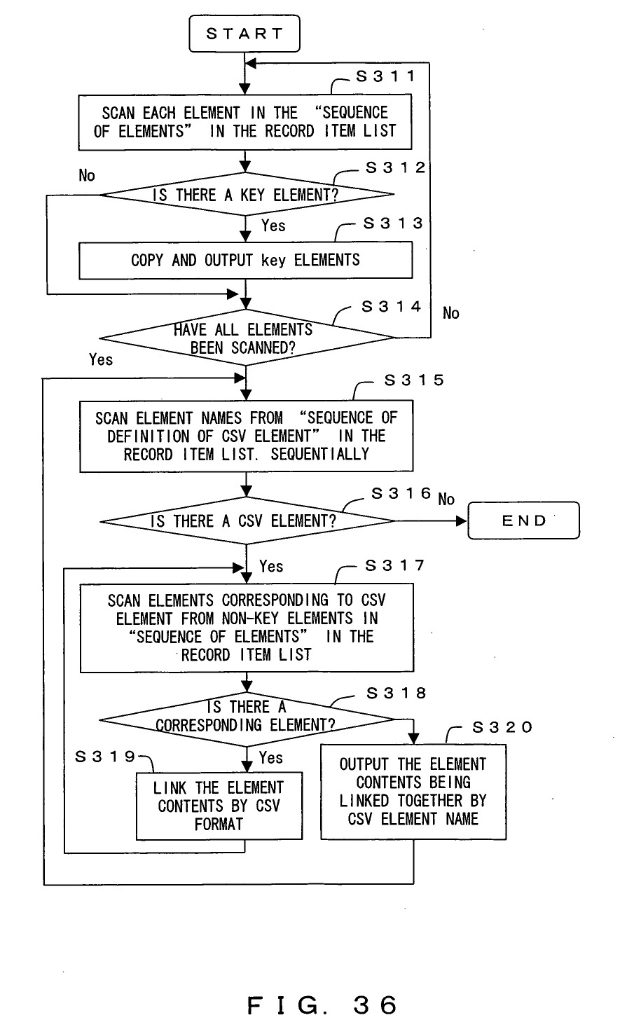

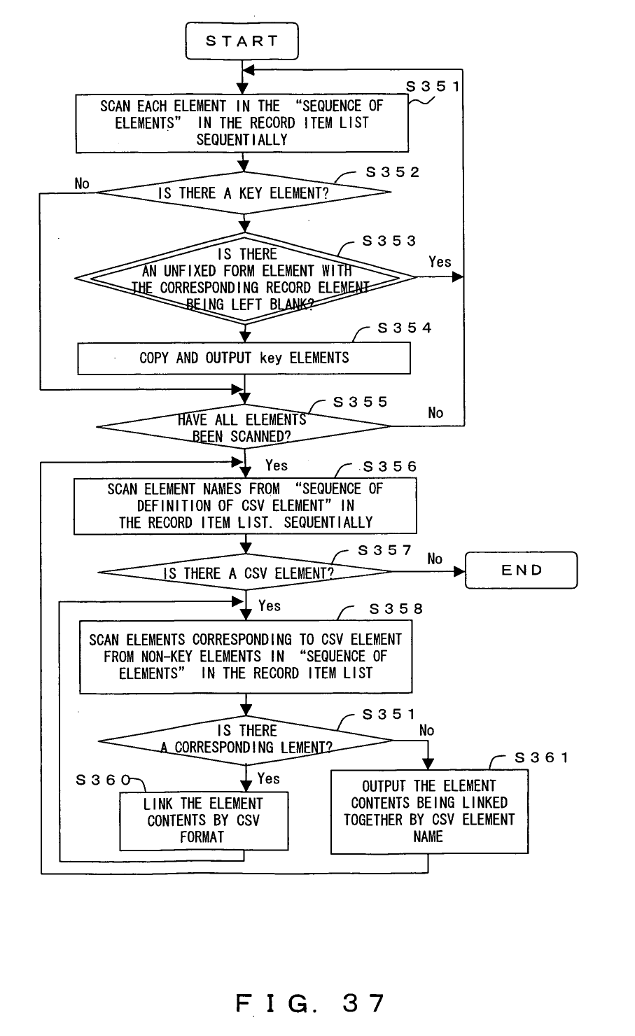

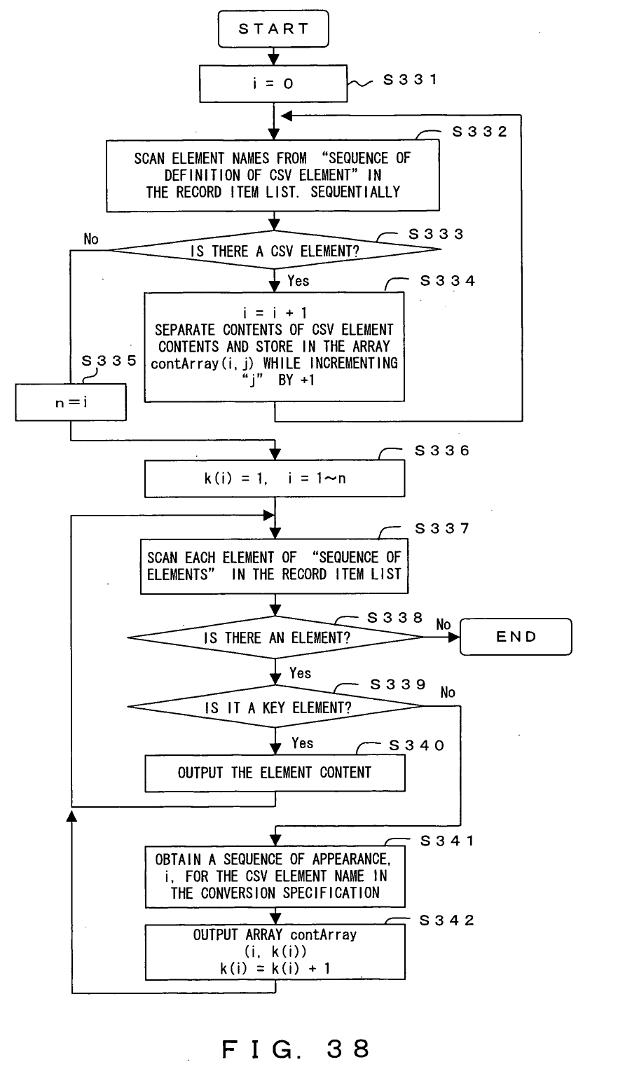

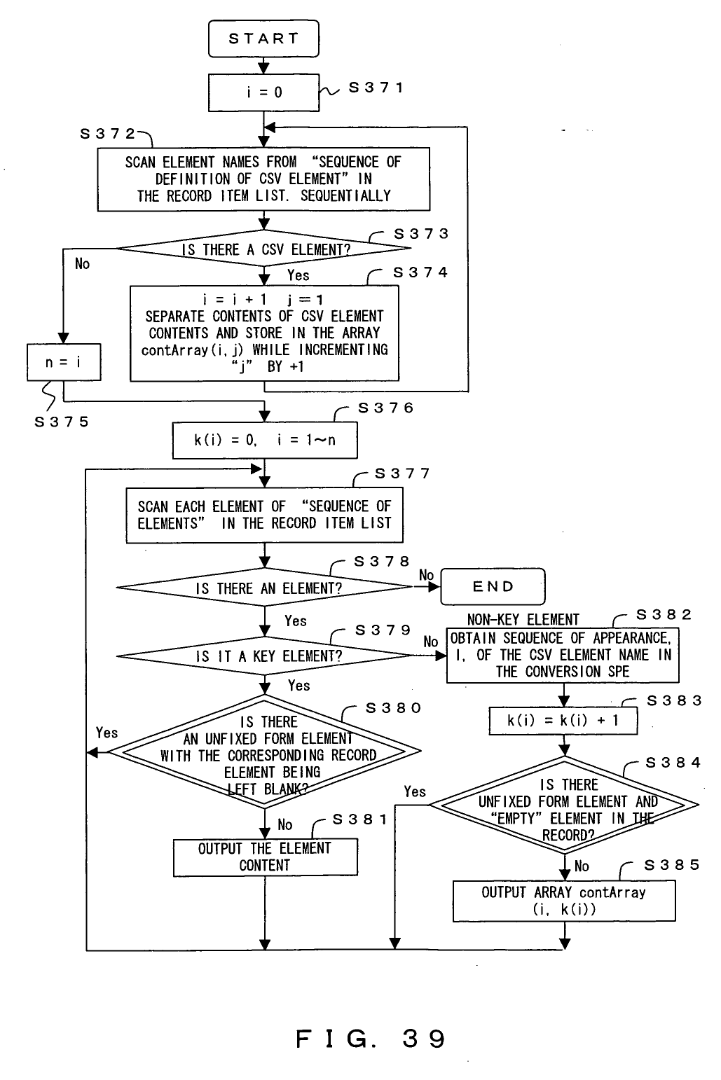

A conversion and/or reconversion processing by using the conversion specification XML document 40 shown by FIG. 34 have the same overall process flow as FIG. 6 or 7, except that the details of the steps S17 or S28 are replaced by FIG. 35, with the step S302 of FIG. 35 being shown by FIGS. 36 through 39. FIG. 36 or FIG. 37 is for a conversion processing, while FIG. 38 or FIG. 39 is for a reconversion.

The processing of FIGS. 36 through 39 are approximately the same as that of FIGS. 8, 13, 9 and 14, with the difference being “in the list of record items” replacing “in the conversion spec.” That is, as a result of the processing in the step S301 shown by FIG. 35, a record item list corresponding to the record subjected to processing is selected from among each record item lists 41, 42 and 43 in the conversion specification XML document 40, and therefore only the selected record item list will be used for the processing in the step S302, instead of using the all items in the conversion specification XML document 40. This is the reason for the “in the list of record items” replacing the “in the conversion spec.”

For instance, if the record of the part category “hard disk” in the XML document shown by FIG. 25 is the subject of processing, the record item list 42 of the conversion specification XML document 40 is selected in the step S301. Therefore the processing of FIGS. 8, 13, 9 and 14 are performed only for the selected record item list 42, that is, the processing of FIGS. 36 through 39 are performed, thereby eliminating useless processing for elements unrelated to the record subjected to processing, improving process efficiency and reducing processing cost.

Meanwhile, FIGS. 8 and 9 are for the first embodiment, that is, a processing for a fixed form XML document, there is no element of format=“unfixed”, that is, “not appearing in a fixed manner”, in the selected record item list for the present embodiment, and therefore the processing of the first embodiment can be conveniently used. But, it is just an example and there may be elements of format=“unfixed” in the selected record item list 42. In this case, empty element may be outputted into the converted XML document as in the second embodiment, or an output format describing the sequence of appearance in the attribute as in the third embodiment.

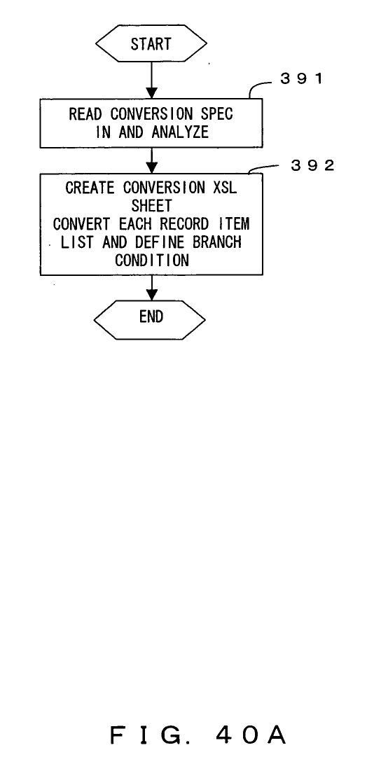

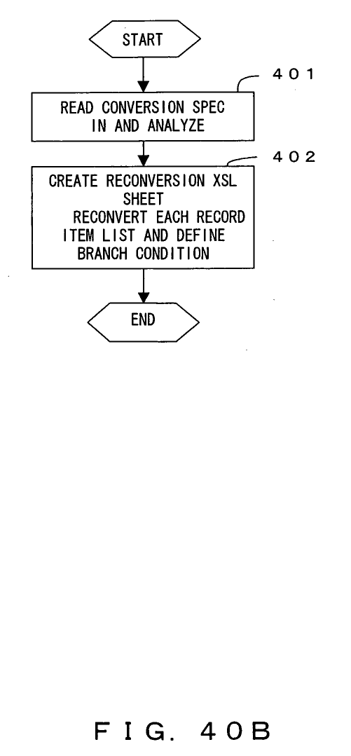

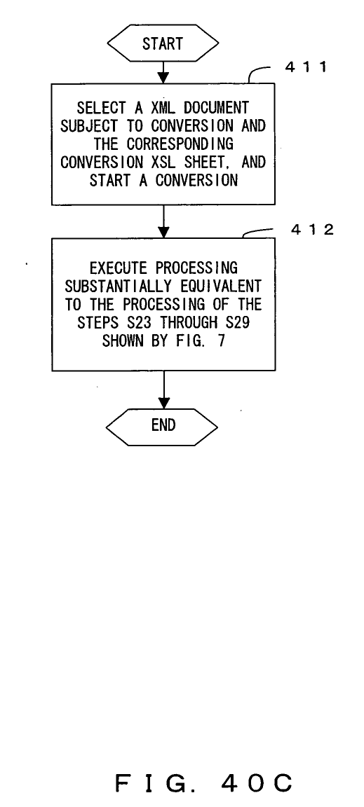

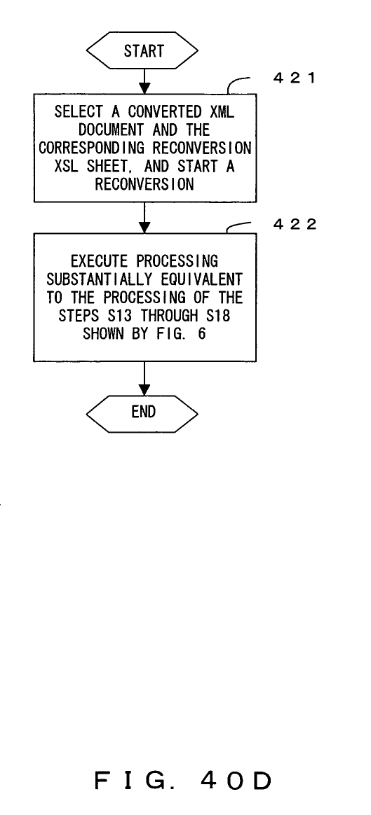

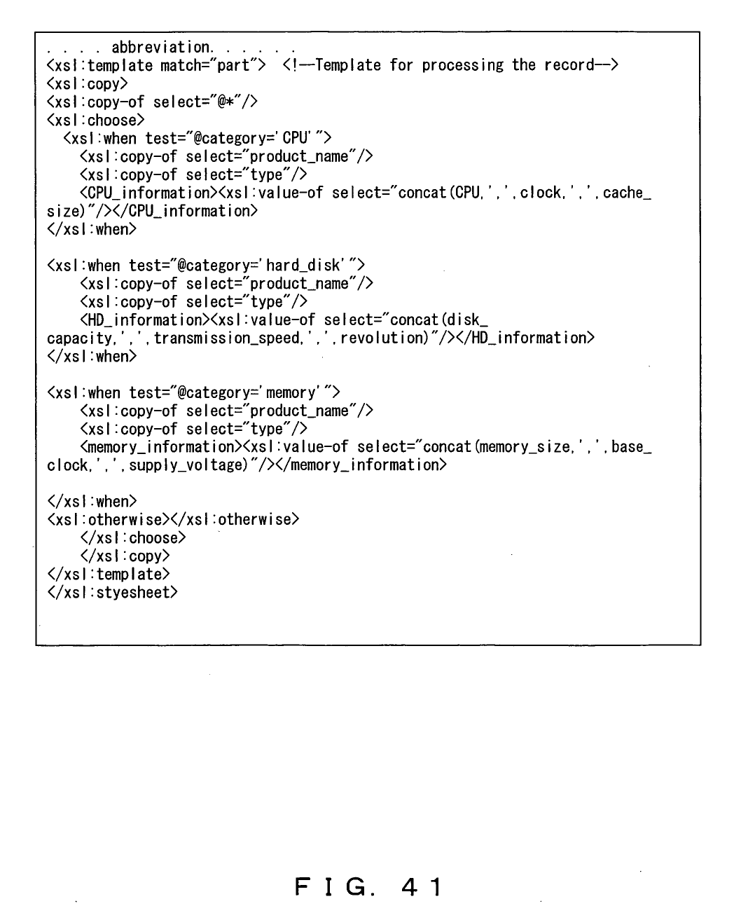

Meanwhile, the XSL conversion unit 13 may create a conversion XSL sheet 15 and a reconversion XSL sheet 16 by the processing of the steps S391 and S392 shown by FIG. 40A, and the steps S401 and S402 shown by FIG. 40B, respectively, based on the conversion specification XML document 40 shown by FIG. 34; and further perform a conversion and reconversion processing.

The processing by the XSL conversion unit 13 is basically converting document according to the XSL spec., thus bearing no particular need for a description. The generation processing of the conversion XSL sheet 15 in the examples shown by FIGS. 34 and 41, every time “item” element appears in the conversion specification XML document shown by FIG. 34, the content (“@category=”CPU” in the first record) of the attribute, “when”, is merely fit to <xsl:when test=. In the “item” element, the element contents of the one specified as “_ORG” by the attribute, mtag, can simply be applied to <xsl:copy-of select=. The element contents of the “item” element of which a CSV element is specified by the attribute, mtag, for can be linked by “cancat”.

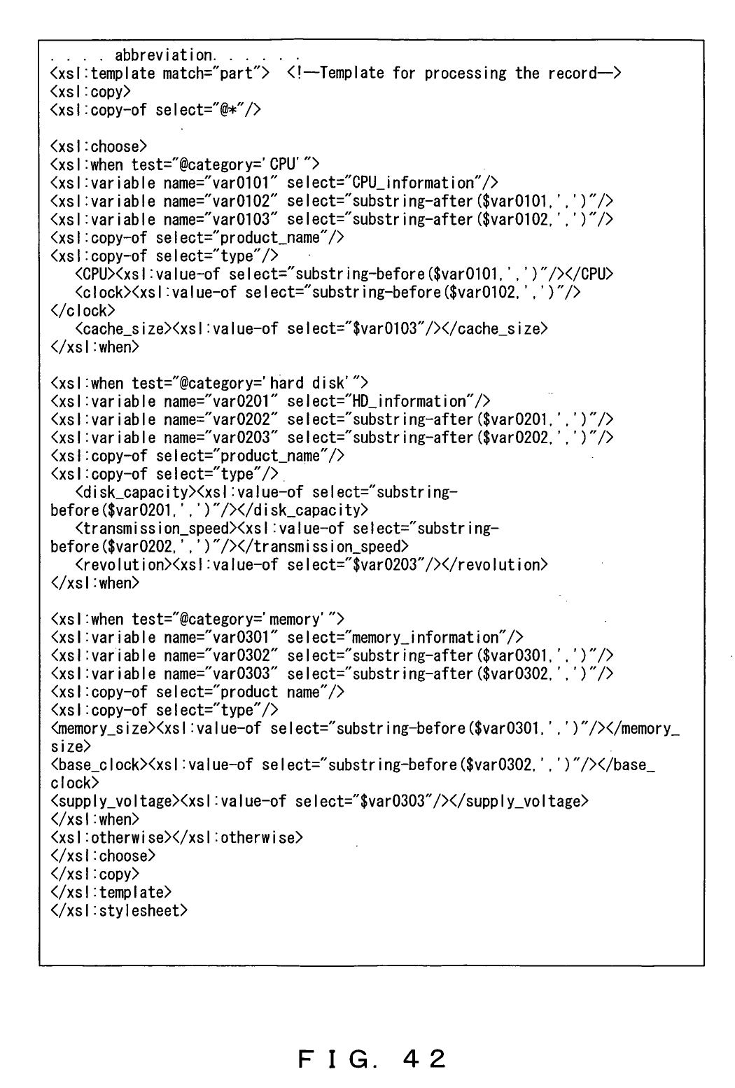

Likewise the reconversion XSL sheet shown by FIG. 42, element contents (i.e., CPU information, product name, type, CPU, clock, cache size, et cetera) can simply be applied to the pre-defined templates such as variable, copy-of, value-of, et cetera, according to merging_tag elements or the attributes of item elements (e.g., “_ORG”, CSV element name) of the conversion specification XML document. Naturally, the numbers of “variable” sentences and “copy-of” sentences are in accordance with the numbers of non-key elements and key elements, respectively.

And, as shown by FIG. 40C, a conversion proceeds by selecting an input XML document 21 and the name of corresponding conversion XSL sheet 15 (step S411) to perform the processing practically corresponding to the steps S23 through S29 shown by FIG. 7 (i.e., processing of step S28 being replaced by FIG. 35; also the processing shown by FIG. 36 or 37) by using the aforementioned conversion XSL sheet 15 (step S412).

Likewise, as shown by FIG. 40D, a reconversion proceeds by selecting a converted XML document 23 (or an extracted XML document 24) subjected to processing and the name of corresponding reconversion XSL sheet 16 (step S421) to perform the processing practically corresponding to the steps S13 through S18 shown by FIG. 6 (i.e., processing of step S17 being replaced by FIG. 35; also the processing shown by FIG. 38 or 39) by using the aforementioned reconversion XSL sheet 16 (step S422).

FIGS. 41 and 42 exemplify a conversion XSL sheet 15 and a reconversion XSL sheet 16, respectively, created by the processing as shown by FIGS. 40A and 40B, respectively. Incidentally, the first half of FIG. 41 is the same as FIG. 29, hence being omitted here; and likewise the first half of FIG. 42 is the same as FIG. 32, hence being omitted here.

In the processing shown by FIGS. 41 and 42, the sequence of elements in each record category indicated by <items> of the conversion specification XML document 40 shown by FIG. 34 is switched by the condition of <choose>-<when><otherwise>. These <choose>, <when> and <otherwise> are well known as programs for XSLT style sheet, hence bearing no need to elaborate. To summarize, however, <choose> is used for processing by selecting a plurality of conditions in the XSLT; <when> is mandatory element and <otherwise> is the optional both in a <choose> sentence. The XSLT processor evaluates xsl:when in sequence and processes only the template of the first xsl:when element of which the value of the test attribute becomes true. If there is no xsl:when element of which the value of the test attribute is true, the processor processes the template of xsl:otherwise, but it is optional as noted above.

Other XSLT program functions are also well known, hence bearing no need to elaborate. To summarize, however, element contents of the element by the tag name being pointed at by <value-of select> can be taken out of an XML document. And <variable> is used for defining a variable. A “$” is attached to a variable name for referring to a value for the variable. A <concat> is known as forming one character string by linking character strings together. A <copy-of select>, in contrast to <value-of select> being used for outputting the value of a specified node as a character string, is used for outputting by copying the node as is, including its sub-element. A use of <if test> performs a simple “if then”-type (i.e., execute (some operation) if (corresponding to something)) conditional processing. A <substring-after> is used for taking a part following a designated character including the character out of a character string. A <substring-before> is used for taking a part before a designated character out of a character string. “@“means an attribute; and “@*” means all attributes.

In FIGS. 41 and 42, evaluation equations for “when” attribute values of the <items> which are specified by the conversion specification XML document are used, as they are, for the evaluation equation (e.g., “@category=‘CPU’”) for “test” attributes of <when> as the switching conditions as described above. This enables complex designations of conditions such as AND, OR, et cetera, combinations between a plurality of elements, -element contents, -attributes and -attribute values.

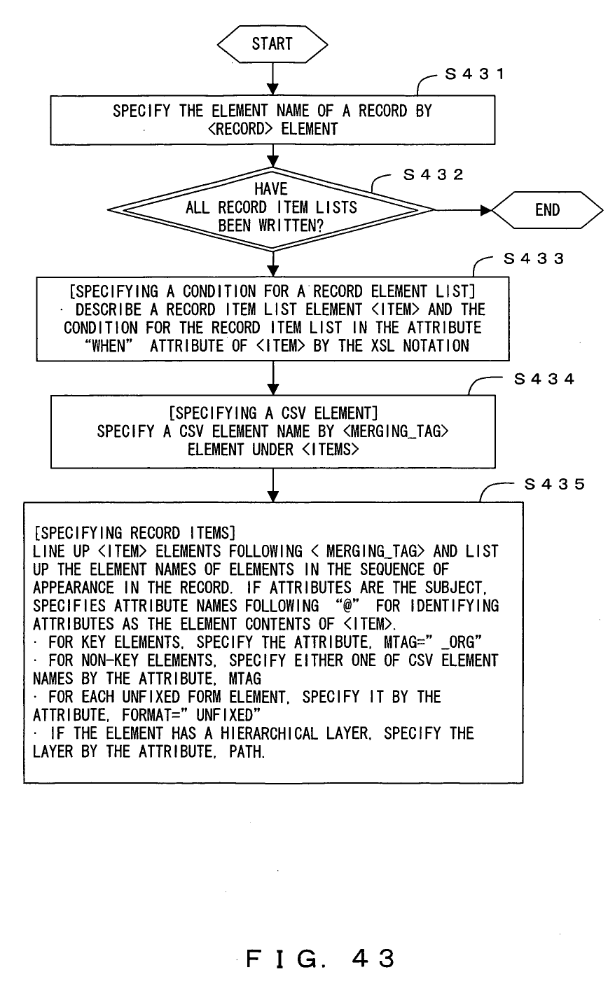

Finally, FIG. 43 describes a creation process flow for the conversion specification XML document shown by FIG. 34.

In FIG. 43, first specifies the element name of a record by <record> element (step S431), followed by processing for the steps S433 through S435 until all the record item lists have been written (step S432).

That is, first specifies a condition for a record element list (step S433), describing a record item list element <item> and the condition for the record item list in the “when” attribute of <item> by the XSL notation.

Then, specifies a CSV element (step S434). This is done by specifying a CSV element name by <merging_tag> element below <items>. Attaches the attribute, format=“unfixed”, then.

The processing is completed by specifying record items (step S435), which is accomplished by lining up <item> elements following <merging_tag> and listing up the element names of elements in the record in the sequence of appearance therein. If attributes are the subject, specifies attribute names following “@” for identifying attributes as the element contents of <item>. For key elements, specifies the attribute, mtag=”-ORG”. For non-key elements, specifies either one of CSV element names by the attribute, mtag. For each unfixed form element, specifies it by the attribute, format=“unfixed”. If the element has a hierarchical layer, specifies the layer by the attribute, path.

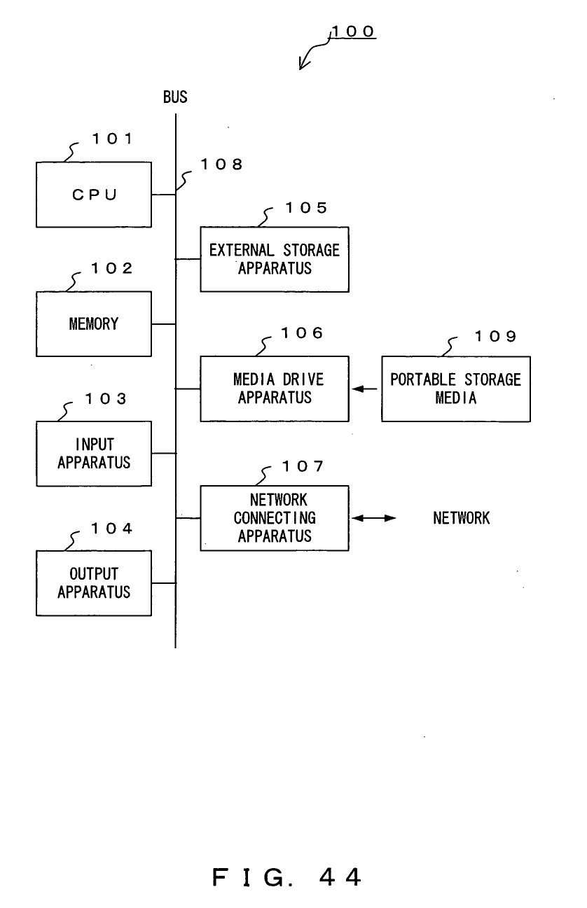

FIG. 44 shows an example of hardware configuration for achieving a structured document conversion method according to the present embodiment.

The computer 100 shown by FIG. 44 comprises a CPU 101, a memory 102, an input apparatus 103, an output apparatus 104, an external storage apparatus 105, a media drive apparatus 106, a network connecting apparatus 107, et cetera, and a bus 108 for connecting these components. The figure shows an example and not limited as such.

The CPU 101 is the central processing unit for controlling the entire computer 100.

The memory 102 is a memory, such as RAM, for temporarily storing a program or data being stored in the external storage apparatus 105 (or, a portable storage media 109) at the time of program execution or a data renewal. The CPU 101 achieves the above described series of processing and functions (e.g., processing shown by FIGS. 6 through 9, FIGS. 13 and 14, FIGS. 17 through 19; and functions of the respective function units shown by FIG. 2) by using a program and data read out in the memory 102. Note that the data includes the above described series of XML documents and XSL sheets, et cetera.

The input apparatus 103 includes keyboard, mouse, touch panel, et cetera.

The output apparatus 104 includes display, printer, et cetera.

The external storage apparatus 105 includes magnetic disk apparatus, optical disk apparatus, magneto optical disk apparatus, et cetera; and stores the program and data, et cetera, for achieving the series of functions according to the present invention as described above.

The media drive apparatus 106 reads out the program and/or data stored in the portable storage media 109 which include FD (Flexible Disk), CD-ROM, DVD, magneto optical disc, et cetera.

The network connection apparatus 107 is configured for connecting with a network and enabling receiving and transmission of programs and/or data, et cetera, with an external data processing apparatus.

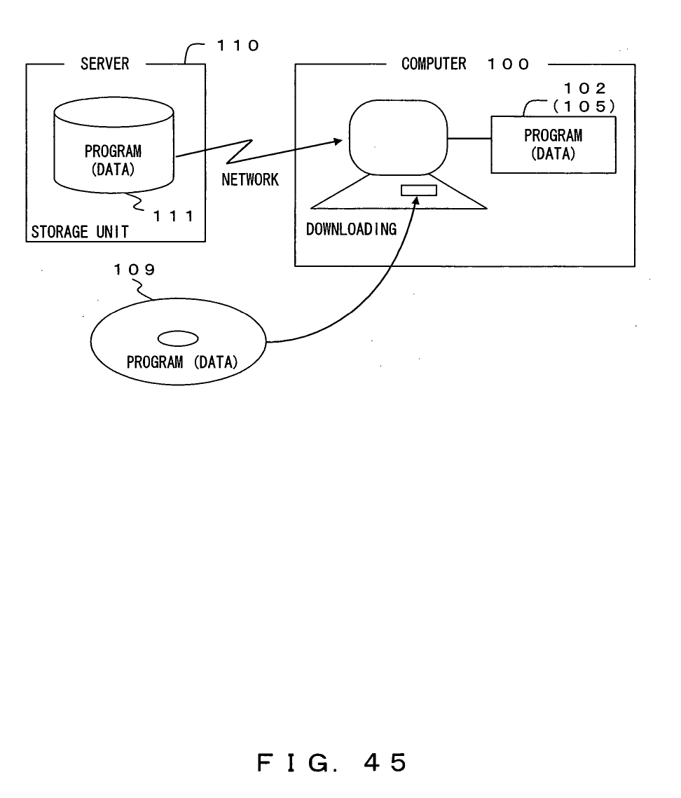

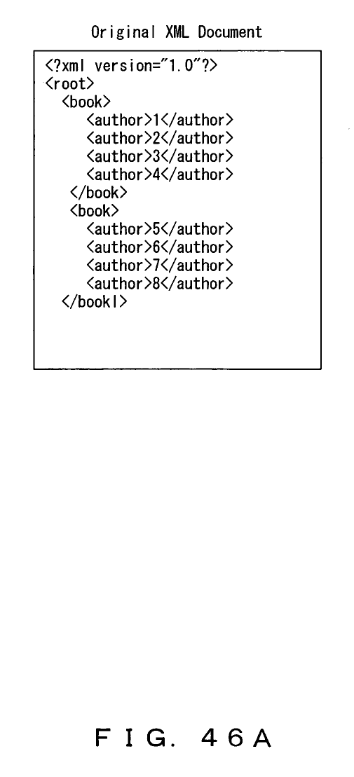

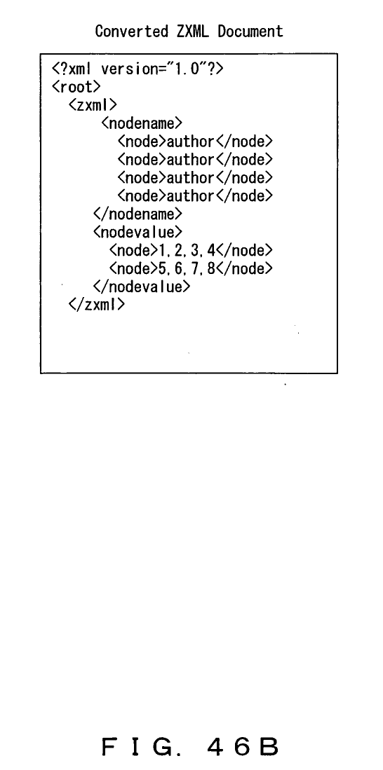

FIG. 45 shows an example of storage media being stored with a program, et cetera, or a download.

As shown by the figures, a configuration may be such as one that reads the program and/or the data for achieving the functions of the present invention out of a portable storage media 109 into the data processing apparatus 100 and execute them by storing them in the memory 102; or alternatively, downloads the program and/or the data stored in the storage unit 111 equipped in an external server 110 by way of a network (e.g., Internet) being connected through the network connection apparatus 107.

The present invention is not limited by apparatuses or methods, but can be configured by a storage media (such as a portable storage media 109) storing the above described program and/or the data, or the above described program per se.

As described in detail above, the structure document conversion and/or reconversion method, the system and/or apparatus and the program according to the present invention enables the existing application software to handle a converted XML document by categorizing elements contained in a record into key elements to be used by the application software and the remaining non-key elements, and converting the non-key elements so as to link them together by the CSV format, while leaving the key elements as they are; a reduction of memory usage volume and processing time for data processing as the general method; and, furthermore, the XML document to maintain its self-describability even after a conversion while preventing an overhead from becoming large even in a case where the application software ends up handling the non-key element, or making capable of reconverting back to the original XML document with its sequence of elements in the reconverted document being the same as the original XML document, or avoiding a redundancy even if there are large number of records and/or of non-key elements in an unfixed form document.

1. A structural conversion apparatus for a structured document, comprising:
a conversion specification definition unit for defining a plurality of new elements in a converted structured document, categorizing each element contained in a structured document for conversion into a key element to be subjected to data processing and the others in sequence of appearance in a record and determining to which of the plurality of new elements to assign the each non-key element that is one other than the key element in dealing with a fixed form structured document; and
a structural conversion unit for describing each element contained in the structured document for conversion in sequence of appearance in the record by the method of writing the key elements, as is, while, for the non-key elements, writing in the form of linking the element contents together by the CSV format per each applicable new element as element contents of each new element, both in the structured document for conversion, in order to create the converted structured document from the structured document for conversion according to a conversion specification specified by the conversion specification definition unit.

2. The structural conversion apparatus for a structured document in claim 1, further comprising a reconversion unit for searching the new element applicable to each element, one after another, which is defined in the sequence of appearance by said conversion specification definition unit, searching an element content corresponding to the element in parallel with the sequence from among each element content linked together by the CSV format for the new element, and writing the element content in the original structured document in order to reconvert said converted structured document back to the original structured document according to a conversion specification specified by the conversion specification definition unit.

3. The structural conversion apparatus for a structured document in claim 1, wherein said structural conversion unit further writes element names corresponding to each element content linked together by said CSV format per said each new element in a converted structured document as additional information with the aforementioned names being linked together by the CSV format.

4. A structural conversion apparatus for a structured document, comprising:
a conversion specification definition unit for defining a plurality of new elements in a converted structured document, categorizing all elements of possible appearances in a structured document for conversion into key elements to be subjected to data processing and the others in sequence of appearance for all possible appearances and determining to which of the plurality of new elements to assign each non-key element that is one other than the key elements in dealing with an unfixed form structured document; and
a structural conversion unit for describing each element contained in the structured document for conversion in sequence of appearance in the record by the method of writing the key elements, as is, while, for the non-key elements, writing a relating element content thereof in the converted structured document by taking the form of element contents of the new element linked together by the CSV format per one respective new element in which the relating element content is written for an element appearing in the structured document for conversion and an empty element is substituted for the element content thereof not appearing therein, in order to create the converted structured document from the structured document for conversion according to a conversion specification specified by the conversion specification definition unit.

5. The structural conversion apparatus for a structured document in claim 4, further comprising:
a reconversion unit for refraining from writing an element if the relating element content thereto is said empty element, when the unit is searching a new element applicable to each element, one after another, which is defined in the sequence of appearance by said conversion specification definition unit, searching an element content corresponding to the element in parallel with the sequence from among each element content linked together by the CSV format for the new element, and writing the element content in the original structured document, in order to reconvert said converted structured document back to the original structured document according to a conversion specification specified by the conversion specification definition unit.

6. The structural conversion apparatus for a structured document in claim 4, wherein a conversion specification definition unit further defines whether or not said each element is an unfixed form element which is an element whose appearance in said structured document for conversion is random, and
said structural conversion unit writes nothing in a converted structured document if said key element is the unfixed form element with nothing being written in the structured document for conversion.

7. A structural conversion apparatus for a structured document, comprising:
a conversion specification definition unit for defining a plurality of new elements in a converted structured document, classifying the new elements into unfixed form element or the other form for each thereof, categorizing all elements of possible appearance in a structured document for conversion into a key element to be subjected to data processing and the others in sequence of appearance for all possible appearance, and determining to which of the plurality of new elements to assign each non-key element that is one other than the key element in dealing with an unfixed form structured document; and
a structural conversion unit for describing each element contained in the structured document for conversion in sequence of appearance in the record by the method of writing the key elements, as are, while, for the non-key elements, writing element contents of the appearing elements being linked together by the CSV format in sequence of appearance as element contents of the new element per each new element, if the new element is not the unfixed form element, while writing element contents of the appearing elements being linked together by the CSV format in sequence of appearance as element contents of the new element and also the sequence of appearance being put together by the CSV format as a tag attribute of the new element, if the new element is the unfixed form element, in order to make a converted structured document from the structured document for conversion according to a conversion specification specified by the conversion specification definition unit.

8. The structural conversion apparatus for a structured document in claim 7, further comprising a reconversion unit for searching a new element applicable to each element in said sequence of appearance specified by said conversion specification definition unit, and writing element content applicable to said element in said original structured document, if the new element is a said unfixed form element and if sequence of appearance of the element is described as said attribute of the new element, in order to reconvert said converted structured document back to the original structured document according to a conversion specification specified by the conversion specification definition unit.

9. The structural conversion apparatus for a structured document in claim 8, wherein said conversion specification definition unit, further defines a different name having a relationship with an element name also specifying an applicable hierarchical layer regarding a random element name on random layer in a structured document for conversion, and said structural conversion unit uses the different name when writing an element name as said additional information.

10. A structural conversion apparatus for a structured document, comprising the steps of
writing a key element in a converted structured document as is; whereas, for each non-key element,
writing a relating element content thereof in the converted structured document by taking the form of element contents of a new element linked together by the CSV format per one respective new element, in describing each element contained within the structured document for conversion in sequence of appearance in a record in order to create the converted structured document from a structured document for conversion according to a conversion specification definition document for defining a plurality of the new elements in the converted structured document, categorizing each element contained in the structured document for conversion into a key element to be subjected to data processing and the others in sequence of appearance in a record and determining to which of the plurality of new elements to assign each non-key element that is one other than the key element in dealing with a fixed form structured document.

11. A structural conversion apparatus for a structured document, comprising the steps of
writing a key element in a converted structured document as is; whereas, for each non-key element,
writing a relating element content thereof in the converted structured document by taking the form of element contents of a new element being linked together by the CSV format per one respective new element in which the relating element content is written for an element appearing in the structured document for conversion and an empty element is substituted for the element content thereof not appearing therein, in describing each element contained within the structured document for conversion in sequence of appearance in said record according to a conversion specification definition document for defining a plurality of new elements in a converted structured document, categorizing all elements of possible appearance in the structured document for conversion into a key element to be subjected to data processing and the others in sequence of appearance for all possible appearance and determining to which of the plurality of new elements to assign each non-key element that is one other than the key element in dealing with an unfixed form structured document.

12. A structural conversion apparatus for a structured document, comprising the steps of
writing a key element in a converted structured document as is, whereas, for each non-key element;
writing element contents of appearing elements being linked together by the CSV format in sequence of appearance in the converted structured document as element contents of a new element per each new element, if a new element is not the unfixed form element; while
writing, in a converted structured document, element contents of the appearing elements being linked together by the CSV format in sequence of appearance as element contents of the new element and the sequence of appearance being written by the CSV format as a tag attribute of the new element, if the new element is the unfixed form element in describing each element contained within a structured document for conversion in sequence of appearance in a record according to a conversion specification definition document for defining a plurality of new elements in the converted structured document, classifying the new elements into an unfixed form element or the other form for each thereof, categorizing all the elements of possible appearance in the structured document for conversion into a key element to be subjected to data processing and the other in sequence of appearance for all possible appearance, and determining to which of the plurality of new elements to assign each non-key element that is one other than the key element in dealing with an unfixed form structured document.

13. A computer data signal embodied in a carrier wave, for representing a program for making a computer accomplish the steps of
writing a key element in a converted structured document as is; whereas, for each non-key element,
writing a relating element content thereof in the converted structured document by taking the form of element contents of a new element linked together by the CSV format per one respective new element, in describing the each element contained within the structured document for conversion in sequence of appearance in a record in order to create the converted structured document from a structured document for conversion according to a conversion specification definition document for defining a plurality of the new elements in the converted structured document, categorizing each element contained in the structured document for conversion into a key element to be subjected to data processing and the other in sequence of appearance in a record and determining to which of the plurality of new elements to assign each non-key element that is one other than the key element in dealing with a fixed form structured document.

14. A computer data signal embodied in a carrier wave, for representing a program for making a computer accomplish the steps of
writing a key element in a converted structured document as is; whereas, for each non-key element,
writing a relating element content thereof in the converted structured document by taking the form of element contents of a new element linked together by the CSV format per one respective new element in which the relating element content is written for an element appearing in the structured document for conversion and an empty element is substituted for the element content thereof not appearing therein, in describing each element contained within the structured document for conversion in sequence of appearance in a record according to a conversion specification definition document for defining a plurality of new elements in a converted structured document, categorizing all elements of possible appearance in the structured document for conversion into a key element to be subjected to data processing and the others in sequence of appearance for all possible appearance and determining to which of the plurality of new elements to assign each non-key element that is one other than the key element in dealing with an unfixed form structured document.

15. A computer data signal embodied in a carrier wave, for representing a program for making a computer accomplish the steps of
writing a key element in a converted structured document as is; whereas, for each non-key element,
writing element contents of appearing elements being linked together by the CSV format in sequence of appearance in the converted structured document as element contents of a new element per each new element, if a new element is not the unfixed form element; while
writing, in a converted structured document, element contents of the appearing elements being linked together by the CSV format in sequence of appearance as element contents of the new element and the sequence of appearance being written by the CSV format as a tag attribute of the new element, if the new element is the unfixed form element in describing the each element contained within a structured document for conversion in sequence of appearance in a record according to a conversion specification definition document for defining a plurality of new elements in the converted structured document, classifying the new elements into an unfixed form element or the other form for each thereof, categorizing all the elements of possible appearance in the structured document for conversion into a key element to be subjected to data processing and the other in sequence of appearance for all possible appearance, and determining to which of the plurality of new elements to assign each non-key element that is one other than the key element in dealing with an unfixed form structured document.

16. A computer readable storage media for storing a program for making the computer accomplish the steps of
writing a key element in a converted structured document as is; whereas, for each non-key element,
writing a relating element content thereof in the converted structured document by taking the form of element contents of a new element linked together by the CSV format per one respective new element, in describing the each element contained within the structured document for conversion in sequence of appearance in a record in order to create the converted structured document from a structured document for conversion according to a conversion specification definition document for defining a plurality of the new elements in the converted structured document, categorizing each element contained in the structured document for conversion into a key element to be subjected to data processing and the others in sequence of appearance in a record and determining to which of the plurality of new elements to assign each non-key element that is one other than the key element in dealing with a fixed form structured document.

17. A computer readable storage media for storing a program for making the computer accomplish the steps of
writing a key element in a converted structured document as is; whereas, for each non-key element,
writing element contents of appearing elements being linked together by the CSV format in sequence of appearance in the converted structured document as element contents of a new element per each new element, if a new element is not the unfixed form element; while
writing, in a converted structured document, element contents of the appearing elements being linked together by the CSV format in sequence of appearance as element contents of the new element and the sequence of appearance being written by the CSV format as a tag attribute of the new element, if the new element is the unfixed form element in describing each element contained within a structured document for conversion in sequence of appearance in said record according to a conversion specification definition document for defining a plurality of new elements in the converted structured document, classifying the new elements into the unfixed form elements or the other form for each thereof, categorizing all the elements of possible appearance in the structured document for conversion into the key elements to be subjected to data processing and the other in sequence of appearance for all possible appearances, and determining to which of the plurality of new elements to assign each non-key element that is one other than the key element in dealing with an unfixed form structured document.

18. A computer readable storage media for storing a program for making the computer accomplish the steps of
writing a key element in a converted structured document as is; whereas, for each non-key element,
writing element contents of appearing elements being linked together by the CSV format in sequence of appearance in the converted structured document as element contents of a new element per each new element, if a new element is not the unfixed form element, while
writing, in a converted structured document, element contents of the appearing elements being linked together by the CSV format in sequence of appearance as element contents of the new element and the sequence of appearance being written by the CSV format as a tag attribute of the new element, if the new element is the unfixed form element in describing each element contained within a structured document for conversion in sequence of appearance in a record according to a conversion specification definition document for defining a plurality of new elements in the converted structured document, classifying the new elements into the unfixed form element or the other form for each thereof, categorizing all the elements of possible appearances in the structured document for conversion into the key elements to be subjected to data processing and the other in sequence of appearance for all possible appearances, and determining to which of the plurality of new elements to assign each non-key element that is one other than the key element in dealing with an unfixed form structured document.

19. A structural conversion apparatus for a structured document, comprising:
a conversion specification definition unit for defining a record item list for each record category, categorizing all elements contained in each record item list of possible appearances for the record category into key elements, to be subjected to data processing, and the others, defining at least one new element for a converted structured document and determining to which of the new elements to assign the non-key elements that are ones other than the key element in dealing with an unfixed form structured document having different elements for forming a record for each record category; and
a structural conversion unit for selecting a record item list from the conversion specification definition unit relating to the record category per each record in the structured document for conversion describing each element contained by the record in sequence of appearance therein based on the selected record item list by the method of writing the key elements, as is, while, for the non-key elements, writing in the form of linking them together by the CSV format per the each applicable new element as element contents of each new element, both in the structured document for conversion, in order to create the converted structured document from the structured document for conversion according to a conversion specification specified by the conversion specification definition unit.

20. The structural conversion apparatus in claim 19, wherein a switching condition for selecting the record item list is described in said each record item list, and said structural conversion unit selects a record item list relating to a record category for processing by using the switching condition.

21. A structural conversion method for a structured document, comprising the steps of
selecting a record item list from a conversion specification definition document relating to a record category per each record in a structured document for conversion; and
describing each element contained by the record in the structured document for conversion in sequence of appearance in the record based on the selected record item list by the method of writing the key elements, as is, whereas, for the non-key elements, writing the form of linking them together by the CSV format per the each applicable new element as element contents of each new element, in order to create the converted structured document from the structured document for conversion according to a conversion specification specified by the conversion specification definition document based on the conversion specification definition document for defining a record item list for each record category, categorizing all elements contained in each record item list of possible appearances for the record category into key elements, to be subjected to data processing, and the others, and defining at least one new element for a converted structured document and determining to which of the new elements to assign the non-key elements that are ones other than the key element in dealing with an unfixed form structured document having different elements for forming a record for each record category.

22. A computer data signal embodied in a carrier wave, for representing a program for making a computer accomplish the steps of
selecting a record item list from a conversion specification definition document relating to a record category per each record in a structured document for conversion; and
describing each element contained by the record in the structured document for conversion in sequence of appearance in the record based on the selected record item list by the method of writing the key elements, as are, whereas, for the non-key elements,
writing the form of linking them together by the CSV format per each applicable new element as element contents of each new element, in order to create the converted structured document from the structured document for conversion according to a conversion specification specified by the conversion specification definition document based on the conversion specification definition document for defining a record item list for each record category, categorizing all elements contained in each record item list of possible appearances for the record category into key elements, to be subjected to data processing, and the others, and defining at least one new element for a converted structured document and determining to which of the new elements to assign the non-key elements that are ones other than the key element in dealing with an unfixed form structured document having different elements for forming a record for each record category.

23. A computer readable storage media for storing a program for making the computer accomplish the steps of
selecting a record item list from a conversion specification definition document relating to a record category per each record in a structured document for conversion; and
describing each element contained by the record in the structured document for conversion in sequence of appearance in the record based on the selected record item list by the method of writing the key elements, as are, whereas, for the non-key elements,
writing the form of linking them together by the CSV format per the each applicable new element as element contents of each new element, in order to create the converted structured document from the structured document for conversion according to a conversion specification specified by the conversion specification definition document based on the conversion specification definition document for defining a record item list for each record category, categorizing all elements contained in each record item list of possible appearances for the record category into key elements, to be subjected to data processing, and the others, and defining at least one new element for a converted structured document and determining to which of the new elements to assign the non-key elements that are ones other than the key element in dealing with an unfixed form structured document having different elements for forming a record for each record category.
